(19) United States
(12) Patent Application Publication
(10) Pub. No.: US 2021/0068034 A1
(43) Pub. Date: Mar. 4, 2021

(54) SYSTEM FOR DETECTING PRESENCE OF FIREARM ON A PREMISES

(71) Applicants: Paul R. Juhasz, Houston, TX (US); Christopher Frerking, Concord, NH (US); James Tiernan, Houston, TX (US)

(72) Inventors: Paul R. Juhasz, Houston, TX (US); Christopher Frerking, Concord, NH (US); James Tiernan, Houston, TX (US)

(21) Appl. No.: 17/032,651

(22) Filed: Sep. 25, 2020

Related U.S. Application Data
(63) Continuation-in-part of application No. 15/986,339, filed on May 22, 2018.
Application No. 15/986,339 is a continuation-in-part of application No. 15/663,660, filed on Jul. 28, 2017, now Pat. No. 10,750,431.
Application No. 15/663,660 is a continuation-in-part of application No. 15/910,190, filed on Mar. 2, 2018, now Pat. No. 10,341,937.
Application No. 15/910,190 is a continuation-in-part of application No. 15/620,288, filed on Jun. 12, 2017, now Pat. No. 9,913,200.
Application No. 15/620,288 is a continuation of application No. 13/462,712, filed on May 2, 2012, now Pat. No. 9,681,358.
Application No. 15/986,339 is a continuation of application No. 12/571,090, filed on Sep. 30, 2009, now abandoned.
Application No. 12/571,090 is a continuation-in-part of application No. 16/430,978, filed on Jun. 4, 2019.
(60) Provisional application No. 61/195,016, filed on Oct. 2, 2008.
(60) Provisional application No. 62/369,620, filed on Aug. 1, 2016.
(60) Provisional application No. 62/368,828, filed on Jul. 29, 2016.
(60) Provisional application No. 62/368,833, filed on Jul. 29, 2016.
(60) Provisional application No. 62/562,880, filed on Sep. 25, 2017.
(60) Provisional application No. 62/680,166, filed on Jun. 4, 2018.

(51) Int. Cl. H04W 48/02; H04W 4/029

(52) U.S. Cl. CPC H04W 48/02; H04W 4/02; H04W 4/029

(57) ABSTRACT

A system configured for detecting firearm threats on a premises includes a surveillance camera on a premises and a utility. The surveillance camera is configured to generate surveillance data. The utility is configured to provide a cloud service for detecting firearm threats on a premises. The system includes a processor; memory in electronic communication with the processor; and instructions stored in the memory. The instructions are executable by the processor to: detect the presence of a firearm on the premises; and upon detecting a firearm, sending a notification that a firearm has been detected on the premises.

### CLAIM TO PRIORITY

This application claims priority to and the benefit of each the following pending applications, the contents of which are hereby incorporated by reference in their entirety: the present application is a continuation-in-part of non-provisional application Ser. No. 16/430,978, filed Jun. 4, 2019 which claims the benefit of provisional application 62/680,166, filed Jun. 4, 2018; the present application is also a continuation-in-part of non-Provisional application Ser. No. 15/986,339, filed May 22, 2018 and entitled “Dead Zone for Wireless Device;” non-Provisional application Ser. No. 15/986,339 is a continuation-in-part of non-Provisional application Ser. No. 15/663,660 filed Jul. 28, 2017, titled “Safety Disarm for Firearm”, issued Aug. 18, 2020 as U.S. Pat. No. 10,750,431, Docket No. JL00900.016; which claims priority from Provisional Application Ser. No. 62/368,828 filed Jul. 29, 2016 titled “Safety Disarm for Firearm”, Docket JL0900.008; Provisional Application Ser. No. 62/368,833 filed Jul. 29, 2016, titled “Dead Zone for Wireless Communication Device”, Docket JL0900.009; Provisional Application Ser. No. 62/369,620 filed Aug. 1, 2016 titled “Safety Disarm for Firearm”, Docket JL0900.010; and non-provisional application Ser. No. 15/663,660 is also a continuation-in-part of application Ser. No. 15/620,288, filed Jun. 12, 2017, titled “Dead Zone for Wireless Communication Device”, Docket JL0900.011, and issued 3-6-2018 as U.S. Pat. No. 9,913,200; non-provisional application Ser. No. 15/620,288 is a continuation of Non-provisional application Ser. No. 13/462,712, filed May 2, 2012, JL0900.005 and issued Jun. 13, 2017 as U.S. Pat. No. 9,681,358; non-provisional application Ser. No. 13/462,712 is a continuation of application Ser. No. 12/571,090 filed Sep. 30, 2009, Docket JL0900.002 abandoned, which claims priority from Provisional Application 61/195,016, filed Oct. 2, 2008. Additionally, non-provisional application Ser. No. 15/986,339 claims priority to and the benefit of: U.S. Provisional Application Ser. No. 62/562,880, filed Sep. 25, 2017, and titled “Dead Zone for Wireless Communication”, Docket JL0900.018, the entirety of which is incorporated herein by reference; and non-provisional application Ser. No. 15/986,339 is also a continuation-in-part of U.S. Non-Provisional application Ser. No. 15/910,190, filed Mar. 2, 2018, titled “Dead Zone for Wireless Communication Device”, Docket JL0900.019, issued on Jul. 2, 2019 as U.S. Pat. No. 10,341,937, the entirety of which is also incorporated herein by reference.

### FIELD OF INVENTION

Embodiments of the invention are directed to wireless communication devices and more particularly to a wireless communication device system, a wireless communication device, and a wireless communication method for disabling the use of wireless communication devices in places where they should not be used.

### BACKGROUND

The cell phone is a widely used device. These devices allow people to talk, send text messages, emails, etc. The upside of these devices is that they allow people to stay connected anywhere anytime. The downside is that these devices are sometimes used in places or at times when they should not be used. For example, studies have shown that use of a cell phone while driving can increase the risk of an accident. Still a number of people use cell phones while driving a motor vehicle. Despite laws restricting the use of cell phones while operating a motor vehicle in a number of States in the U.S., rampant cell phone use during driving continues through unawareness or disregard of these laws, hence risking injury to the caller and others through an accident. As another example, studies have shown that radio waves transmitted by wireless devices may interfere with medical equipment. Still, a number of people use cell phones while in a hospital. Despite warnings telling callers to silence their cell phones when in the hospital, hospital cell phone use continues through unawareness or disregard of these laws, hence risking interference with medical equipment and the lives of those who depend on them. As yet further examples, there are places where the use of cell phones in places or at times may interfere with the public enjoyment, health, welfare, or safety. For instance, despite requests or common courtesy, a number of people use their cell phones during a movie theater, a performing arts hall, a church, or other places of public gathering, hence causing a distraction that may interfere with the movie, performance, worship or public gathering.

U.S. Pat. No. 6,979,724 is directed to a method for switching a cell phone from audible to silent mode of operation during a concert performance, a play, a conference, a meeting or dinner. An RF transmitter is provided with an omni-directional or directional antenna. The RF transmitter is locally mounted in the area where a cell phone is to be switched to silent mode of operation. The RF transmitter is programmed to broadcast a message containing a code. When in range of the RF transmitter broadcast, a cell phone that has been programmed to recognize the broadcast is automatically programmed by the broadcast to switch itself to silent mode of operation. Japanese laid open patent application H10-42371 is directed to a receiver/transmitter that is locally mounted at a hospital in the area where a cell phone is not to be used. The receiver/transmitter broadcasts a signal and waits for acknowledgement by a cell phone. On acknowledgement, a microcomputer associated with the receiver/transmitter determines whether the phone is set up for use. If the phone is so set up for use, the microcomputer broadcasts a warning over a speaker mounted in the hospital that the phone is not to be used in the hospital. Japanese laid open patent application J11-004190 is directed to a cell phone accessory that monitors engine speed and parking brake activity. The accessory is connected to a cell phone in a car to detect incoming calls to the cell phone. On detection of an incoming call, the accessory suppresses or reduces the volume of the cell phone ring tone and diverts the call for recording on an answering machine residing in the accessory for playback. Neither prior art disables the use of wireless communication devices in places where they should not be used.

There is also growing tension between the Second Amendment right of the people to bear arms and the protection of innocent people against injury or death from intentional or accidental discharge of a firearm.

There are features provided on a gun to provide greater safety. See, for example, http://guns.wonderhowto.com/how-to/use-each-three-safety-features-colt-model-1911-series-80-handgun-390775/

There is a need for a communication system, device, and method for disabling the use of wireless communication devices in places where they should not be used. There is also need for a safety disarm of a firearm to minimize casualties from intentional shootings of innocent people as happened in San Bernardino and Orlando as well as accidental discharge of a firearm including by children playing.

Unless otherwise indicated herein, the materials described in this section are not prior art to the claims in this application and are not admitted to be prior art by inclusion in this section.

### SUMMARY

In one aspect, a system configured for detecting firearm threats on a premises includes a surveillance camera on a premises and a utility. The surveillance camera is configured to generate surveillance data. The utility is configured to provide a cloud service for detecting firearm threats on a premises. The system includes a processor; memory in electronic communication with the processor; and instructions stored in the memory. The instructions are executable by the processor to: detect the presence of a firearm on the premises; and upon detecting a firearm, sending a notification that a firearm has been detected on the premises.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF DRAWINGS

FIG. 1 shows a representative prior art cell phone system.

FIG. 2 shows a representative prior art cell phone system of FIG. 1 provided with GPRS service designed for GSM networks.

FIG. 3 shows a representative prior art cell phone system of FIG. 2 provided with global positioning system (GPS).

FIG. 4 shows a system embodiment of the invention.

FIG. 5 shows an embodiment of a no zone register.

FIG. 6 shows a logic flow for the system embodiment of FIG. 4 implemented with the no zone register of FIG. 5.

FIG. 7 shows another embodiment of an inventive no zone register.

FIG. 8 shows a logic flow for the system embodiment of FIG. 4 implemented with the no zone register of FIG. 7.

FIG. 9 shows a logic flow for the system of FIG. 4 implemented with the no zone register of FIG. 7 in a network that recognizes whether a mobile terminal in the network is being used in a hands free mode of operation.

FIG. 10 shows an alternative wireless communication device embodiment of the invention.

FIGS. 11A, 11B-1 and 11B-2, and 11C show an illustrative embodiment of this disclosure. (FIGS. 11B-1 and 11B-2 collectively FIG. 11B.)

FIG. 12 shows an illustrative embodiment of FIG. 11 of this disclosure.

FIGS. 13A, 13B, 13C, 13D depict an illustrative embodiment of this disclosure.

FIGS. 14A, 14B, 14C, 14D depict an illustrative embodiment of this disclosure.

FIGS. 15A, 15B, 15C, 15D depict an illustrative embodiment of this disclosure.

FIGS. 16A, 16B, 16C, 16D, 16E depict an illustrative embodiment of this disclosure.

FIGS. 17A, 17B, 17C, 17D depict an illustrative embodiment of this disclosure.

FIG. 18 shows a method of this disclosure.

FIG. 19 is a representative prior art small cell system.

FIG. 20 is an illustrative system embodiment of a small cell system according to this disclosure.

FIG. 21 is an illustrative system alternative embodiment of a small cell system according to this disclosure.

FIG. 22 is an illustrative system alternative embodiment of a small cell system according to this disclosure.

FIGS. 23A, 23B is an illustrative small cell method according to this disclosure. (FIGS. 23A and 23B collectively FIG. 23.)

FIGS. 24A, 24B is an illustrative alternative small cell method according to this disclosure. (FIGS. 24A and 24B collectively FIG. 24.)

FIGS. 25A, 25B is an illustrative small cell method according to this disclosure. (FIGS. 25A and 25B collectively FIG. 25.)

FIGS. 26A, 26B is an illustrative small cell system according to this disclosure. (FIGS. 26A and 26B collectively FIG. 26.)

FIGS. 27A, 27B is an illustrative small cell system according to this disclosure. (FIGS. 27A and 27B collectively FIG. 27.)

FIGS. 28A, 28B illustrative NZR registers for airline carrier according to this disclosure. (FIGS. 28A and 28B collectively FIG. 28.)

FIG. 29 shows a firearm with a safety disarm according to an example embodiment.

FIG. 30 shows a firearm with a safety disarm according to an example embodiment.

FIG. 31 shows an illustrative memory map for use in the operation of the firearm shown in FIGS. 29 and 30 according to this disclosure.

FIG. 32 shows an illustrative embodiment of this disclosure.

FIG. 33 shows an illustrative embodiment of one prior art lower level system.

FIG. 34 shows an illustrative embodiment of one lower level system with firearm subsystem according to this disclosure.

FIG. 35 shows an illustrative embodiment of one lower level system with firearm subsystem according to this disclosure.

FIG. 36 shows an illustrative embodiment of one lower level system with firearm subsystem according to this disclosure.

FIG. 37 shows an illustrative embodiment of this disclosure with an arm/disarm control interface through which a firearm operator may monitor and control the firearm.

FIG. 38 shows an illustrative embodiment of this disclosure with an arm/disarm control interface through which a remote operator can monitor and control the firearm.

FIG. 39 shows an illustrative embodiment of FIG. 38 of this disclosure.

FIG. 40 shows an illustrative memory map for use in the operation of the firearm shown in FIGS. 38 and 39.

FIG. 41 shows a method of this disclosure.

### DETAILED DESCRIPTION

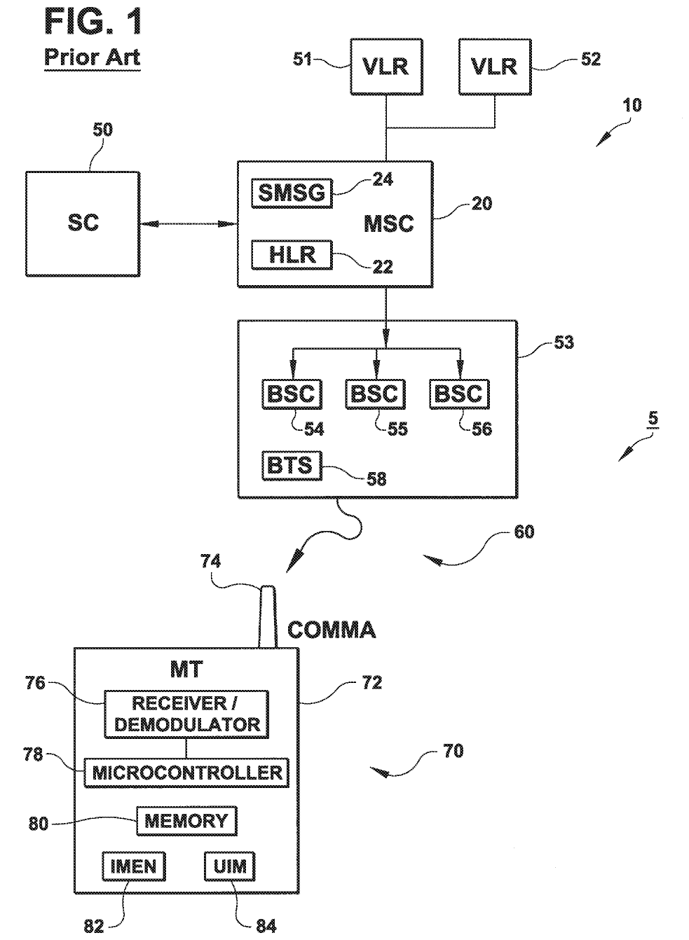

Prior art FIG. 1 shows a representative prior art cell phone system 5 comprising a network 10, a plurality of mobile terminals 70, such as cell phones, and in between the network and cell phone, an air interface 60. Network 10 typically includes a mobile switching center (MSC) 20, an operational support center (SC) 50, visiting location registers (VLR) 51, 52, and base station controllers 54, 55, 56, and base transceiver station (BTS) 58 which may be collectively referred to as base station subsystem (BSS) 53. In the illustrative system of FIG. 1, mobile terminal (MT) 70 is illustratively based on the Groupe Speciale Mobile (GSM) standard, but may be based on other standards. MT 70 comprises a mobile unit 72 having an antenna 74, a receiver/demodulator 76, a microcontroller 78, memory 80, international mobile equipment number 82, and a user identity module 84 also referred to as a subscriber identify module or SIM. MT 70 communicates with network 10 through air interface 60.

Mobile switching center 20 is a telecommunications switch deployed in network 10 to provide call control, processing and access to the public switched telephone (fixed) network. The home location register (HLR) 22 is a database that is maintained by a user's home carrier or the mobile operator with whom the user has initiated service. HLR 22 stores information about the user, including the user profile (preferences), account status, features and capabilities. VLR 51, 52 is a database used by the serving carrier to manage service requests from mobile users who are away from the home system.

When MT 70 is powered on the IMSI or MIN of the mobile is sent to network 10 via the air interface 60. The mobile request to use the network is picked up by BTS 58. The call is directed to the MSC 20 that oversees the switching in which the mobile was powered on in. MSC 20 determines whether MT 70 is in its “home” area or whether it is a “visitor”. MSC 20 makes this determination based on the IMSI or MIN information. If in the home area, HLR 22 provides information for handling both origination of a call and placement of a call. It does so based on service subscription information, service restrictions and supplementary information in HLR 22. If in a visitor area, VLR 51, 52 requests information from the HLR 22 where MT 70 is registered so that the visited system can process the call appropriately. If MSC 20 determines that the mobile is authorized to use network 10, MSC 20 logs the phone onto network 10 and tells the mobile it is logged on.

Once logged on, when a user dials a GSM mobile subscriber's MSISDN or a TIA network MIN, the call is sent to MSN 20 which interrogates HLR 22 of the caller to obtain authorization and routing information stored in the service profile of the user associated with his MSISDN or MIN. MSC 20 illustratively routes the call over a public switching telecommunications network (PSTN) to the HLR of the number called. Based on the IMSI or MIN number, the called HLR looks up the called subscriber profile as well as the current VLR 51, 52 at which the called subscriber is registered. The called HLR 22 generates a response message and sends it back to the calling MSC 20. MSC 20 then attempts to complete the call based on the location of the destination provided by called HLR 22.

Billing tickets for calls made in network 10 are typically produced on MSC 20. MSC 20 provides the billing tickets to the SC 50 which provides the interface to the customer invoices and the bills. SC 50 includes systems for billing the subscribers as well as for subscriber administration, fraud detection, and voice mail. These systems collect billing data generated by MSC in network 10 and manage the subscriber databases in network 10.

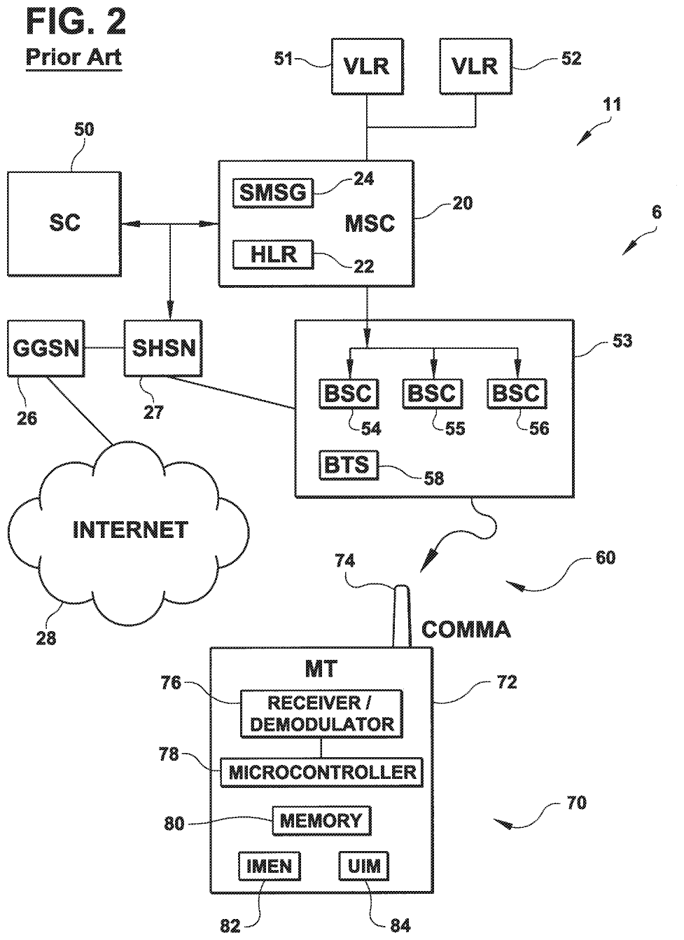

Prior art FIG. 2 shows the representative prior art cell phone system 5 of FIG. 1 provided with GPRS service designed for GSM networks. GPRS provides an overlay service onto GSM that allows the mobile to access the Internet. GPRS allows a mobile to provide high-speed Internet data communications using the existing GSM air interface. GPRS provides a direct interface to the Internet services for GSM mobile devices and is implemented in an existing GSM network with the addition of two new elements. These elements are a Signaling GPRS Service Node (SGSN) 27 and a Gateway GPRS Service Node (GGSN) 26. Additional modifications to the base station systems to include packet control units may also be required. GPRS allows a mobile to typically have an endless connection to an IP network that may stay open at low cost so that the mobile is connected to the network and enabled to connect to the Internet on initiation of a GDP Context message. Voice calls on GPRS handsets are routed by MSC 20 using the same circuit switched channels and protocols of GSM.

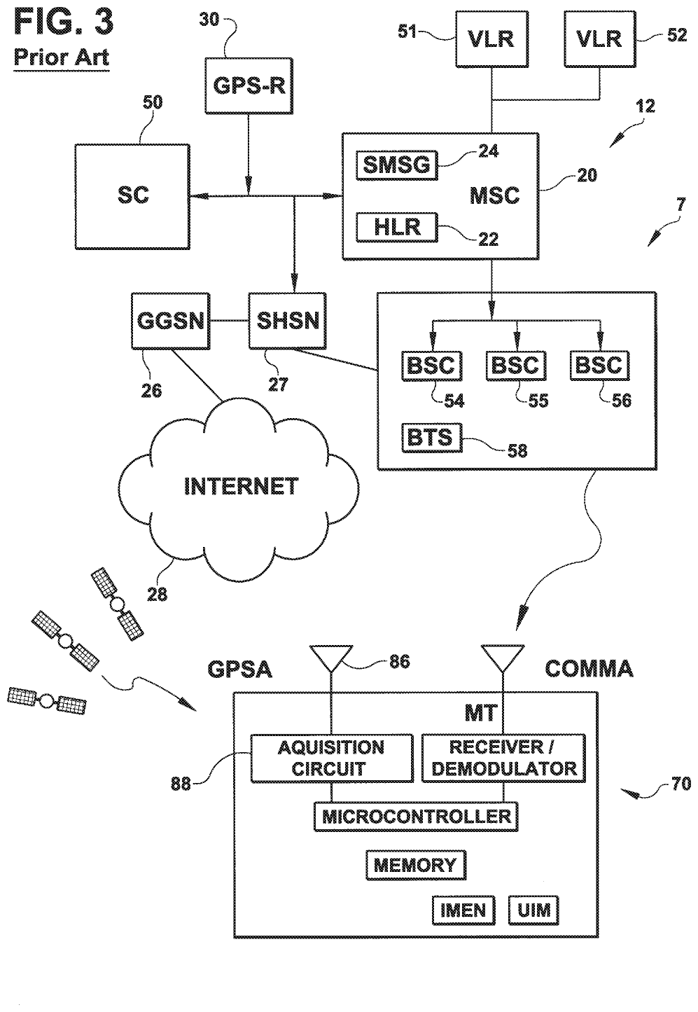

Prior art FIG. 3 shows the representative prior art cell phone system 5 of FIG. 2 provided with global positioning system (GPS). The U.S. Global Positioning System is a constellation of 24 satellites which orbit the earth in 12 hour orbits. The satellites are arranged in six orbital planes each containing four satellites. The constellation provides a user with approximately five to eight satellites visible from any point on earth. These satellites transmit as part of their message both satellite positioning data called “ephemeris” data and clock timing data. The satellites also transmit time-of-week information which allows a receiver to determine accurate time. Many new phones in the U.S., for example, have some GPS receiving capability built in. As shown in FIG. 3, MT 70 further comprises a GPS antenna 86 and GPS acquisition circuitry 88 for capturing satellite messages for use in calculating MT 70 receiver location and other information such as speed and direction. Assisted GPS enhances the performance of the GPS system by helping MT 70 locate satellite signals when MT 70 is surrounded by tall buildings or is indoors or under trees and assist MT 70 in calculating its position. GPRS functionality in MT 70, which allows direct connection to the Internet services for GSM mobile devices using SGSN 27 and GGSN 26, allows MT 70 GPS location information to be provided to network 12 regularly to allow network 12 to provide real time location data on MT 70. GPS location information on MT 70 may be stored in GPS-R register 30. Network 10 may use real time GPS data to track MT 70 through the network or use information derived from GPS data such as speed and direction of travel of MT 70. This information may be stored in GPS-R register 30. In some cases, a service provider may provide MT 70 with GPS functionality that is accessibly by third-party applications. Some companies like Accu-Tracking have developed software for installation on an MT 70 having such third party accessible GPS functionality. For a subscriber, Accu-Tracking tracks GPS data on MT 70 including direction of travel and speed of travel and displays these parameters on a subscriber Website for viewing by the subscriber over a computer. This service allows for example a parent to use an MT 70 of a child to track the movement of the child and if the child is driving a car to track the speed of the car. The service even permits audible alerts to be sent to MT 70 in the event the child is speeding.

All of the foregoing is common knowledge to one skilled in the art.

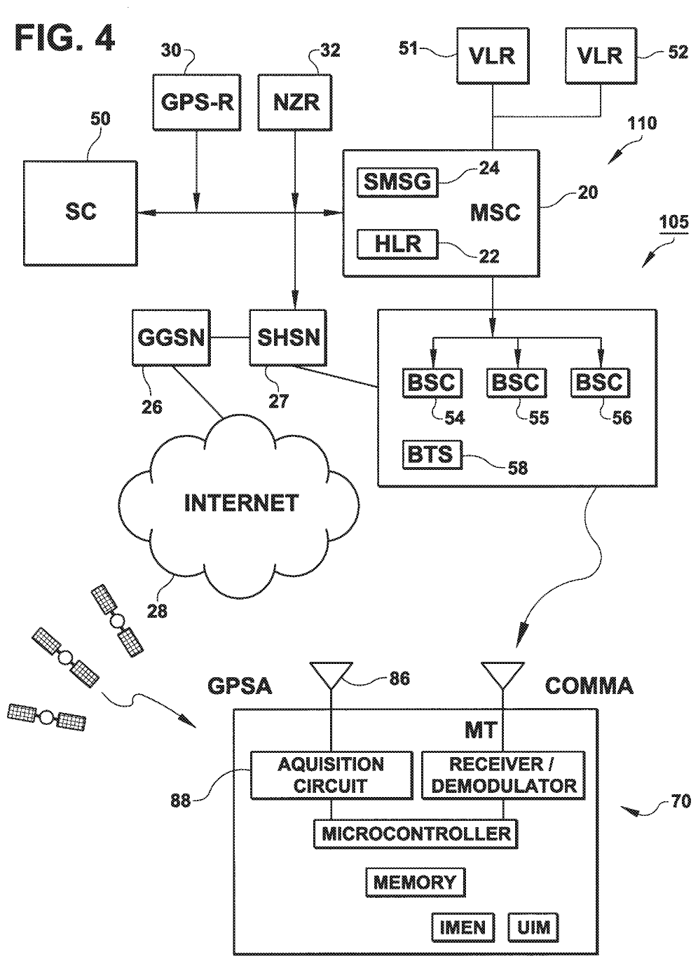

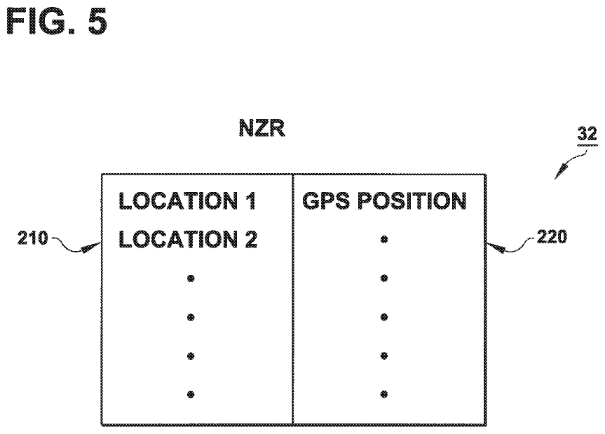

FIG. 4 shows an embodiment of the present invention. A cell phone system 105 comprises the representative prior art cell phone system 5 of FIG. 3 and a no communication zone register (NZR) 32. The representative elements of the prior art phone system 5 shown in FIG. 3 have been previously described. FIG. 5 shows an embodiment of NZR 32. As shown in FIG. 5, NZR 32 is a register that may include a table of geographical locations 210. Geographical locations 210 are physical locations in network 110 in which communication by or to MT 70 over network 110 is to be disabled and/or functions of the MT 70 are to be disabled, enabled or modified. Geographical locations 210 may be a hospital, a movie theater, a performing arts hall, a church, or other places where the use of cell phones may interfere with the public enjoyment, health, welfare, or safety. GPS positions 220 of the geographical locations 210 are provided for identifying the GPS positions of the locations. For a location that may be identified by an area of GPS positions, these GPS positions would be provided as GPS position 220 in the database of NZR 32.

In operation, GPRS functionality in MT 70 allows MT 70 GPS location information to be provided to network 110 regularly to allow network 110 to have real time location data on MT 70. GPS location information on MT 70 and derivative information such as speed and direction of travel of MT 70 generated by network 110 may be stored in GPS-R register 30. MSC 20 regularly queries whether the GPS location information of MT 70 is within a no communication zone (i.e., dead zone). If NZR 32 indicates MT 70 is not in a dead zone, the communication functionality of MT 70 remains enabled. If NZR 32 indicates MT 70 is in a dead zone, network 110 disables the communication functionality of MT 70 for so long as MT 70 is in the dead zone.

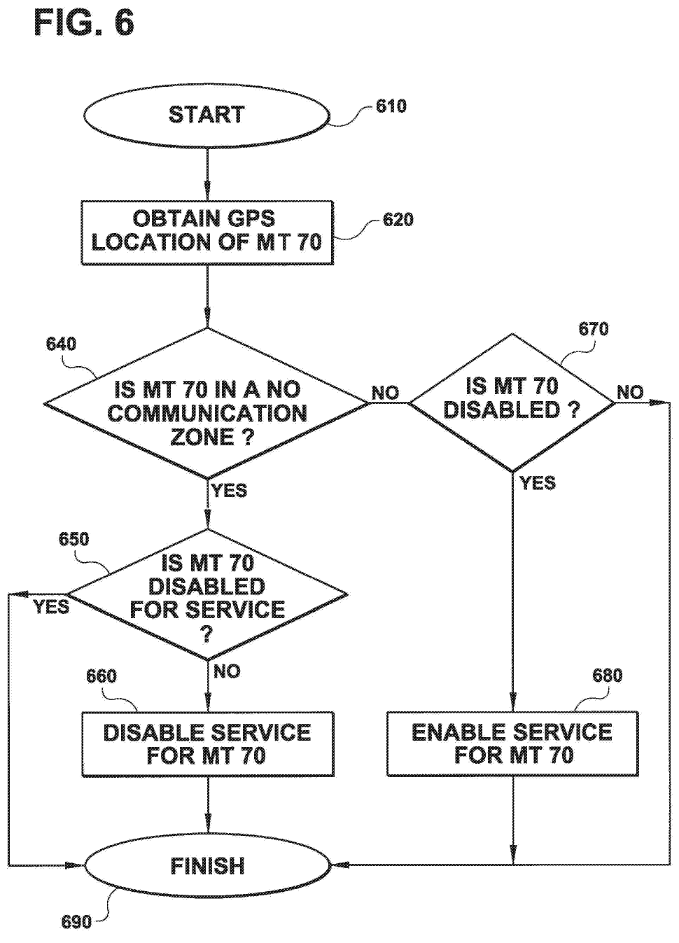

FIG. 6 shows a logic flow diagram for an embodiment. As shown, network 110 periodically or continuously employs an embodiment by entering the logic shown in FIG. 6 at the start control block 610. At control block 620, network 110 obtains the present GPS location of MT 70 from GPS-R register 30. At control block 640, network 110 queries whether the present GPS location of MT 70 is within a no communication zone location. This may be done by MSC 20 comparing the present location of MT 70 to the GPS locations contained in NZR 32. A match indicates MT 70 is in a no communication zone whereas a no match indicates that MT 70 lies outside that communication zone. If the query done at control block 640 indicates MT 70 is not in a no communication zone (i.e., dead zone), control branches to control block 670 where MSC 20 queries whether MT 70 is disabled. If MT 70 is not disabled because it was not in a dead zone, MSC 20 flows to control finish block 690 and the process is finished. If MT 70 is disabled because on the last pass through the control logic MT 70 was in a dead zone but on the current pass MT 70 in no longer in a dead zone, MSC 20 enables communication functionality of MT 70 at control block 680 and the process flows to control finish block 690. If the query at control block 640 indicates MT 70 is in a dead zone, control flows to control block 650 where network 110 queries whether the communication functionality of MT 70 is disabled. If the communication functionality is disabled, control flows to control finish block 690. If the control functionality is not disabled, network 110 control flows to control block 660 where the communication functionality of MT 70 is disabled after which the process flows to control finish block 690. Network 110 will keep communication functionality of MT 70 disabled for so long as MT 70 remains in the dead zone.

In the embodiment of FIG. 6, the control block 650 function of flagging off service for MT 70 may be done based on programmed service subscription information, service restrictions and supplementary information provided in HLR 22. For example, service restrictions on MT 70 may include disabling the service of MT 70 when MT 70 is in a dead zone. The same goes for service enablement. Alternatively, MT 70 service may be disabled or enabled using well known over-the-air programming techniques.

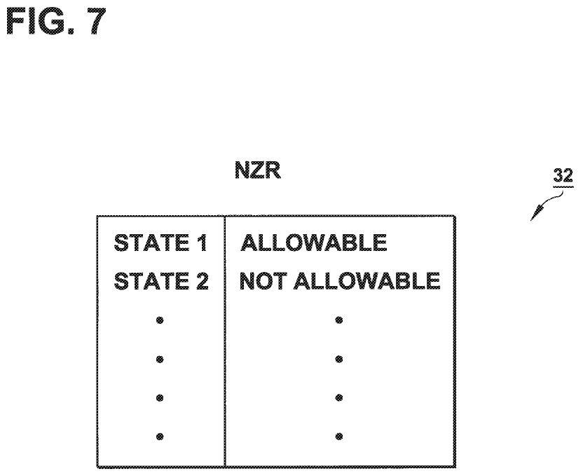

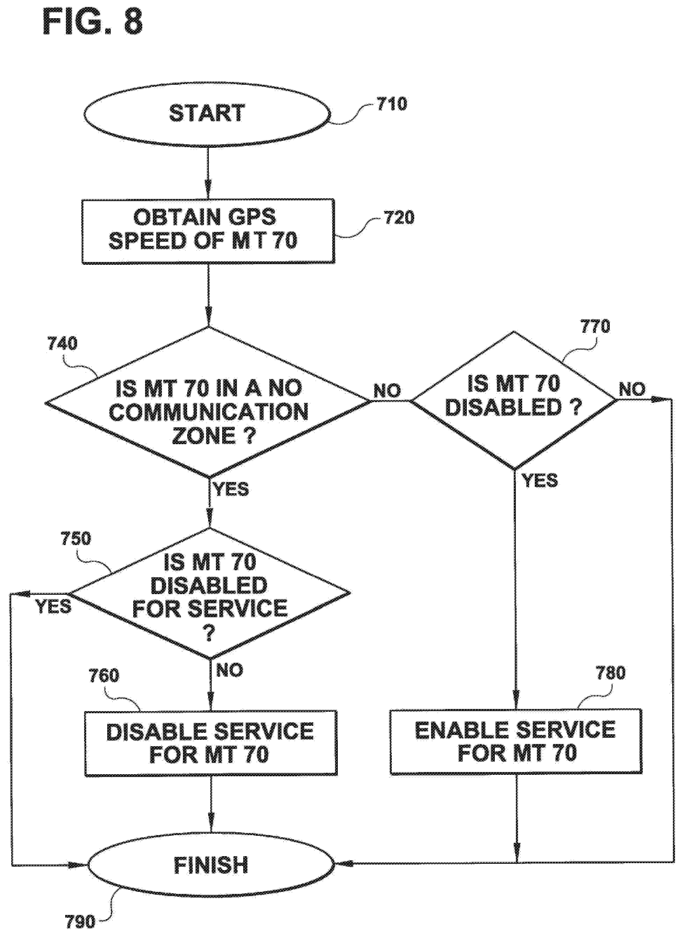

FIG. 7 shows another embodiment in which NZR 32 contains a database of states and information on whether the state allows cell phones to be used in a moving vehicle. In this embodiment, the moving vehicle may be a car or truck or motorcycle or bicycle and the allowable speed may be as simple as allowable or not. For example, states that do not allow the use of cell phones while driving would be denoted on the list as not allowable whereas the other states would be denoted as allowable. Referring to the logic flow of this embodiment shown in FIG. 8, after entering the control process at control start block 710 MSC 20 would obtain the GPS speed of MT 70 at control block 720 and at control block 740 query whether the speed of movement of MT 70 is at or above the speed denoted in NZR 32 shown in FIG. 7. If the speed of movement of MT 70 is at or above the speed denoted in NZR 32, then process flows to control block 750 and continues on in a manner similar to the manner described with like process control blocks shown in FIG. 6. If the speed of movement of MT 70 is not at or above the speed denoted in NZR 32, then process flows to control block 770 and continues on in a manner similar to the manner described with like process control blocks shown in FIG. 6.

In the example, the speed denoted in NZR 32 is either allowable which means that MT 70 may be used in vehicles or not allowable which means that MT 70 may not be used while driving. Alternatively, in states where use of a cell phone while driving is not permitted, NZR 32 may be set at a low speed instead of a no speed condition as specified in the prior example in order to allow for the possible use of a cell phone in a moving but non-driving condition, such as, while walking. By trading off a no speed condition in NZR 32 for a speed of, for example, a typical walking speed of a person, such as 5 miles per hour, the cell phone would be useable while walking but not when driving at speeds at or above 5 miles per hour.

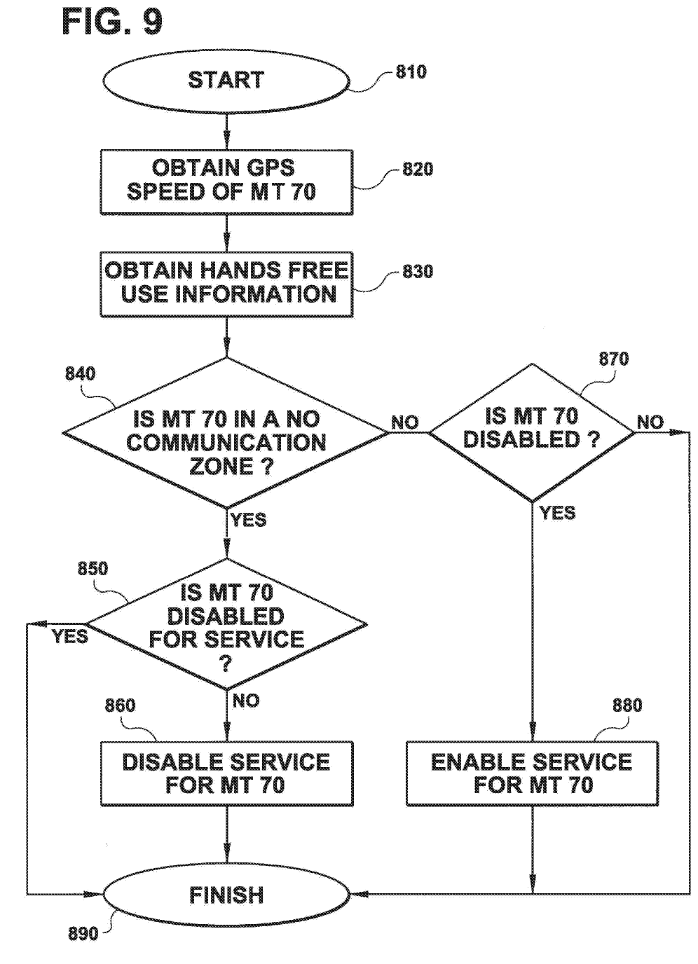

In a further embodiment, in some states, cell phone use while driving is permitted so long as done using a hands free device. FIG. 9 shows an illustrative embodiment of a logic flow diagram which recognizes whether MT 70 is being operated in hands free mode of operation. When operated in hands free mode of operation, MT 70 detects the hands free operation and transmits that information to network 110. In this example, NZR 32 in FIG. 7 would further include a designation of allowable with hands free condition in addition to the allowable and not allowable conditions previously described. In the process flow shown in FIG. 9, the network obtains the GPS speed of MT 70 at control block 820 and further obtains the hands free use information of MT 70 at control block 830. At control block 840, a no communication zone condition would occur if, for the state which requires MT 70 to be operated in a hands free mode of operation for MT 70 to be useable while driving, the MT 70 information obtained by network 110 shows MT 70 to have a GPS speed that satisfies the speed condition for disablement of communication and the condition of being used without a hands free. Based on this query at control block 840 network 110 proceeds through the remaining process shown in FIG. 9 in a manner similar to the manner described with like process control blocks shown in FIG. 6.

The foregoing embodiments preferably would not disable the ability of cell phones to place 911 or like calls for emergency purposes. In addition, there may be other instances in which calls may likewise be permitted such as in connection with calls from or to family members.

In another embodiment, the network in either one or more of the foregoing embodiments may be provided with a messaging service for messaging MT 70 that service is interrupted because the communication device is in a no communication zone. For example, messaging may be generated by the network and transmitted to MT 70 via gateway SMSG 24 and illustratively displayed in text form on a display on MT 70. Messaging an MT 70 via SMS gateway SMSG 24 is common knowledge to one skilled in the art.

While the foregoing embodiments illustrate the use of GPS location and derived speed, alternative embodiments may be useable with any GPS direct or derived information. As one example, where acceleration is derived from GPS data, the use of MT 70 could be conditioned on the acceleration of MT 70 in the network. In addition, embodiments may create conditions of dead zone of operation based on a blend of GPS and non-GPS data available to the network. For example, a dead zone may be further conditioned on the time of day of use of MT 70 such that at certain times of day a dead zone would exist to disable use of MT 70 whereas at other times of day the dead zone would be lifted to allow MT 70 to be used in that zone. In previous example further illustrates that embodiments may be used alone or in combination with one or more direct or derived information. As yet another example of the use of embodiments with a combination of information, in the situation where the operation of a communication device is not allowed in a city but allowed outside of a city, embodiments of the invention may track both the location of MT 70 with respect to the city as well as the speed of the MT 70 at its location. Whether MT 70 would be operable would turn on the conditions that MT 70 satisfies where used.

In the previous embodiments, except as to establishments that may be mandated by applicable laws to be included on the dead zone list which would need to be included on the list, the network generates the dead zone list of hospitals, movie theaters, performing arts halls, churches, or other places where the use of cell phones may interfere with the public enjoyment, health, welfare, or safety, possibly based upon publicly available information. In another embodiment, if the establishment is listed on the dead zone list by default, unless it is one of the mandated establishments, the establishment may have the option to elect to be dropped from the list so as to allow MT 70 to be used in its establishment. For example, a restaurant that may be included on the dead zone list by default may elect to be dropped from the list in order to allow its customers to use MT 70 in its establishment. As yet another embodiment, any establishment that may not be included on the default dead zone list may have the option to elect to be included on the dead zone. For example, a store or a football stadium may request to be included on the dead zone list in order to prevent the use of MT 70 from disturbing its patrons. As yet another example, inclusion of an establishment on the dead zone list may be by way of a service offering provided by the service provider. The service may be offered at no charge to an establishment or may offered on a subscription fee basis. With this service, an establishment may elect to have their establishment included on the dead zone list by subscription to the service.

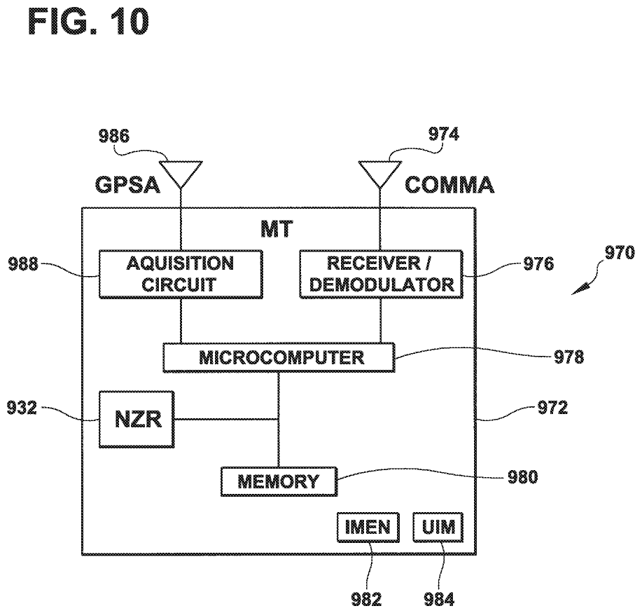

FIG. 10 shows another embodiment of the invention in which in the representative prior art cell phone system 7 of FIG. 3 MT 70 includes a no communication zone register (NZR) 932 including a database of predetermined zones in which communication by, to, or by and to MT 970 is to be disabled and/or functions of MT 970 are to be disabled, enabled, or modified. In this embodiment, MT 970 tracks its location based on GPS positioning data (alone or with the aid of AGPS). When MT 970 is in one of the predetermined zones in which certain communication by, to, or by and to MT 970 is not permitted, MT 970 is disabled from handling the certain communication by, to, or by and to MT 970. NZR 932 is a register like shown and discussed in connection with FIG. 5 that may include a table of geographical locations. The listing of geographical locations may be limited by the size of the register. For example, in view of the size constraints of the available semiconductor space in MT 970, the geographical locations could be limited to a limited set of predetermined locations such as movie theaters within a 10 mile radius of the billing address of the mobile user. To be maintained current, NZR 923 could be updated by the network 12 in which MT 970 is authorized to be used by the employment of well-known over the air reprogramming technologies. The logic for the embodiment of the invention shown in FIG. 10 may be similar to the logic shown in FIG. 6 except that control block 620, which is shown to obtains GPS location of MT 70, would be done by MT 970 and not by the network as discussed in connection with FIG. 6.

As an alternative embodiment, NZR 932 may be a register like shown and discussed in connection with FIG. 7 that may include a table of conditions on the speed of MT 70. In this embodiment, MT 970 further comprises software for calculating the speed of MT 970 from GPS positioning data. Since speed is the distance traveled in a specified time, software may, using GPS position data, track the distance traveled by MT 970 in a specified time and calculate the speed. The sophistication of the calculation may be limited by available semiconductor considerations. The logic for this embodiment of the invention may be similar to the logic shown in FIG. 8 or 9 except that control block 720 and 820, which is shown to obtain speed information on MT 70, would be done by MT 970 and not by the network as discussed in connection with FIGS. 8 and 9.

In the embodiment of FIG. 10, the predetermined zone may be a geographical location, and may comprise a GPS position. Alternatively, the predetermined zone may comprise a condition on the speed of the wireless communication device in said network where the speed may be derived from GPS position data. Disabling of communication with respect to the wireless communication device in FIG. 10 may occur by enablement of a flag in the wireless communication device that prevents the wireless communication device to place, receive, or place and receive the certain communication while the communication device is in the no communication zone. The condition on the speed of the wireless device may be taken from the group of no communication allowed, communication allowed, and communication allowed under certain preconditions. The device may recognize that the wireless communication device is operating in a hands free mode of operation. The certain communication disabled may exclude communication under conditions taken from the group of the speed of said wireless communication device is less than a predetermined speed and said wireless is being used in a hands free mode of operation. The certain communication disabled may exclude communication under an emergency call. On interruption of service, the device may display a message indicating that service is interrupted because the communication device is in a no communication zone.

As yet another embodiment, MT 970 may be used in the network shown in FIG. 4. One of the benefits of such a hybrid configuration in which both the network and the terminal contain a no communication zone register is that it may allow for quicker adoption of the technology. This by allowing, for example, legacy mobile terminals, that are without the architecture and/or semiconductor real estate that might allow for over the air reprogramming of the terminal with no zone register communication functionality, to be disabled using no zone communication registers located in the network while newer model terminals are provided with no communication functionality in the terminal.

In an embodiment of a method for disabling predetermined communication by, to, or by and to a wireless communication device, the method comprises: creating a no communication zone of locations wherein the wireless communication device is to be disabled; tracking predetermined positioning data on the wireless communication device; querying whether the predetermined positioning data is within the no communication zone location; and if the wireless communication device is in a no communication zone location, disabling certain communication by, to, or by and to the wireless communication device.

While the foregoing embodiments illustrate the use of GPS location and derived speed, in alternative embodiments the invention may be useable with any GPS direct or derived information. As one example, where acceleration is derived from GPS data, the use of MT 70 could be conditioned on the acceleration of MT 70 in the network. In addition, embodiments of the invention may create conditions of dead zone of operation based on a blend of GPS and non-GPS data. For example, a dead zone may be further conditioned on the time of day of use of MT 70 such that at certain times of day a dead zone would exist to disable use of MT 70 whereas at other times of day the dead zone would be lifted to allow MT 70 to be used in that zone. The previous example further illustrates that embodiments of the invention may be used alone or in combination with one or more direct or derived information. As yet another example of the use of embodiments of the invention with a combination of information, in the situation where the operation of a communication device is not allowed in a city but allowed outside of a city, embodiments may track both the location of MT 70 with respect to the city as well as the speed of the MT 70 at its location. Whether MT 70 would be operable would turn on the conditions that MT 70 satisfies where used.

While the foregoing embodiments for disablement of MT 70 have been disclosed, there are other ways well known to those skilled in the art in which communication by, to, or by and to a wireless communication device may be restricted and these other well-known ways provide yet other embodiments how the communication of MT 70 may be disabled and the implementation of these other ways of restricting the wireless communication of MT 70 are incorporated herein as to these other embodiments that use Applicant's dead zone invention for wireless communication devices. For example, disablement may occur by the network or device flagging on a feature that overrides the password of MT 70 when MT 70 is in a dead zone which prevents a user from unlocking his phone for use while in the dead zone. As yet another example, disablement may occur by the network or device flagging on a feature that disables the send/receive keypad on MT 70.

In the previous embodiments, except as to establishments that may be mandated by applicable laws to be included on the dead zone list which would need to be included on the list, the network may generate the dead zone list of hospitals, movie theaters, performing arts halls, churches, or other places where the use of cell phones may interfere with the public enjoyment, health, welfare, or safety, possibly based upon publicly available information. In another embodiment, if the establishment is listed on the dead zone list by default, unless it is one of the mandated establishments, the establishment may have the option to elect to be dropped from the list so as to allow MT 70 to be used in its establishment. For example, a restaurant that may be included on the dead zone list by default may elect to be dropped from the list in order to allow its customers to use MT 70 in its establishment. As yet another embodiment, any establishment that may not be included on the default dead zone list may have the option to elect to be included on the dead zone. For example, a store or a football stadium may request to be included on the dead zone list in order to prevent the use of MT 70 from disturbing its patrons. As yet another example, inclusion of an establishment on the dead zone list may be by way of a service offering provided by the service provider. The service may be offered at no charge to an establishment or may offered on a subscription fee basis. With this service, an establishment may elect to have their establishment included on the dead zone list by subscription to the service.

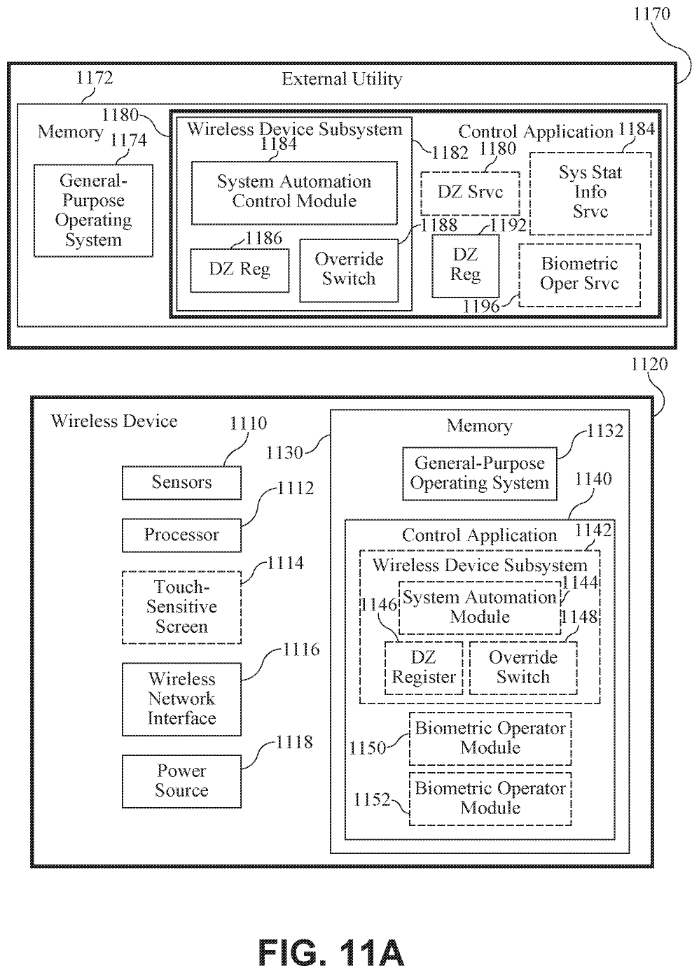

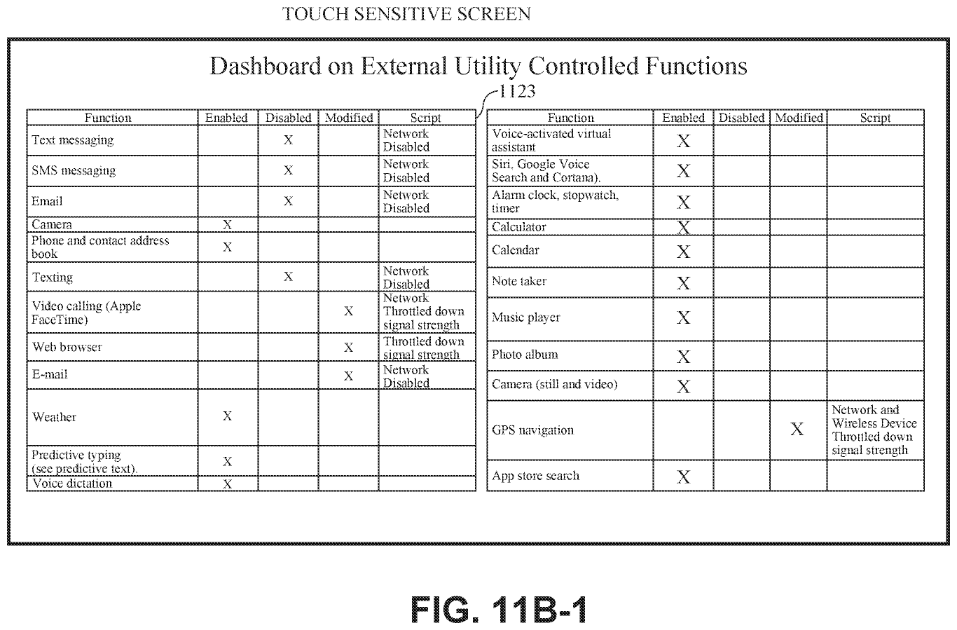

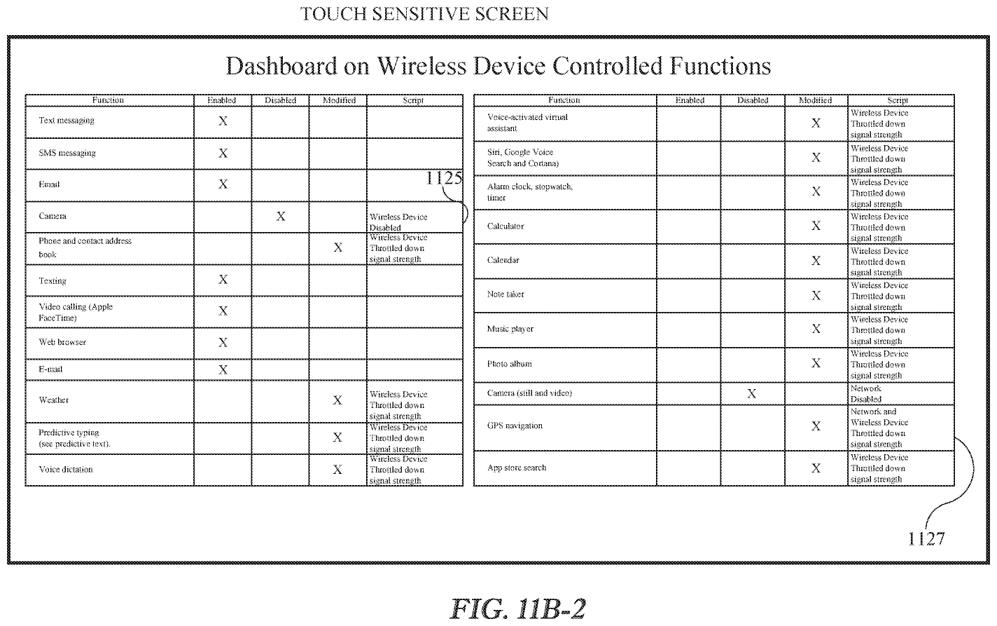

FIG. 11A shows an illustrative embodiment of this disclosure comprising a wireless device 1120 and an external utility 170. Wireless device 1120 comprises a processor 1112 and a memory 1130. External utility comprises a memory 1172 for storing instructions for execution by processor 1112 or by an external processor. A processor (not shown) may be associated with memory 1172 to execute instructions stored in the memory. The instructions may be configured to execute control instructions of general purpose operating system 1174 and control applications 1180.

Processor 1112 may be hardware and software configured to process instructions. The processor may be implemented in any number of ways. Such ways include, by way of example and not of limitation, digital and/or analog processors such as microprocessors and digital-signal processors (DSPs); controllers such as microcontrollers; software running in a machine; programmable circuits such as Field Programmable Gate Arrays (FPGAs), Field-Programmable Analog Arrays (FPAAs), Programmable Logic Devices (PLDs), Application Specific Integrated Circuits (ASICs), any combination of one or more of these, and so on. Processor associated with external utility 1170 may be a server class processor, or other processor configured for executing control instructions associated with general purpose operating system 1174 and control applications 1180.

Memory 1130 may be any physical device capable of storing information temporarily or permanently. Memory may be implemented in any number of ways. Such ways include, by way of example and not of limitation, nonvolatile memories (NVM), read-only memories (ROM), random access memories (RAM), any combination of these, etc. Memory 1130 may include programs containing instructions for execution by processor 1112 or a processor external to the wireless device. The instructions perform the functions described in this disclosure including performing protocols, decision making analytics, and so on. In addition, memory 1130 may store rules, configurations, data, etc. Memory 1172 of external utility 1170 may be a server class memory, or other memory configured for storing control instructions associated with general purpose operating system 1174 and control applications 1180.

At least some of the software and data structures stored in the memory 1130 of the wireless device 1120 implements a general-purpose operating system 1132 that functionally organizes the wireless device 1120. The general-purpose operating system 1132 may be a type of operating system, that is capable of executing a variety of types of software applications, including applications related to wireless device control.

The general purpose operating system 1174 of external utility 1170 may be a type of operating system that is capable of executing a variety of types of software applications, including applications related to wireless device control. It will be understood that a general purpose operating system includes operating systems that, while capable of executing a variety of software applications, may be configured for special-purpose applications in any particular embodiment.

At least another part of the software and data structures in the memory 1130 of the wireless device 1120 stores a control application 1180 that is utilized to control external utility functions as disclosed herein.

At least another part of the software and data structures in the memory 1172 of the external utility stores a control application 1180 that is utilized to control wireless device functions as disclosed herein.

The control application 1140 of wireless device 1120 may include a wireless device subsystem 1142, a biometric operator module 1150, and a system status information module 1152. The wireless device subsystem 1142 of wireless device 1120 may include a system automation module, a dead zone (DZ) register 1146, and an override switch 1148.

The control application 1180 of external utility 1170 may include a wireless device subsystem 1182, a dead zone (DZ) service 1190, a dead zone (DZ) register 1192, a biometric operator service 1196, and a system status information module 1194. The wireless device subsystem 1182 of external utility 1170 may include a system automation control module 1184, a dead zone (DZ) register 1186, and an override switch 1188.

The wireless device subsystem 1142 of wireless device 1120 may be hardware and software configured to monitor and control the wireless device. The wireless device subsystem 1142 of wireless device 1120 is also electrically coupled to, and provides control signals to wireless device subsystems such as sensors 1110 (or other subsystems, e.g., camera operation, scanning operation, texting, emailing, internet connectivity, etc.) that implement image capture, motion, wireless communication, internet browsing, and/or other function control. In one illustrative embodiment, the wireless device subsystem 1142 of wireless device 1120 is electrically coupled to one or more sensors 1110 onboard the wireless device as explained below. Image data, system status data, and/or other data may be detected by sensors or collected, under the direction of wireless device subsystem 1142 of wireless device 1120 for processing by the wireless device subsystem 1142 of wireless device 1120. Illustratively, the wireless device subsystem 1142 of wireless device 1120 may be configured to control the operation of the lower level systems of wireless device as explained below.

Alternatively, control of the lower level systems of wireless device may be by wireless device subsystem 1182 of external utility 1170, or by both the wireless device subsystem 1182 of external utility 1170 and the wireless device subsystem 1142 of wireless device 1120. The wireless device subsystem 1182 of external utility 1170 may be hardware and software configured to monitor and control the wireless device from an external location.

The DZ register 1146 of the wireless device subsystem 1142 of wireless device 1120 may be a portion of memory 1130 that stores locations in which a function of the wireless device should be disabled or modified in order to adapt to the requirements specified for the location. In another illustrative embodiment, the DZ register 1186 of wireless device subsystem 1182 of external utility 1170 may store locations in which a function of the wireless device should be disabled or modified in order to adapt to the requirements specified for the location. In another embodiment, the DZ register 1192 of the external utility 1170 may store locations in which a function of the wireless device should be disabled or modified in order to adapt to the requirements specified for the location. In another embodiment, combinations of DZ registers may be used according to this disclosure. For example, DZ register 1186 may contain dead zone locations on the network level and DZ register 1146 may contain dead zone locations on the wireless device level customized for a particular wireless device or user. DZ register 1192 may contain dead zone locations useable by a DZ service 1190. For example, a communication service provider for the wireless device may customize DZ register 1146 and DZ register 1186 in accordance with restrictions and permissions set by the service provider; while DZ register 1192 may be dead zone locations for which restrictions and permissions are set by a specific DZ service 1190. For instance, if the wireless device is associated with a firearm as per the examples below, a firearm bureau may operate the DZ service 1190 and use the DZ register 1192 for dead zone locations applicable to that service while the provider of the communication service may control the dead zone locations in DZ register 1186.

Dead zone locations may be locations in which the functionality of one or more features of a wireless device may be prohibited. Where, for example, the dead zone is a location in which all voice communications are prohibited, a wireless device in such a dead zone location may by the teachings of this disclosure cause the cellular and voice over IP (VOIP) functions of the wireless device to be disabled. However, the other communication features of a wireless device such as text messaging or emailing or internet browsing may still be enabled and so be allowed. In this example, some but not all communication functionalities of a wireless device may be disabled by the teachings of this disclosure. In another example, all communication functionality of a wireless device may be disabled during the duration of time that the wireless device is in the dead zone. For instance, if the dead zone is a location where a wireless device should not be used, the communication features of the wireless device may be disabled.

The teachings of this disclosure also permit the functionalities of a wireless device to be modified without disablement. For instance, a wireless device that is approaching a dead zone may be modified by the teachings of this disclosure so that the user is aware that he is approaching a dead zone. For instance, the teachings of this disclosure may cause a communication signal to the smart phone to become weaker and weaker the closer the wireless device gets to the dead zone. This may cause the wireless device to change direction to avoid the dead zone to avoid the disablement of functionalities. In another example, a dead zone may permit a wireless device to render displays on a screen of the wireless device but at an intensity level that is less annoying to others on location. The teachings of this disclosure may modify the intensity settings of the wireless device to allow this to happen.

The wireless device subsystem 1142 of wireless device 1120 may include an override switch 1148. The override switch may be hardware and software configured to override the control of the wireless device as explained below. Where, for instance, a wireless device enters a dead zone, a control signal from system automation control module 1184 of wireless device 1120 may be applied to the override switch 1148. The output from the override switch 1148 may override control of the wireless device and disable the functionalities that are not permitted by the wireless device while in a dead zone.

Alternatively, where control of the lower level systems of wireless device may be by wireless device subsystem 1182 of external utility 1170, a control signal from system automation control module 1184 of external utility 1170 may be applied to an override switch 1188. The output from the override switch 1188 may override control of the wireless device and disable the functionalities that are not permitted by the wireless device while in a dead zone.

In operation, image, system status, or other data may be collected by the wireless device, the external utility 1170, or both. And the wireless device subsystem 1142 of wireless device 1120, the wireless device subsystem 1182 of external utility 1170, or both in turn issues appropriate control signals to lower level systems of the wireless device to control their performance (such as disable function of the wireless device).

The biometric operator module 1150 may be hardware and software configured to calculate one or more biometric data or metrics, determine therefrom identity indicia on the operator currently using the wireless device, and based on the identity indicia, enable or disable functionality of the wireless device or services provided to the wireless device as described herein. Biometric data or metrics may include one or more of data samples, models, fingerprints, similarity scores and verification or identification data.

Biometric data or metrics may be used to authenticate a user of the wireless device for purposes such as identification and access control. A biometric operator monitor may employ a biometric identification technique such as face recognition, fingerprint identification, hand geometry biometrics, retina scan, iris scan, signature, voice analysis, and so to authenticate a user and access control. For example, if the biometrics of an operator do not match the biometrics of an authorized wireless device operator encoded in the memory 1130 (e.g., the operator is not the registered user of the wireless device), the biometric operator module may not enable the wireless device or if the wireless device is enabled, the biometric operator module may disable the wireless device.

Alternatively, external utility 1170 may include a biometric operator service 1196. Biometric operator service may be server class hardware and software configured to calculate one or more biometric data or metrics, determine therefrom identity indicia on the operator currently using the wireless device, and based on the identity indicia, enable or disable functionality of the wireless device or services provided to the wireless device as described herein. Alternatively, biometric operator service may be non-server class hardware and software.

Alternatively, if the operator is not the registered user of the wireless device, the biometric operator module may perform one or more other sequences, such as a sequence to determine, notwithstanding the operator not being the registered user of the wireless device, whether the operator is someone otherwise authorized to use the wireless device. For example, in the illustrative embodiment of FIG. 11A, a cloud service may be provided comprising a registry of biometric or other data on law enforcement officers. The biometric operator module may provide to the cloud service the biometric or other data on the person seeking to use the wireless device. The cloud service may then perform a set of instructions to determine whether the provided biometric data of the intended user matches the biometric data of a law enforcement officer. If there is a match, the cloud service may communicate to the biometric operator monitor to provide control instructions to enable the wireless device for use by the intended user. A biometric operator service 1196 in memory 1172 may provide this service of controlling the enable/disable functionality of the wireless device or services provided by the network to the wireless device based upon biometric data.

The system status information module 1152 may be hardware and software configured to provide system status information that may include data on why a wireless device remains disabled or functions of the wireless device remain disabled notwithstanding the desire of the operator to use the wireless device, information on the condition of the wireless device, instructions on what an operator may do in order to enable the firearm, and so on. For example, the status data may indicate that the biometric recognition failed; try again. Or the status data may indicate that the wireless device is in a dead zone; move to another location. The status data may also indicate that the power source is low; recharge or change battery. Other information may also be provided.

To provide feedback to an operator on the system status information, the electronic control system may also include a speaker, to issue voice prompts, etc. The electronic control system may also include visual gauges like a gauge to indicate the amount of power left and a gauge that changes in a condition such as changing a color, such as green, when a function of a wireless device is enabled according to this disclosure, and another color, such as red, when a function of the wireless device is enabled.

As depicted in FIG. 11B, touch-sensitive screen 1114 may display a dashboard of one or more functions of the wireless device that are controlled by the system automation module 1144 of the wireless device 1120, the system automation control module 1184 of the external utility 1170, or both. The dashboard provides enablement/disablement/modified indicia along with a script. The script may be a program that operates on the external utility and wireless device, as the case may be. Illustrative functions of the wireless device controlled by this disclosure illustrated on the dashboard are elements 1125, 1123, and 1127 associated with disablement by the wireless device, disablement by the external utility, and a modification of the functionality by both wireless device and external utility according to this disclosure. In the case of element 1127, a script would modify the performance of the GPS navigation system. Since in this example, a script from both external device and wireless device would apply, the script with the higher priority would apply to control the modification of the indicated function.

FIG. 11C depicts a logic map for enablement/disablement/modification of a wireless device by wireless device subsystem 1182 and wireless device subsystem 1142 (e.g., a logic map distributed across the wireless device 1120 and external utility 1170). As indicated, if both network and wireless device enable a function of the wireless device, the function will be enabled. If any one or both network and wireless device disable a function of the wireless device, the function will be disabled. If either network or wireless device is enabled and the other of network and wireless device is configured to run a script or to modify the functionality of the wireless device, the script will execute and provide control signals for controlling or modifying the function. If both network and wireless device invoke scripts or modification, then the script or modification that has been ascribed the higher priority will execute and provide control signals for controlling or modifying the function.

A system status information service 1194 in external utility 1170 may provide system status information to the wireless device for controlling the enable/disable functionality of the wireless device or services provided by the network to the wireless device.

A dead zone (DZ) service 1190 in external utility 1170 may provide dead zone services to the wireless device for controlling the enable/disable functionality of the wireless device or services provided by the network to the wireless device. For example, a third party may set up a dead zone subscription service whereby churches, restaurants, and so on may subscribe to have control signals sent to control functionality in wireless devices that are on the premises of the subscriber.

The wireless device may include a touch-sensitive screen 1114 to allow a wireless device operator to interface with the wireless device. The touch-sensitive screen may be a computer display screen that is also an input device. Illustratively, the touch-screen may be integrated with the electronic control system of the wireless device to allow an operator of the wireless device to provide input commands to the wireless device and to scroll, navigate, and zoom image, system status, and other data rendered on the touch-sensitive screen. Alternatively, any enable/disable control interface may be used in place of the touch-screen.

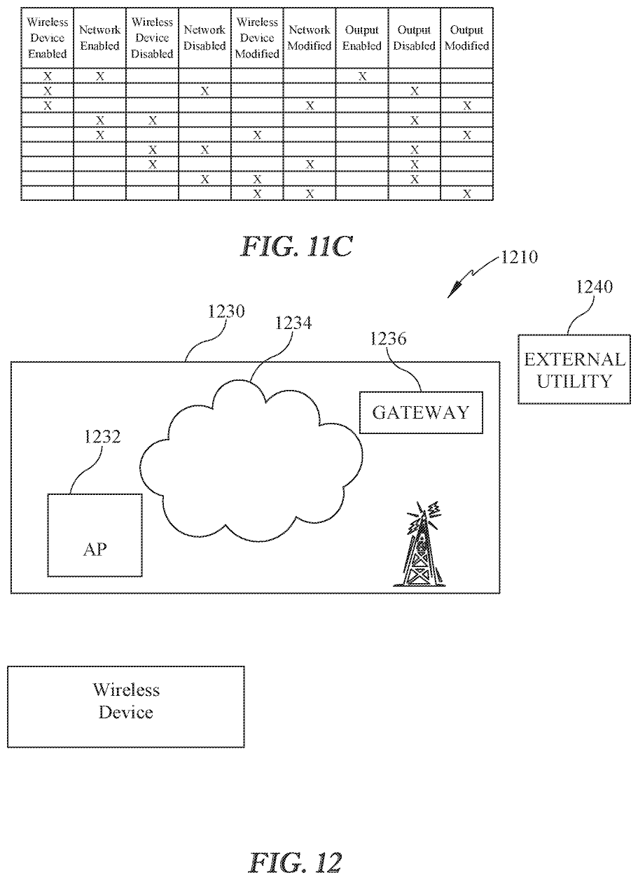

The screens may be sensitive to pressure. A user may interact with the wireless device by touching pictures or words on the screen. The touch-sensitive screen 1114 may be configured to visually display information and to received input, including touches and gestures entered by an operator. Alternatively, the touch-sensitive screen 1114 may be provided by the display of a wireless mobile device. Illustrative examples of wireless mobile devices include tablet computers, smartphones, and certain portable media players that execute general-purpose operating systems. Alternatively, the touch-sensitive screen 1114 may be provided by the display of an external utility configured to wirelessly communicate with the wireless device of this disclosure. The wireless communication of the wireless mobile device or external utility with the wireless device may be over a wireless network 1230 described below in connection with FIG. 12 below. Alternatively, the wireless mobile devices, external utility, or other enable/disable control interface, such as a monitor, may be hardwire tethered to the wireless device of this disclosure through communication ports.

As described above, the touch-sensitive screen may allow the image, system status, or other data to be displayed on a user interface (UI) on the touch-sensitive screen 1114 (FIG. 11A), and may receive control input indicating desired motion and/or other function control via the UI, such as when firearm operator control is permitted in the embodiment described below. The desired motion may be scrolling, navigating, and zooming image, system, and other data rendered on the touch-sensitive screen. This control input may be passed to the network 1230 for transmission back to the external utility 1170 (FIG. 11A) (which may be a server 1240) where permitted. The network 1230 may be a public or private network, or combination of both.

The touch-sensitive screen may also enable an operator of the wireless device to pass data to the network through wireless network interface 1116 for transmission back to an external utility 1170 (FIG. 11A) over a wireless network, when permitted. The touch-sensitive screen may also render on the display of the touch-sensitive screen data received over the wireless network from a cloud service or other external utilities over the network. For instance, data streamed into the wireless device for rendering on the touch-sensitive screen (or for broadcast audibly) may include data on why one or more features of a wireless device remains disabled, data requiring the operator to perform certain steps before enabling the wireless device, data resulting from a biometric check done by a cloud server as previously described, and so on.

The external utility may provide a control signal to wireless network interface 1116 for use by wireless device in controlling the firearm as disclosed herein.

An operator may be permitted to access data, such as image, system status, other data, update data, and/or confirm data, and so on. For example, an operator may have permission to access system status data in order to understand why a wireless device functionality has been disabled. The dashboard depicted in FIG. 11B illustrates one way in which such information may be made available to an operator.

A service provider may have permission to update status data over a network as disclosed herein. In one illustrative example, the service provider may be a bureau, such as a government entity enabled with permissions to update status information. A law enforcement officer may have permission enable a wireless device that is not his own. Permission may be illustratively granted using a cloud service including a registry on biometric data as previously explained.

Permission may be given to a user of the wireless device in other situations after a condition has triggered the functionality of the wireless device to be disabled. For example, a user may have permission to make a 911 call even in a location where calling is prohibited or restricted. In another example, a law enforcement officer entering a dead zone in hot pursuit of armed robbers may, for example, using permissions, over-ride the disabling of the wireless device to allow one or more functionalities to be used. Permissions may be encoded in the memory of the wireless device or stored in a cloud service which may include a registry of persons with permission to operate the wireless device.

The wireless device may also include an enable/disable control interface through which a remote operator or service may monitor and control the wireless device as described herein. For example, the wireless device subsystem 1142 of the wireless device may include an interface through which a remote operator or service may monitor and control the wireless device as described herein.

The wireless device may be provided with a microphone for the electronic control system to receive voice commands, such as by an operator, like “try again” or “reboot”, and so on.

In another embodiment, a plurality of wireless devices may be tethered or wirelessly connected to an off boarded computing device. The computing device may serve the plurality of wireless devices in one or more ways, such as by validating the operator, providing services, and so forth. A plurality of wireless devices may be wirelessly connected to a remote computing device for purposes of monitoring and controlling the wireless device in the dead zone area, such as by disabling a functionality of the wireless device when an operator is entering a dead zone.

FIG. 11A shows a wireless device may that further include sensors 1110. Sensors 1110 may comprise an image capture sensor, another sensor, or a combination of both. The image capture sensor may be hardware and software configured to capture an image. Image capture sensors typically include one or more light sensors. A light source may also be included to emit light to be reflected off an object. The light sensors capture and translate the reflected light into electrical signals. The image captured may be a photo image. For example, the light sensors may be a high-pixel resolution CCD (charge coupled device) chip and it and associated hardware may be used for generating digital images. The software for processing the captured images may reside in the memory 1130 or a section of memory. Alternatively, the image capture sensors may be provided with a processor and a memory for storing and executing this image processing software.

Other sensors may include heat, location accelerometer, a gyroscope, a magnetometer, a proximity sensor, a gravity sensor, a linear accelerometer, and so on. Additional sensors may include light sensor, camera sensors, microphone sensors, touch sensors, pressure sensor, temperature sensor, humidity sensor, and so on.

Illustratively, the wireless network interface 1116 may comprise transceiver circuitry and software for sending and receiving packets over a wireless network (e.g., an IEEE 802.11 WLAN). Alternatively, the transceiver may be hardware and software configured to transmit data to and from the electronic control system and a network or an external device including Wi-Fi, blue tooth CDMA, and so on, that enables a wireless communication link for between the electronic control system and an external device.

In an alternative embodiment, the wireless network interface 1116 may be combined with or replaced by a hardwire connect for electrically connecting the electronic control system to the network by wire, such as one or more ports and associated circuitry and software that allow wired communication between the electronic control system and an external device (e.g., an Ethernet connector, an RS232 connector, a USB or other wire connector.)

A hardwire connect may be used, for example, to tether a wireless device to another wireless device to enable the functionality of the wireless device to assist, augment, enhance, or complement functionality that is provided by the wireless device. In one example, the tether permits the wireless network interface of the smart phone to be used by the electronic control system to communicate with external devices or a network. For example, a smart phone received and held in a pocket of a garment worn by the operator may be tethered to the wireless device so as to allow the smart phone to communicate with the wireless device to perform the functionalities of this disclosure. For example, the touch-screen of the display of the mobile device may provide the touch-sensitive screen 1114 of the wireless device. In another example, the wireless network interface of the smart phone may provide the hardware and software to establish a wireless communication link with a network.

The wireless network interface 1116, hardwire connect, or both may enable any computing device to be electrically connected to the wireless device of this disclosure. By computing device is meant servers, intermediary servers, personal computers, cellular phones, smart phones, wireless computers, wireless lap-top computers, mobile devices such as tablet computers, pad computers, personal digital assistant, wireless sensors or networks of sensors, such as mesh network sensors, and so on may be in electrical communication with to provide functionality to the electronic control system.

In another illustrative embodiment, a wireless mobile device such as a smartphone or other computing device may be the wireless device of this disclosure. In this embodiment, the smartphone may provide the processor, memory, and wireless network interface functionalities of the electronic control system according to this disclosure. The battery of the smartphone may provide power for the firearm subsystem or enhance a power system provided the firearm for operating the firearm subsystem.

FIG. 12 shows an illustrative embodiment system 1210 implementation of FIG. 11 of this disclosure comprising a wireless device 1220, a network 1230, and an external utility 1240.

Wireless device 1220 has been previously described. Network illustratively may include access point 1232, base station 1238, a cloud 1234, and a gateway 1236. Network may include an access point or base station or both. Networking may also occur on a peer-to-peer basis where possible.

Access point 1232 is a station that transmits and receives data (sometimes referred to as a transceiver). An access point connects users to other users within the network and also can serve as the point of interconnection between the WLAN and a fixed wire network. A base station is a fixed point of communication for customer cellular phones on a carrier network. A cloud is a network of computers through which data passes between two end points. A gateway 1236 is a network node that connects two networks using different protocols together.

External utility 1240 comprises one or more programmed computers that may be connected to the wireless device 1220 wirelessly or by wired connection in order to allow for the exchange of data and control signals between the electronic control system and the external utility through wireless network interface 1116 and/or hardware connection as previously explained. The external utility of this disclosure may be a cloud server. A server may be any computer configured to serve the requests of client programs running on the same or other computers on a network. The computer of the external utility may be a host computer configured to serve the requests of one or more client programs residing in the safety disarm module. Alternatively, the computer of the external utility may serve a client residing on the external utility or on some other computer to which the external utility may be connected. Depending on the computing service that the server is configured to offer, the server may include one or more of a file server for storing and making files accessible for reading and writing to the client, a print server that manages one or more printers, a network server that manages network traffic, a mail server that manages mail on a network, a database server that allows clients to interact with a database, a firearm server for managing firearm records, and so on. The server may also be in communication with one or more other servers that may include one or more of the foregoing or other servers. The foregoing and servers may provide a service to the firearm operator. For instance, the print server may enable a firearm operator to print an image of a target or print information on why the firearm was not armed, or information on the use of the firearm such as day and time of use, time of firing, number of firings, location, and so on. Sensors associated with the firearm may track movement of the firearm for printing by the print server for investigative, historical, archival, or other purposes.

The computer of the external utility may be any computer (e.g., end user device or server) including servers, intermediary servers, personal computers, cellular phones, smart phones, wireless computers, wireless lap-top computers, mobile devices such as tablet computers, pad computers, personal digital assistant, and wireless sensors or networks of sensors, such as mesh network sensors. These examples are not intended to be limiting, and the present disclosure is not limited to these examples of computing device. In one illustrative embodiment, the computing device may be a user equipment such as a cellular phone, a smart phone, or other device, such as a tablet or a personal digital assistant containing a multi applications processor configured to execute a mobile application. In other embodiments, any computing device configured to execute an application to provide a data service according to this disclosure may be used as the computing device of this disclosure.

The external utility 1240 in FIG. 12 may be configured to serve the control application in controlling the operation of the wireless device and in supporting the operator of the wireless device. In one example, the illustrative memory map on dead zones may reside in the wireless device. Alternatively, the map may reside on an external utility, such as a cloud server. Alternatively, a first map may reside on the external utility and a second map on the wireless device. The maps may be identical, similar, complementary, and so on.

The cloud server may allow for dead zone services at a level more complicated and sophisticated than possible on the wireless device to take place in order to make the enable/disable of this disclosure. Control application of this disclosure, for example as illustrated in FIG. 11A may comprise software configured to create a communication link between the wireless device and the cloud server so as to allow the electronic control system and the service to communicate. The control application may be downloadable software, embedded software, and so on. In another example, the cloud server may allow for complex biometric metrics to be generated for use by the biometric operator monitor of the wireless device of this disclosure. This may make the enabling of a wireless device in a dead zone, for example, according to this disclosure based on the biometric identity of the operator more robust and effective.

In another example, the cloud server may allow for system status data to be generated for use by the system status information module 1152. This may make the feeding of system status data to the wireless device of this disclosure more robust and effective.

In another embodiment, as shown in FIG. 11A, an illustrative memory map for operation of the wireless device may reside on a cloud server. Data on the wireless device, wireless device registrant, registration data, permitted wireless operators, wireless operator recognition, date of use, location of use, dead zone restrictions, and so on may be managed by way of a service on a cloud server and used to arm or disarm a firearm, stream data, provide guidance or coaching to an operator, and so on.

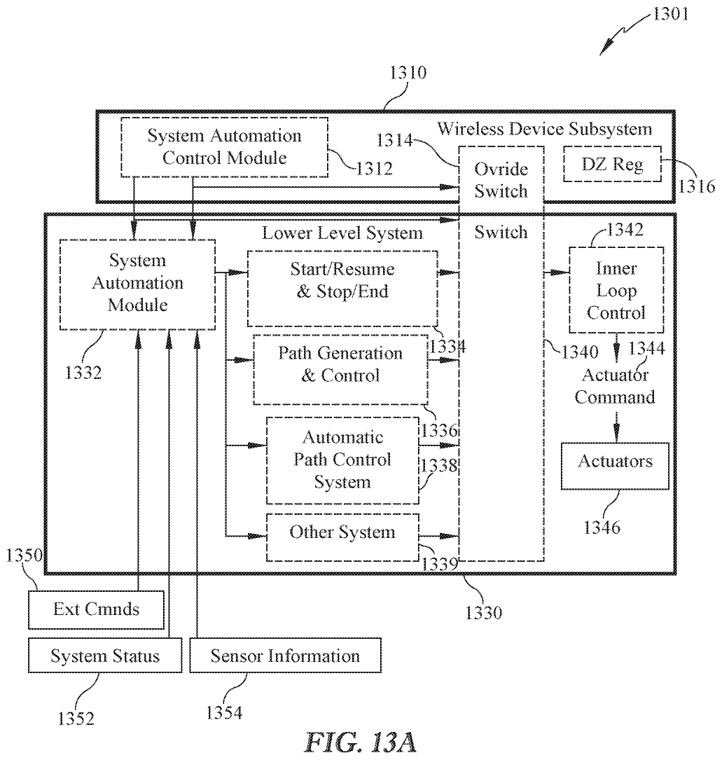

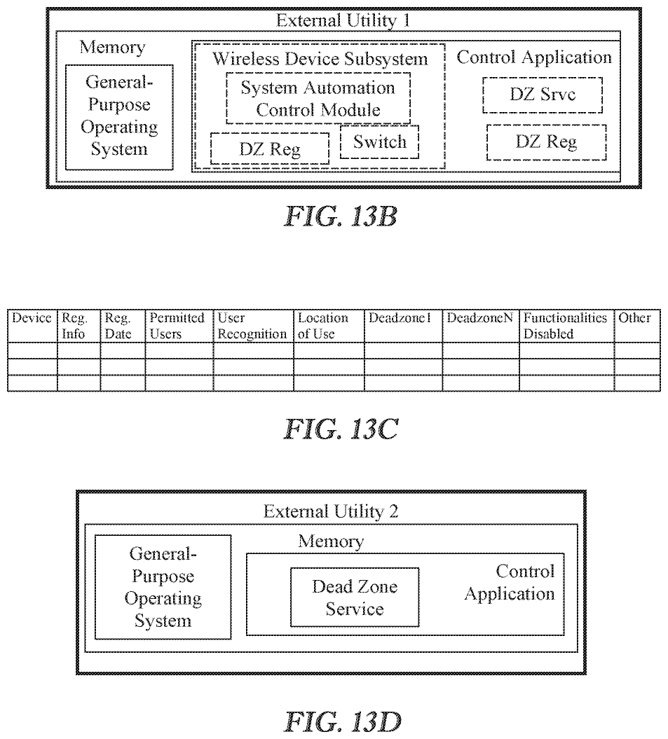

FIG. 13A depicts an illustrative dead zone control architecture 1301 for wireless device. In wireless devices, there may be many controllers which are responsible for different functions of a wireless device or for controlling the wireless device on different levels. To perform a given wireless function the wireless device controllers (e.g. Start/Resume & Stop/End 1334, Path Generation & Control 1336, Automatic Path Control System 1338, Other System 1339) are activated and connected in a certain way. A system automation module 1332 provides control signals to the device controllers responsive to external commands 1350, system status 1352, and sensor information 1354. The specific ways system automation module 1332 does this are known in art and a matter of design choice.

A wireless device subsystem 1310 of this disclosure (either wireless device subsystem 1142 in wireless device 1120, or wireless device subsystem 1182 in external utility 1170, or both) applies control signals to system automation module 1332 in order to enable, disable, or modify one or more functionalities of the wireless device in accordance with this disclosure. Control signals may be generated by the wireless device subsystem 1310 responsive to the wireless device approaching a dead zone, entering a dead zone, and so on. The outputs of the controllers are illustratively applied to a switch 1340 for generating an actuator command 1344 which may be under the influence of an inner loop control that controls actuators 1346. Actuators 1346 may be an electro-mechanical, electrical or software configuration that generates an actuator response in response to the actuator command 1344. An electromechanical actuator may be the mechanism that causes a camera lens to zoom and out and to focus and take a picture. An electrical actuator may be light sensor that flashes in response to the actuator command 1344. A software actuator may be a switch that turns a function of a wireless device on or off. For instance, the software actuator may turn off wireless network interface 1116. Alternatively, it may turn off email, text, or sms messaging. Other illustrative functions of the wireless device are depicted in FIG. 11B.

Wireless device subsystem 1310 may also include an override switch 1314 to generate a control signal to override control signals that are otherwise generated by switch 1340.

A DMZ register may be used by the system automation control module 1312 to determine whether or not the wireless device is approaching or entering or leaving a dead zone location.

In operation, the system automation control module 1312 monitors the location of the wireless device. As a wireless device approaches a dead zone location, the system automation control module 1312 may generate control signals for modifying the wireless device controllers (e.g. Start/Resume & Stop/End 1334, Path Generation & Control 1336, Automatic Path Control System 1338, Other System 1339) are activated and connected in a certain way. For example, the system automation control module may generate scripts as shown in FIG. 11B to change the performance of the wireless device controllers. For example, the script may cause the signal of the voice call to become weak, or cause the Internet signal to become weak, or cause the illumination of the display of the wireless device to become dimmer. The closer the wireless device is to the dead zone location, the more the control signals generated by the system automation control module 1312 may cause the performance of the actuators to change. In this way, the operator of the wireless device may change course to steer clear of a dead zone location or become aware that he is approaching a location where one or more functionalities of his wireless device may be disabled.

When the system automation control module 1312 detects that a wireless device is entering a dead zone, the system automation control module 1312 may disable a functionality of the wireless device. The disable control signal may be generated by override switch 1314 or by control signals that the system automation control module 1312 applies to the system automation module 1332.

FIG. 13B shows illustrative dead zone control architecture for wireless device of FIG. 13A incorporated in an external utility. The elements shown are generally as described in FIG. 11A adapted for use with wireless device of FIG. 13A according to the teachings of this disclosure. FIG. 13D shows illustrative dead zone service in a separate external utility. Alternatively, a single external utility may integrate the functions illustrated in FIGS. 13B and 13D or the functionalities may be distributed across a plurality of external utilities. FIG. 13C illustrates a memory map that may be stored in DZ register depicted in FIG. 13B. The memory map may include indicia such as wireless device, device registration, registration date, permitted users, user recognition, location of use, dead zone areas, and functionalities to be disabled. These functionalities may be the actuators 1346 in FIG. 1A and depicted in FIG. 11B.

The specific functionality to be disabled may be set by rules programed into the system automation control module 1312. For instance, the rules may cause system automation control module 131 to disable all communication functionality or just voice calling.

The modification of the behavior of the wireless device may in accordance to rules such as depicted in FIG. 11C.

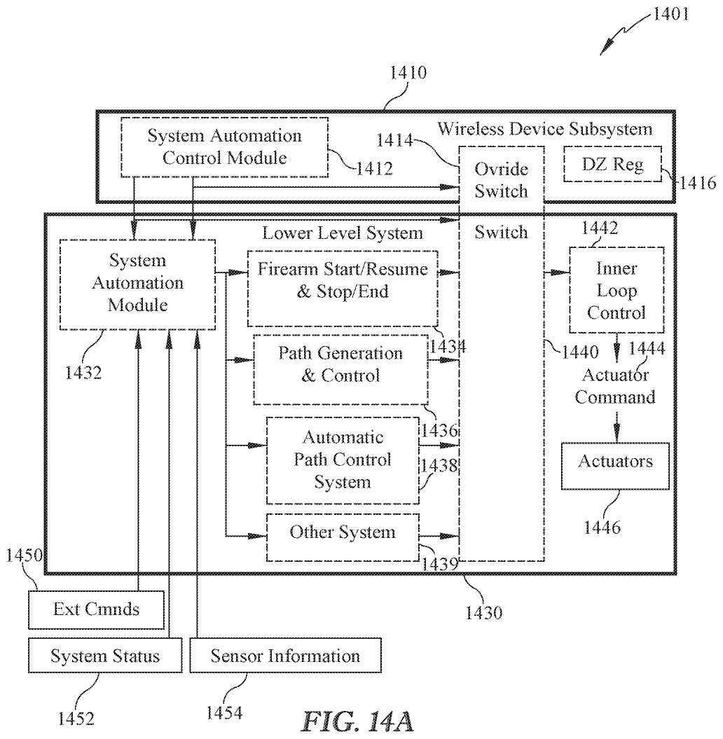

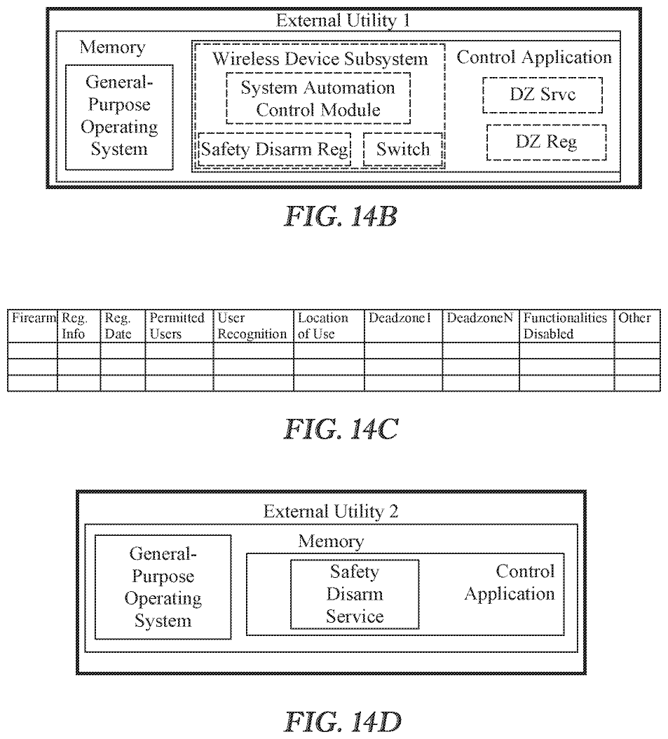

FIG. 14A depicts an illustrative dead zone control architecture 1401 for wireless device for a firearm. In this wireless devices for a firearm, one or more controllers may be provided, the controllers being responsible for different functions of the wireless device or for controlling the wireless device on different levels. In this embodiment, the firearm is controlled by the wireless device by wireless device controllers (e.g. Firearm Start/Resume & Stop/End 1434, Path Generation & Control 1436, Automatic Path Control System 1438, Other System 1439) are activated and connected in a certain way. A system automation module 1432 provides control signals to the device controllers responsive to external commands 1450, system status 1457, and sensor information 1454.

A wireless device subsystem 1410 of this disclosure (either wireless device subsystem 1142 in wireless device 1120 or wireless device subsystem 1182 in external utility 1170, or both) applies control signals to system automation module 1432 in order to enable, disable, or modify one or more functionalities of the wireless device in accordance with this disclosure. Control signals may be generated by the wireless device subsystem 1410 responsive to the wireless device approaching a dead zone, entering a dead zone, and so on. The outputs of the controllers are illustratively applied to a switch 1440 for generating an actuator command 1444 which may be under the influence of an inner loop control that controls actuators 1446. Actuators 1446 may be an electro-mechanical, electrical, or software configuration that generates an actuator response in response to the actuator command 1444. An electromechanical actuator may be a firearm subsystem (e.g., firearm subsystems, such as firearm latch controllers, transmission controllers, latch actuators, etc.) that implement motion and/or other function control as taught in Non-Provisional application Ser. No. 15/663,660 filed Jul. 28, 2017, titled “Safety Disarm for Firearm”, Docket No. JL00900.016, which is also herein incorporated by reference. An electrical actuator may be light sensor that flashes in response to the actuator command 14f44. A software actuator may be a switch that turns a function of a wireless device on or off. For instance, the software actuator may turn off wireless network interface 1116. Alternatively, it may turn off email, text, or sms messaging. Other illustrative functions of the wireless device are depicted in FIG. 11B.

Wireless device subsystem 1310 may also include an override switch 1414 to generate a control signal to override control signals that are otherwise generated by switch 1440.

A DMZ register may be used by the system automation control module 1412 to determine whether or not the wireless device is approaching or entering or leaving a dead zone location.

In operation, the system automation control module 1412 monitors the location of the wireless device. As a wireless device approaches a dead zone location, the system automation control module 1312 may generate control signals for modifying the wireless device controllers (e.g. Firearm Start/Resume & Stop/End 1434, Path Generation & Control 1436, Automatic Path Control System 1438, Other System 1439) are activated and connected in a certain way. For example, the system automation control module may generate scripts as shown in FIG. 11B to change the performance of the wireless device controllers. For example, the script may cause the signal of the voice call to become weak, or cause the internee signal to become weak, or cause the illumination of the display of the wireless device to become dimmer. The closer the wireless device is to the dead zone location, the more the control signals generated by the system automation control module 1412 may cause the performance of the actuators to change. In this way, the operator of the wireless device may change course to steer clear of a dead zone location or become aware that he is approaching a location where one or more functionalities of his wireless device may be disabled.

When the system automation control module 1412 detects that a wireless device is entering a dead zone, the system automation control module 1412 may disable a functionality of the wireless device. The disable control signal may be generated by override switch 1414 or by control signals that the system automation control module 1412 applies to the system automation module 1432.

FIG. 14B shows illustrative dead zone control architecture for wireless device of FIG. 14A incorporated in an external utility. The elements shown are generally as described in FIG. 11A adapted for use with wireless device of FIG. 14A according to the teachings of this disclosure. FIG. 14D shows illustrative dead zone service in a separate external utility. Alternatively, a single external utility may integrate the functions illustrated in FIGS. 14B and 143D or the functionalities may be distributed across a plurality of external utilities. FIG. 14C illustrates a memory map that may be stored in DZ register depicted in FIG. 14B. The memory map may include indicia such as firearm, device registration, registration date, permitted users, user recognition, location of use, dead zone areas, and functionalities to be disabled, other. These functionalities may be the actuators 1346 in FIG. 11A and depicted in FIG. 11B.

The specific functionality to be disabled may be set by rules programed into the system automation control module 1412. For instance, the rules may cause system automation control module 1412 to disable all communication functionality or just voice calling.

The modification of the behavior of the wireless device may in accordance to rules such as depicted in FIG. 11C.

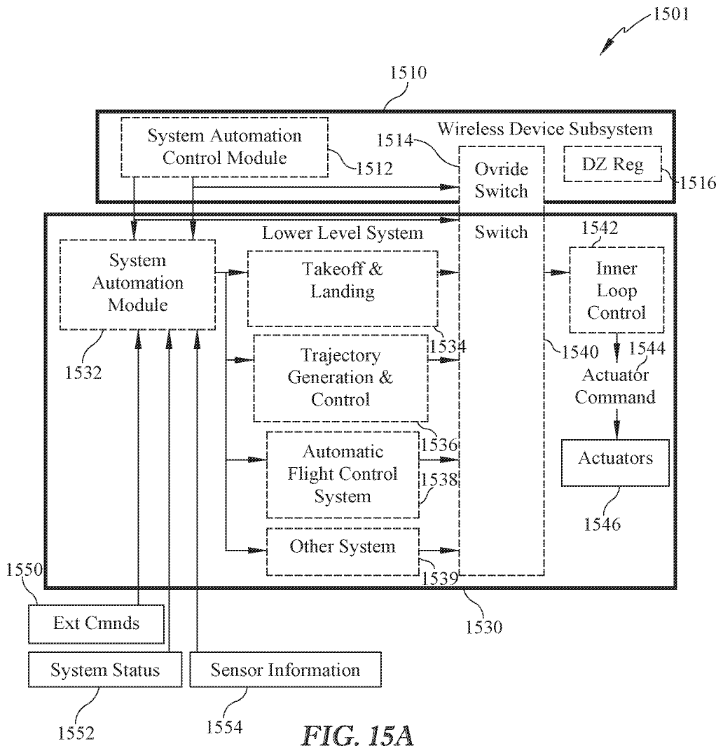

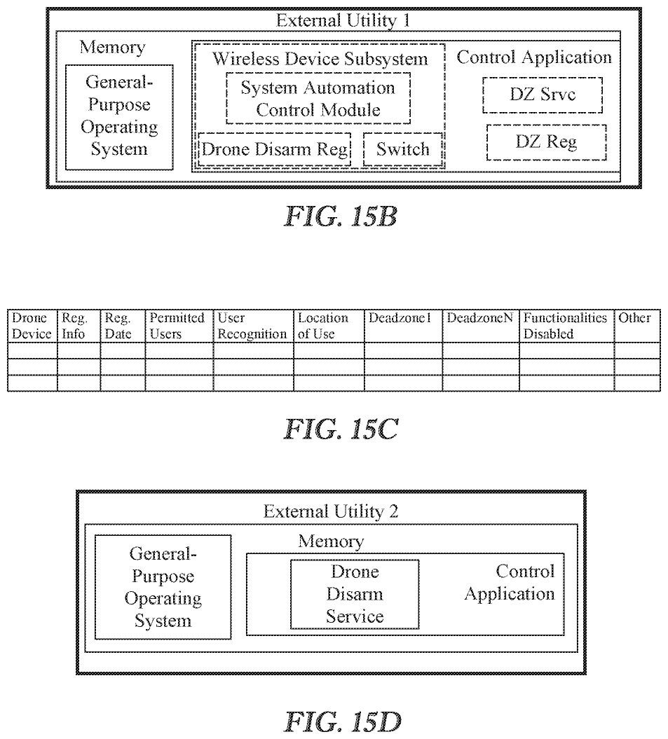

FIG. 15A depicts an illustrative dead zone control architecture for wireless device, such as a drone. In unmanned aerial systems, there are many controllers which are responsible for different parts of a flight mission or for controlling the aircraft on different levels. To perform a given flight mission the flight controllers (e.g. Takeoff & Landing 1534, Trajectory Generation & Control 1536, Automatic Flight Control System 1538, and Other System 1539) may have to be activated and connected in a certain way. To ensure the correct switching a superior system automation logic may be needed. A system automation module 1532 provides control signals to the device controllers responsive to external commands 1550, system status 1552, and sensor information 1554.

A wireless device subsystem 1510 of this disclosure (either wireless device subsystem 1142 in wireless device 1120 or wireless device subsystem 1182 in external utility 1170, or both) applies control signals to system automation module 1532 in order to enable, disable, or modify one or more functionalities of the wireless device in accordance with this disclosure. Control signals may be generated by the wireless device subsystem 1510 responsive to the wireless device approaching a dead zone, entering a dead zone, and so on. The outputs of the controllers are illustratively applied to a switch 1540 for generating an actuator command 1544 which may be under the influence of an inner loop control that controls actuators 15446. Actuators 1546 may be an electro-mechanical, electrical, or software configuration that generates an actuator response in response to the actuator command 1544. An electromechanical actuator may implement motion and/or other function control, e.g. the flaps or gear. These actuators have a direct influence on the aircraft's envelope, which can be based on aerodynamic or structural limits. An electrical actuator may be light sensor that flashes in response to the actuator command 1544. A software actuator may be a switch that turns a function of the wireless device on or off. For instance, the software actuator may turn off wireless network interface 1116. Alternatively, it may turn off camera taking. Other illustrative functions of the wireless device are depicted in FIG. 11B.

Wireless device subsystem 1510 may also include an override switch 1514 to generate a control signal to override control signals that are otherwise generated by switch 1540.

A DMZ register may be used by the system automation control module 1512 to determine whether or not the wireless device is approaching or entering or leaving a dead zone location.

In operation, the system automation control module 1512 monitors the location of the wireless device. As a wireless device approaches a dead zone location, the system automation control module 1512 may generate control signals for modifying the wireless device controllers (e.g. Takeoff & Landing 1534, Trajectory Generation & Control 1536, Automatic Flight Control System 1538, Other System 1539) are activated and connected in a certain way. For example, the system automation control module may generate scripts as shown in FIG. 11B to change the performance of the wireless device controllers. For example, the script may cause operation of the aircraft in the specified envelope, it may adjust certain limits within the flight controllers to steer the wireless device away from the dead zone.

The closer the wireless device is to the dead zone location, the more the control signals generated by the system automation control module 1512 may cause the performance of the actuators to change. In this way, the wireless device may change course to steer clear of a dead zone location or become aware that he is approaching a location where one or more functionalities of his wireless device may be disabled.

When the system automation control module 1512 detects that a wireless device is entering a dead zone, the system automation control module 1512 may disable a functionality of the wireless device, such as a camera. This may prohibit, for example, a drone from taking pictures of people in the privacy of their properties. Some camera functionality may still be permitted such as line of site in order to enable the drone to continue flight unhindered. The disable control signal may be generated by override switch 1514 or by control signals that the system automation control module 1512 applies to the system automation module 1532.

FIG. 15B shows illustrative dead zone control architecture for wireless device of FIG. 15A incorporated in an external utility. The elements shown are generally as described in FIG. 11A adapted for use with wireless device of FIG. 15A according to the teachings of this disclosure. FIG. 15D shows illustrative dead zone service in a separate external utility. Alternatively, a single external utility may integrate the functions illustrated in FIGS. 15B and 153D or the functionalities may be distributed across a plurality of external utilities. FIG. 15C illustrates a memory map that may be stored in DZ register depicted in FIG. 15B. The memory map may include indicia such as firearm, device registration, registration date, permitted users, user recognition, location of use, dead zone areas, and functionalities to be disabled, other. These functionalities may be the actuators 1156 in FIG. 11A and depicted in FIG. 11B.

The specific functionality to be disabled may be set by rules programed into the system automation control module 1512. For instance, the rules may cause system automation control module 1512 to disable all communication functionality or just voice calling.

The modification of the behavior of the wireless device may in accordance to rules such as depicted in FIG. 11C.

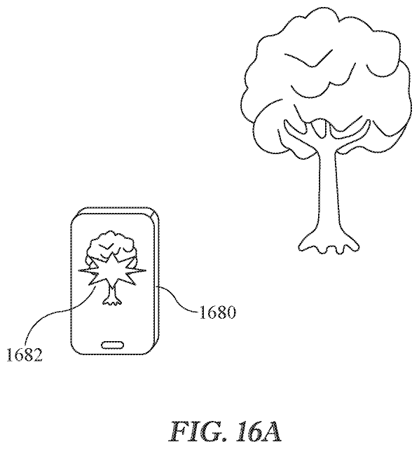

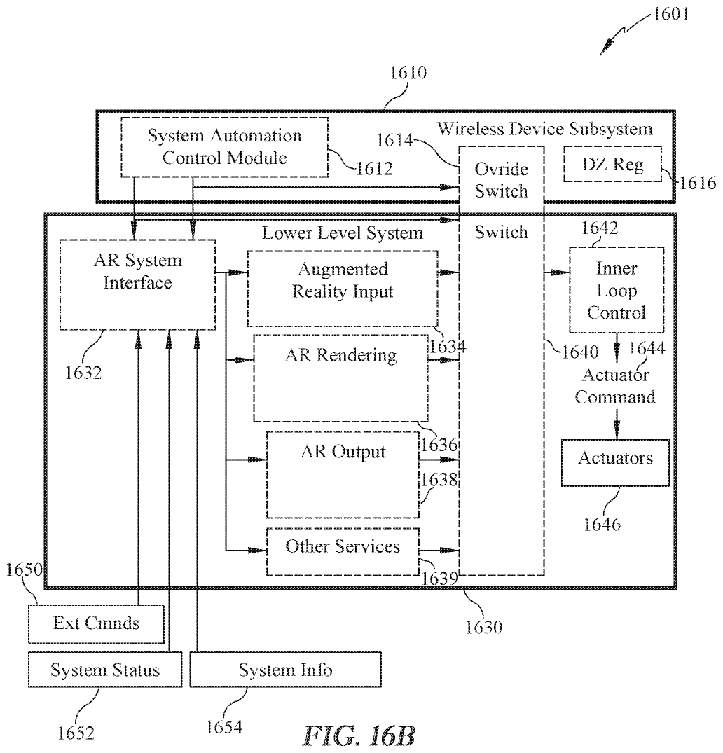

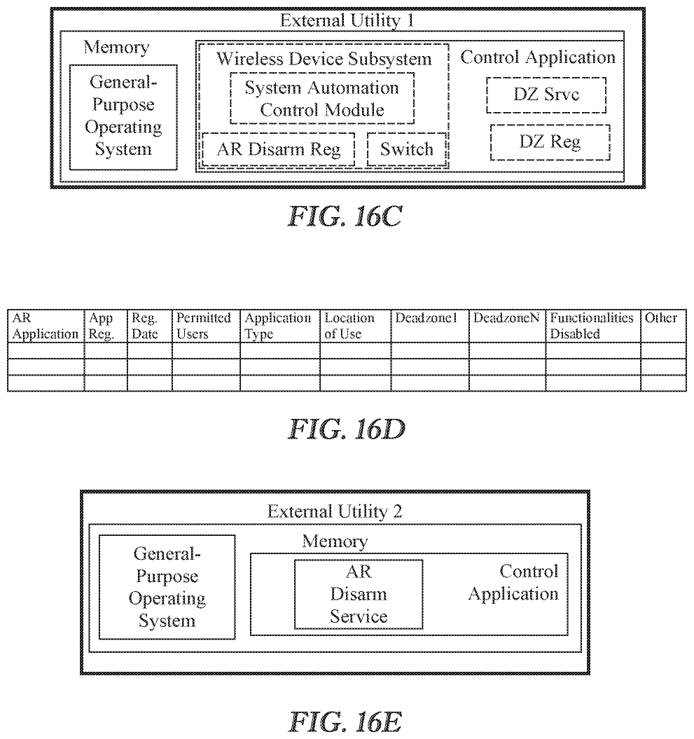

FIG. 16A depicts a wireless device 1680 that is executing an augmented reality (AR) application 1682. Generally, augmented reality provides a live view of a physical, real-world environment whose elements are “augmented” by computer-generated information, such as visual, audial, and/or haptic information. The computer-generated information can be added to the live view or may mask portions of the live view. Additionally, the computer-generated information is typically spatially aligned with the real-world environment such that it is perceived as a part of the real-world environment.

The AR application 1682 may use input from a camera (not shown), microphone (not shown) or other input devices or sensors (not shown), to produce computer-augmented perceptual output, based on the data collected by such input devices or sensors. For example, video input taken by a camera can be displayed on a screen 1684 of the wireless device 1680 with additional computer-generated images added to the video in real time, to provide a “real world” image from the camera, augmented with the computer-generated images. Input from other sensors (not shown), such as magnetic field sensors, orientation sensors, and accelerometers can also be used to provide information on, e.g., the direction that a user is facing or moving, to help to generate an augmented reality scene.

Other forms of input, such as audio, may also be augmented through enhancement or addition of computer-generated content. Additionally, although the wireless device 1680 shown in FIG. 16A is depicted as being a mobile “smart phone”, other wireless devices, such as eyeglasses, headsets, headphones, haptic devices, or other output devices or combinations of such devices may be used in augmented reality applications.

While augmented reality shows great promise in a wide range of applications, including education, medicine, architecture, design, art, entertainment, and other fields, there are occasions where use of certain forms of augmented reality may be inappropriate. For example, a recently popular entertainment AR application called POKÉMON GO, published by Niantic, Inc. of San Francisco, Calif., encourages players to search real-world locations for AR characters that are displayed on a smart phone as being in the player's real-world location. These characters may then be battled, captured, trained, etc., in real-world locations, using AR to depict the characters in the player's real-world location. While the game has been very popular, and encourages physical activity (since players are encouraged to travel, generally by foot, to locations where certain of the AR characters can be found), there are real-world locations where playing the game would be inappropriate. For example, the game could be disruptive in places like classrooms, museums, theaters, or restaurants. The game could be disrespectful if AR creatures were depicted in places like cemeteries, places of worship, or places of great cultural significance. While some (e.g., educational) AR applications may be appropriate in some of these settings, others (e.g., entertainment AR applications) would be inappropriate, disruptive, and/or disrespectful. There may be settings (e.g., memorials) where no AR application should be used.

FIG. 16B depicts an illustrative dead zone control architecture for a wireless device that can use dead zone control to enable, disable, or modify access to AR functions. Because there may be a variety of AR-related functions that can be activated, deactivated, or modified, and it may be desirable to control these functions based on both the location and type of AR application educational AR applications may be appropriate in schools, while entertainment AR applications might not be), complex system automation logic may be used, AR services, including AR input services 1634, AR rendering services 1636, AR output services 1638, and other services 1639 may be provided as a set of components for use by AR applications. For example, the AR input services 1634 may control cameras and motion sensors, as well as providing complex scene and lighting understanding to provide visual scene input for use by an AR application. The AR rendering services 1636 may provide the ability to combine computer-generated visual content with visual content derived from the camera and other sensors, and the AR output services 1638 may provide access to devices such as a screen, headset, eyeglasses, etc. to output visual AR content. Further, similar services may be available for other sensory modalities (e.g., auditory, haptic, olfactory). An AR system interface 1632 provides control signals to the AR services responsive to external commands 1650 (e.g., from AR applications), system status 1652, and system information 1654. The specific ways in which the AR system interface 1632 does this are known in art and a matter of design choice.

A wireless device subsystem 1610 of this disclosure (either wireless device subsystem 1142 in wireless device 1120 or wireless device subsystem 1182 in external utility 1170, or both, as shown in FIG. 11A) applies control signals to AR system interface 1632 in order to enable, disable, or modify one or more functionalities of the wireless device in accordance with this disclosure. Control signals may be generated by the wireless device subsystem 1610 responsive to the wireless device approaching a dead zone, entering a dead zone, and so on. The outputs of the controllers are illustratively applied to a switch 1640 for generating an actuator command 1644 which may, in some embodiments, be under the influence of an inner loop control 1642 that controls actuators 1646. Actuators 1646 may be an electro-mechanical, electrical, or software configuration that generates a response to the actuator command 1644. An electromechanical actuator may be the mechanism that, for example, causes a camera lens to zoom and out and to focus and take a picture. An electrical actuator may be light sensor that flashes in response to the actuator command 1644. A software actuator may be a switch that turns a function of a wireless device on or off, or that modifies a function of a wireless device. For instance, in the context of an AR system, a software actuator may send commands that cause the AR rendering services 1636 to reject requests to render AR objects in a real-world scene, cause the AR input services 1634 to reject requests to access a video stream, or cause the AR output services 1638 to output only to eyeglasses or headsets, and not to mobile phone screens. Additionally, in some embodiments, the actuators 1646 may be able to disable, enable, or modify communications functions, such as voice communications, email, text, or sms messaging, or other functions of the wireless device. Other illustrative functions of the wireless device are depicted in FIG. 11B.

Wireless device subsystem 1610 may also include an override switch 1614 to generate a control signal to override control signals that are otherwise generated by switch 1640.

A DMZ register may be used by the system automation control module 1612 to determine whether or not the wireless device is approaching or entering or leaving a dead zone location.

In operation, the system automation control module 1612 monitors the location of the wireless device. As a wireless device approaches a dead zone location, the system automation control module 1612 may generate control signals for modifying the AR services (e.g. AR input services 1634, AR rendering services 1636, AR output services 1638, other services 1639) are activated and connected in a certain way. For example, the system automation control module may generate scripts, similar to those shown in FIG. 11B, to change the performance of the AR services. For example, the script may cause rendered AR objects in a scene to become increasingly transparent, cause a video stream from a device camera to be output with decreasing focus or detail, cause certain types of AR applications (e.g., entertainment applications) to have decreased access to AR services, etc. In some embodiments, the closer the wireless device is to the dead zone location, the more the control signals generated by the system automation control module 1612 may cause the performance of the actuators to change. In this way, the operator of the wireless device may become aware that he is approaching a location where one or more functionalities of his wireless device may be disabled, and may decide to avoid the dead zone location.

When the system automation control module 1612 detects that a wireless device is entering a dead zone, the system automation control module 1612 may disable or modify an AR-related functionality of the wireless device. The disable control signal may be generated by override switch 1614 or by control signals that the system automation control module 1612 applies to the AR system interface 1632.

FIG. 16C shows the illustrative dead zone control architecture 1601 for the wireless device of FIG. 16B, incorporated into an external utility 1661. The elements shown are generally as described in FIG. 11A adapted for use with wireless device of FIG. 16A according to the teachings of this disclosure. Similarly, FIG. 16E shows an illustrative dead zone service 1665, which provides dead zone services related to augmented reality in a separate external utility 1663. The dead zone service 1665 may be similar to the dead zone service discussed above as DZ service 1190, with reference to FIG. 11A. Alternatively, a single external utility may integrate the functions illustrated in FIGS. 16C and 16E or the functionalities may be distributed across a plurality of external utilities.

FIG. 16D illustrates a memory map that may be stored in DZ register 1616 depicted in FIG. 16B. The memory map may include indicia such as AR application, application registration, registration date, permitted users, application type, location of use, dead zone areas, and functionalities to be disabled (or enabled or modified), and other. These functionalities may, for example, correspond to the actuators 1646 in FIG. 16B.

The specific functionality to be disabled, enabled, or modified may be set by rules programed into the system automation control module 1612. For instance, the rules may cause system automation control module 1612 to disable AR rendering, to modify scene understanding in AR input services, or to modify other AR-related services. Additionally, the rules may cause the system automation control module 1612 to disable, enable, or modify communication functionality and/or voice calling.

The modification of the behavior of the wireless device may in accordance to rules such as those depicted in FIG. 11C.

In accordance with some embodiments of the invention, augmented reality may be combined with other functions or embodiments that are described above. For example, augmented reality functions may be used with drone embodiments to automatically cover over, defocus, or pixelate views through residential windows, or views of sensitive private or government property, even when a drone is not actually flying over such property. Such residential or sensitive properties may, for example, be defined in the DZ registers of the various embodiments that are discussed herein. Similarly, augmented reality can be used in conjunction with firearm-related embodiments to highlight permitted targets, or to indicate as forbidden or to obscure forbidden targets.

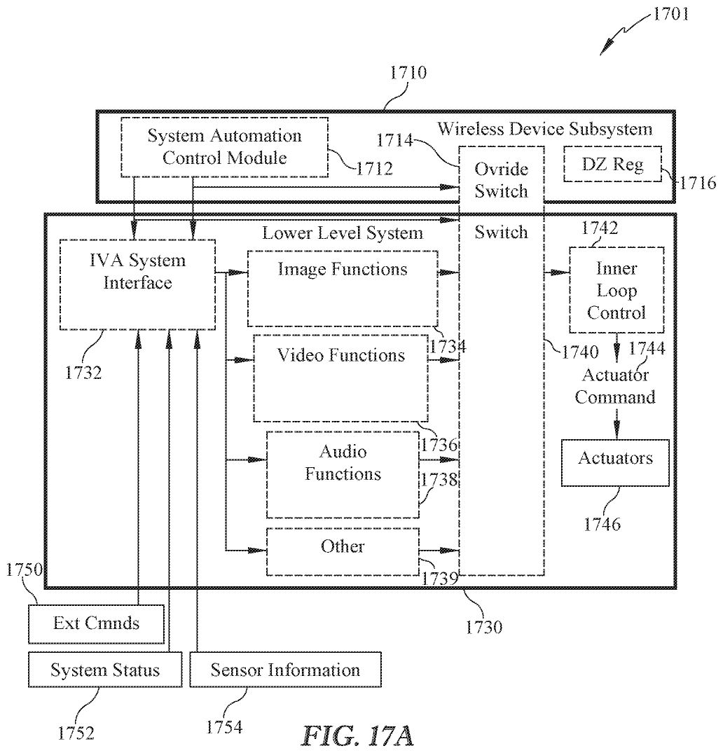

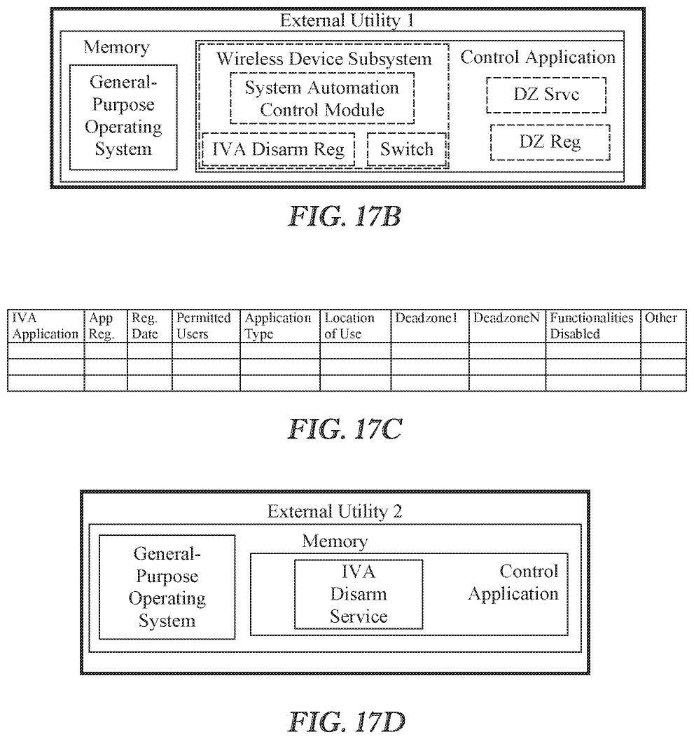

FIG. 17A depicts an illustrative dead zone control architecture 1701 for a wireless device that can use dead zone control to enable, disable, or modify access to a variety of image, video, and/or audio (IVA) functions. Modernly, most mobile phones, for example, have sophisticated audio and video recording capabilities, as well as high-resolution cameras, many of which can take good images, even in low light. Controlling access to these functions may, for example, permit audio and video recording to be disabled within a concert venue, while allowing still photos to be taken. As another example, still images and video could be disabled in private areas, such as dressing rooms, locker rooms, or restrooms. As yet another example, flash capabilities of a camera on a mobile device may be disabled within museums, places of worship, or other locations where flash photography may be inappropriate. There may be a variety of locations or conditions in which some or all IVA functions of a mobile device should be disabled or modified.

IVA functions, including image functions 1734, video functions 1736, audio functions 1738, and other functions 1739 may be available on mobile devices, and may be used by a variety of applications that are available on mobile devices. For example, the image functions 1734 may provide access to still-camera input (and, in some embodiments, output) functions, such as taking pictures, adjusting zoom, lighting and exposure control, flash control, and so on. The video functions 1736 may control recording and playback of video, and the audio functions 1738 may control recording and playback of audio. An IVA system interface 1732 provides control signals to the IVA functions responsive to external commands 1750, system status 1752, and sensor information 1754. The specific ways in which the IVA system interface 1732 does this are known in art and a matter of design choice.

A wireless device subsystem 1710 of this disclosure (either wireless device subsystem 1142 in wireless device 1120 or wireless device subsystem 1182 in external utility 1170, or both, as shown in FIG. 11A) applies control signals to IVA system interface 1732 in order to enable, disable, or modify one or more functionalities of the wireless device in accordance with this disclosure. Control signals may be generated by the wireless device subsystem 1710 responsive to the wireless device approaching a dead zone, entering a dead zone, and so on. The outputs of the controllers are illustratively applied to a switch 1740 for generating an actuator command 1744 which may, in some embodiments, be under the influence of an inner loop control 1742 that controls actuators 1746. Actuators 1746 may be an electro-mechanical, electrical, or software configuration that generates a response to the actuator command 1744. An electromechanical actuator may be the mechanism that, for example, causes a camera lens to zoom and out and to focus and take a picture. An electrical actuator may be light sensor that flashes in response to the actuator command 1744. A software actuator may be a switch that turns a function of a wireless device on or off, or that modifies a function of a wireless device. For instance, in the context of an IVA system, a software actuator may send commands that cause the video functions 1736 to reject requests to record or display video, cause the image functions 1734 to defocus the camera lens, or cause the audio functions 1738 record only snippets of audio that are 5 seconds or shorter. Additionally, in some embodiments, the actuators 1746 may be able to disable, enable, or modify communications functions, such as voice communications, email, text, or sms messaging, or other functions of the wireless device. Other illustrative functions of the wireless device are depicted in FIG. 11B.

Wireless device subsystem 1710 may also include an override switch 1714 to generate a control signal to override control signals that are otherwise generated by switch 1740.

A DMZ register may be used by the system automation control module 1712 to determine whether or not the wireless device is approaching or entering or leaving a dead zone location.

In operation, the system automation control module 1712 monitors the location of the wireless device. As a wireless device approaches a dead zone location, the system automation control module 1712 may generate control signals for modifying the IVA functions (e.g. image functions 1734 video functions 1736 audio functions 1738, other functions 1739) so that the IVA functions are activated and connected in a certain way. For example, the system automation control module 1712 may generate scripts, similar to those shown in FIG. 11B, to change the performance of the IVA functions. For example, the script may cause video recorded by a device to become increasingly defocused, cause audio recorded and/or played by a device to decrease in volume, or cause certain types of IVA applications (e.g., entertainment applications) to have decreased access to IVA functions, etc. In some embodiments, the closer the wireless device is to the dead zone location, the more the control signals generated by the system automation control module 1712 may cause the performance of the actuators to change. In this way, the operator of the wireless device may become aware that he is approaching a location Where one or more functionalities of his wireless device may be disabled, and may decide to avoid the dead zone location.

When the system automation control module 1712 detects that a wireless device is entering a dead zone, the system automation control module 1712 may disable or modify an IVA-related functionality of the wireless device. The disable control signal may be generated by override switch 1714 or by control signals that the system automation control module 1712 applies to the IVA system interface 1632.

FIG. 17B shows the illustrative dead zone control architecture 1701 for the wireless device of FIG. 17A, incorporated into an external utility 1761. The elements shown are generally as described in FIG. 11A adapted for use with wireless device of FIG. 13A according to the teachings of this disclosure. Similarly, FIG. 17D shows an illustrative dead zone service which provides dead zone services related to IVA functions in a separate external utility. The dead zone service may be similar to the dead zone service discussed above as DZ service 1190, with reference to FIG. 11A. Alternatively, a single external utility may integrate the functions illustrated in FIGS. 17B and 17D or the functionalities may be distributed across a plurality of external utilities.

FIG. 17C illustrates a memory map that may be stored in DZ register 1716 depicted in FIG. 17A. The memory map may include indicia such as IVA application, application registration, registration date, permitted users, application type, location of use, dead zone areas, and functionalities to be disabled (or enabled or modified), and other. These functionalities may, for example, correspond to the actuators 1746 in FIG. 17A.

The specific functionality to be disabled, enabled, or modified may be set by rules programed into the system automation control module 1712. For instance, the rules may cause system automation control module 1712 to disable video or audio recording, to limit audio playback volume, or to modify other IVA-related functions. Additionally, the rules may cause the system automation control module 1712 to disable, enable, or modify communication functionality and/or voice calling.

The modification of the behavior of the wireless device may be in accordance to rules such as those depicted in FIG. 11C.

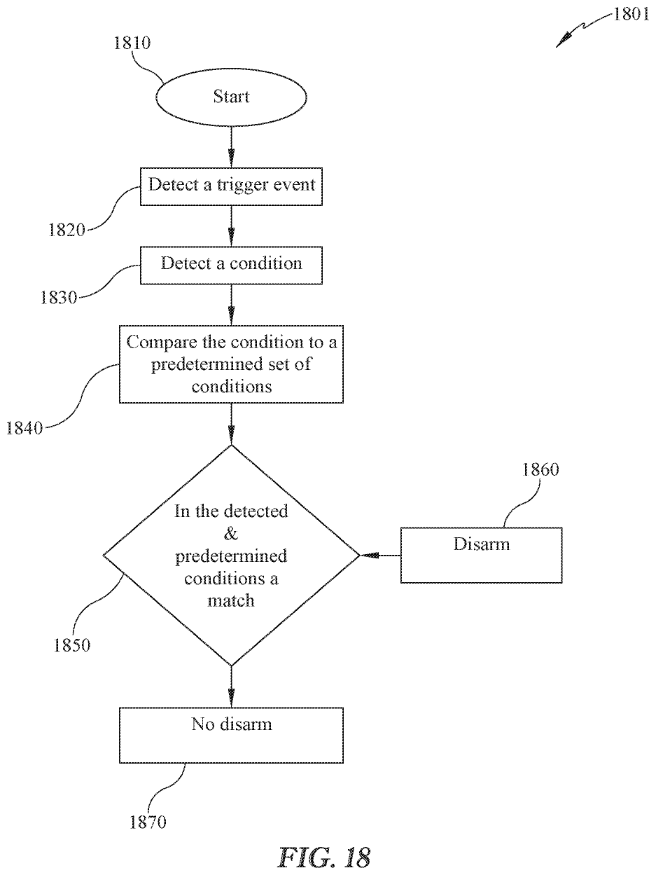

FIG. 18 shows an illustrative method of this disclosure. The method advances from start 1810 to detecting a trigger event 1820. For example, a location. If a trigger event is detected, the method detects a condition 1830. For example, a dead zone location. In step 1840, the method compares the detected condition to a predetermined set of conditions. For example, the detected location would be compared to a predetermined set of dead zone locations. At step 1850, the method determines whether the comparison yields a match. If comparison yields a match, a wireless function is disarmed 1860. If the comparison yields no match, the firearm is armed for firing.

An illustrative computer readable medium according to this disclosure contains program instructions for causing a computer to perform the method of detecting a trigger event; detecting a condition; comparing the condition to a predetermined condition; disabling a function of the wireless device if the condition matches the predetermined condition. The predetermined condition may be a shape (e.g., in the shape of a human), a location (e.g., in a dead zone), the identity of the operator, whether or not the wireless device has been tampered with (e.g., electronic control system or sensors have been tampered with), and so on.

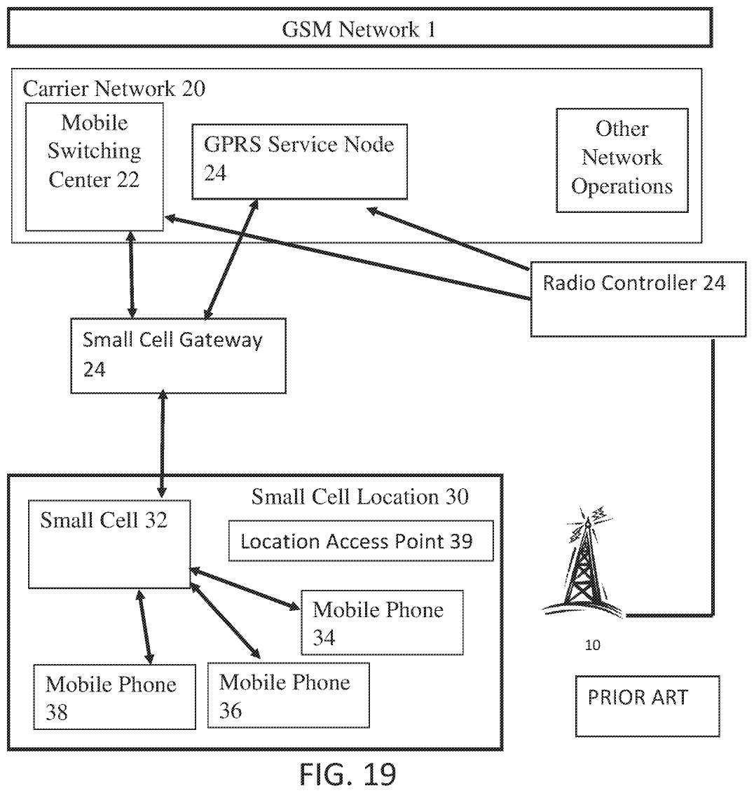

FIG. 19 shows a prior art small cell network.

Small cells are short range mobile phone base stations used to complement mobile phone service from larger macro cell towers. In one aspect, small cells may be compact residential femtocells, the size of a paperback book and connected using standard domestic internet broadband. In another aspect, small cells may be larger equipment used inside commercial offices or outdoor public spaces. Small cells offer excellent mobile phone coverage and data speeds at home, in the office and public areas for both voice and data. Small cells have been developed for both 3G and the newer radio technologies such as 4G/LTE, and 5G. Small cells are small cellular base stations designed specifically to add additional capacity over small coverage areas.

Small cells provide a small radio footprint. Small cells are available for a wide range of air interfaces including GSM, CDMA2000, TD-SCDMA, W-CDMA, LTE and WiMax. In 3GPP terminology, for example, a Home Node B (HNB) is a 3G femtocell. A Home eNode B (HeNB) is an LTE femtocell. Small cells play an important role in the evolution of cellular standards, such as 4G and 5G, since small cells provide an effective way to increase capacity and coverage. This allows these standards to support the growing number of devices requiring communication access, and particularly internet access.

Wi-Fi is a small cell too. Wi-Fi is standard equipment on most mobile devices. A Wi-Fi hotspot for Internet access is built into the wireless router commonly used at home or in a small office (see wireless router and Wi-Fi extender). Wi-Fi hotspots may also be available free or for a charge in public areas such as coffee shops, lounges, airports, on the street, and other venues. However, Wi-Fi does not operate in licensed spectrum. As a result, it may not be managed as effectively as small cells utilizing licensed spectrum.

For this and other reasons, small cells provide carriers with an effective radio footprint for controlling network traffic.

Small cell deployments vary according to the use case and radio technology employed. Generally, there are three types of small cells. They are femtocells, picocells and microcells. While the usage of these small cells may overlap, there are some generally understood differences between them.

Femtocells are small cells that have the shortest range of small-cell types. They are usually installed in homes or small businesses. These small cells are router-like devices installed on the premise. The small cell generally accommodates coverage for few users at a time. Femtocells may also generally have a maximum range of less than about 10 meters.

Picocells are small cells that are typically installed in larger indoor areas like shopping malls, offices or train stations. These small cells generally accommodates coverage for up to about 100 users at a time. Picocells may also generally have a range of under 200 meters.

Microcells or metrocells are the largest and most powerful small cell. They are usually installed outdoors on traffic lights or signs. They may also be used for large events. Microcells may also generally have a range of under about two kilometers.

The term small cell may be used to cover these and other wider applications.

These small cells provide the foregoing described small radio footprints. This is in contrast to macrocell towers which may have a range of up to about 20 miles.

The network operators install the macrocell towers. They also may typically install microcells and picocells are usually installed by network operators.

While typically, femtocell, picocell, and metrocell/microcell describe different product solutions, the term small cell may be used to cover these and other product solutions. For example, a femtocell is typically used to describe residential products. A picocell is typically used to describe enterprise/business premises products. The term small cell may be used to cover all aspects as the underlying femtocell technology has expanded to cover these and other wider applications.

In some applications of a mobile terminal use, there may be a need for the internet connection of the mobile terminal to be controlled. For example, one problem brick and mortar stores face is losing a customer who has entered the store to do some shopping on account of better pricing available to the customer over the internet. For instance, many customers may come to the brick and mortar store to learn enough about the products to decide which, of the many products that meet the customer need, the customer should buy. Once decided, or to help the customer make the decision, thanks to the internet, while using the brick and mortar store experience to help decide which product to buy, customers may connect to and surf the internet for comparative pricing or product offering on like products on the fly and while taking in the whole brick and mortar experience. In so doing, the customers bring the internet showrooms of virtual online stores into the brick and mortar store that is educating the customer on which product to buy. In trying to make the sale, the brick and mortar store finds itself competing with online stores. Since the online stores are without the show room, sales team, and other overhead value, the brick and mortar store may lose the sale of the product to an online store offering the same product at a reduced price even though the sale might not have been made at all had the customer not experienced the product at the brick and mortar store.

It could help the shopping experience of the customer at the brick and mortar store and lead to more sales if the brick and mortar store could control the entire shopping experience of the customer while the customer is on the brick and mortar premises. A brick and mortar experience without interruption by online stores or with controlled access to internet content while in the brick and mortar store may help the shopping experience. This has been a challenge since customers may access the internet through a WiFi access point or over a cellular network. The store may be able to restrict access to a WiFi access point it has installed on the premises; but not access to WiFi access points in nearby locations. If the radio coverage or footprint of the nearby WiFi access point overlaps the radio coverage or WiFi access point located at the brick and mortar store, the store may be unable to restrict access of customers at the store to those nearby WiFi access points. In addition, customers may access the internet over a cellular network. So regardless of available WiFi, a customer may still access the internet over the cellular network.

There are other examples where the customer experience at a location may be improved by controlled access of the customer to the internet while at the location. For example, a restaurant may want all voice and data communication from the cellular network and access point prevented in order to enable a more quiet dining experience. Alternatively, the restaurant may want to allow diners limited internet access over the cellular network and the restaurant's WiFi to the content provided by the restaurant through its website or sponsored site. For instance, a diner whether in the restaurant or not may access content on the restaurant through the restaurant or sponsored website. As another example, the restaurant may allow menu and ordering apps on mobile terminals of diners to access a restaurant website for browsing the menu and ordering. In another example, a location may want to allow predetermined apps and not others.

There are also many examples where the customer experience at a location may be improved by network control of functions of the mobile terminal. For example, an art gallery may want to prevent a mobile terminal from taking a photo, audio, video, making a voice call, texting, emailing, or internet browsing within the art gallery. Control of any function of the mobile terminal by an establishment at a location may be a desirable way to improve the experience of a visitor to the location as well as advancing the mission of the establishment such as avoiding flash image capture in an art gallery which may degrade the characteristic of paintings or an image capture with or without flash to avoid violating copyright laws, avoiding calls in a restaurant designed for quiet dining, avoiding browsing of competitor online stores in a brick and mortar store to help drive sales, controlled WiFi and cellular access at airports to avoid interference with signaled control of airplanes as well as interference with communication systems, turning off audio and/or video at concerts or theaters to avoid violating copyright laws, and so on.

Controlled WiFi and cellular access may serve many other purposes including administering, managing customer experiences, as well as store activities and the conduct within the stores by store personnel, customers or others. For instance, a team of shoplifters communicating by cellular network in a store for the purpose of stealing products may be thwarted by restrictions placed by the store on cellular communications while in the store such as a restriction preventing messaging while in the store. As another example, an establishment may minimize legal exposure by employment of more control over the type of communication permitted at the location. For instance, an air carrier may better manage litigation risk by controlled communication access allowed passengers while on the carrier. Controlled communication access may also allow an establishment to protect the privacy of its customers.

This disclosure addresses the foregoing needs by providing a dead zone in a small cell application

Referring still to FIG. 19, in this illustrative embodiment, the small cell network includes a network 1, illustratively GSM but may be based on any cellular technology. GSM network 1 includes a carrier network 20 and a small cell location 30. The carrier network includes a mobile switching center 22, a GPRS Service Node 24, other network operations 25, a radio controller 26, and a small cell gateway 27.

The small cell location 30 includes a small cell 32, a location access point 39 and mobile phones 34, 36, 38.

The carrier network 20 may be operated by a separate network operator for providing telecommunication services to terminal devices

Base station 10 is a fixed point of communication for customer cellular phones on a carrier network as previously explained as BTS in for example, FIG. 1. Radio controller 26, or base station controller (BSC) is a network element that controls and monitors a number of base stations and provides the interface between the cell sites and the mobile switching center (MSC). as previously explained as BSC 54 in for example, FIG. 1

In this embodiment, a GSM network 1 is illustrated. Alternatively, the network may be based on other cellular technologies such as GSM, CDMA and so on. Carrier network 20 includes mobile switching center 22, GPRS Service Node 24 as previously explained.

The small cell (SAP) 32 is a hardware device located at a small cell location 30, e.g., a customer's premises that interfaces with mobile devices over-the air radio interface. The SAP appears to a mobile device as an outdoor macrocell; however, it emits less power. The SAP interfaces with the core mobile network via a broadband interface such as DSL, fiber, cable, Using a SAP to gain access to the mobile network improves indoor coverage and bandwidth availability for mobile devices. SAP may be either of the small cell types previously explained. According to the cellular technologies used, SAP can be classified into UMTS FAP, GSM FAP, WiMAX FAP, and so on.

The small cell gateway (SCG) 24 is responsible for the radio resource control, the overall load control and the handover control. The SCG interfaces with the SAP over the broadband access network. The SCG performs signaling protocol conversion and in some implementations bearer (voice, video . . . ) channel conversions. The SCG gateway also performs the function of a security gateway by protecting the mobile network operator (MNO) from attack attempts over the public broadband access. The SCG interfaces with the different MNO network segments that have been defined as reference points. There generally is a reference point between the SCG and the MNO's circuit-switch network for transporting real-time applications such as voice and video. There generally is a reference point between the SCG and the MNO's packet-switch network for routing user data such as text messages and e-mail. There generally is also an interface for the SCG to communicate to the core IMS network.

Mobile phones 34, 36, 38 refer to an electronic device used to communicate voice and/or data via a telecommunications system, such as (but not limited to) a small cell network or other cellular network. Other terminology used to refer to terminal devices and non-limiting examples of such devices can include mobile stations, mobile devices, access terminals, subscriber stations, terminal mobile terminals, remote stations, user terminals, terminals, subscriber units, cellular phones, smart phones, personal digital assistants (“PDAs”), laptop computers, netbooks, e-readers, wireless modems, etc.

Location Access Point 39 is an access point connects users to other users within the network and also can serve as the point of interconnection between the WLAN and a fixed wire network as previously explained. An access point may be integrated into the small cell to create a bundled cellular Wi-Fi solution.

In operation, when in range of the small cell, the mobile phone will automatically detect the small cell and use the small cell in preference to the larger macrocell cell sites. Once a mobile phone is connected to a small cell, calls from the mobile phone are made and received in a similar way as previously disclosed in prior priority applications, except that the signals from the cell phone are sent to the small cell which typically encrypts and passes the signals via the public or private broadband IP network to one of the mobile operators main switching centers. Making and receiving calls uses procedures and telephone numbers as disclosed in the priority applications again except that the voice call passes through the small cell. Similarly accessing and receiving the GPRS Service Node for internet communication uses procedures as disclosed in the priority applications again except that the data call passes through the small cell.

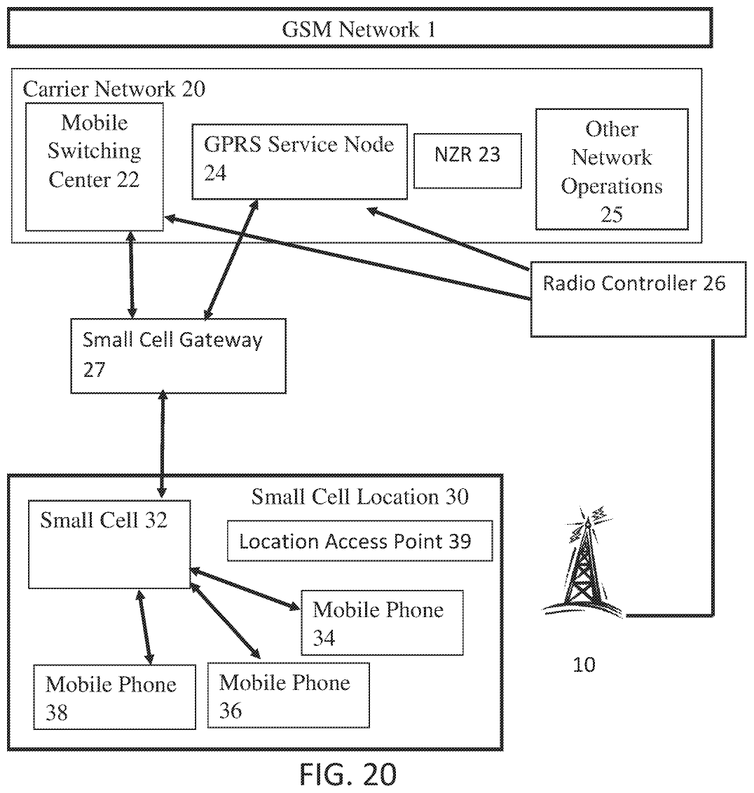

FIG. 20 depicts the small cell network of this disclosure. It may include all of elements described in connection with FIG. 19 and further includes a No Zone Register (NZR) 23 located on the carrier network 20. In one illustrative embodiment above of FIG. 5 above, an illustrative NZR was disclosed as a register that may include a table of geographical locations 210. Geographical locations 210 are physical locations in network 110 in which communication by or to MT 70 over network 110 is to be disabled and/or functions of the MT 70 are to be disabled, enabled or modified. Geographical locations 210 may be a hospital, a movie theater, a performing arts hall, a church, or other places where the use of cell phones may interfere with the public enjoyment, health, welfare, or safety. GPS positions 220 of the geographical locations 210 are provided for identifying the GPS positions of the locations. For a location that may be identified by an area of GPS positions, these GPS positions would be provided as GPS position 220 in the database of NZR 23.

As disclosed throughout this specification, NZR may contain any restriction on that disables a function of the wireless device when it is in the one of the physical locations defined in the NZR. Restrictions may include restrictions on voice communication, text messages, emails, and data communication. Restrictions may include disabling the camera; disabling audio recording; cease rendering augmented reality content; start/resume, stop/end, path generation, path control, automatic path control system and other system override control; and so on; as disclosed throughout this specification

NZR 23 may include any of the illustrative restrictions on a function of the phone including the illustrative examples disclosed herein, including in the memory maps explained below. In the small cell network of this disclosure, the small cell network

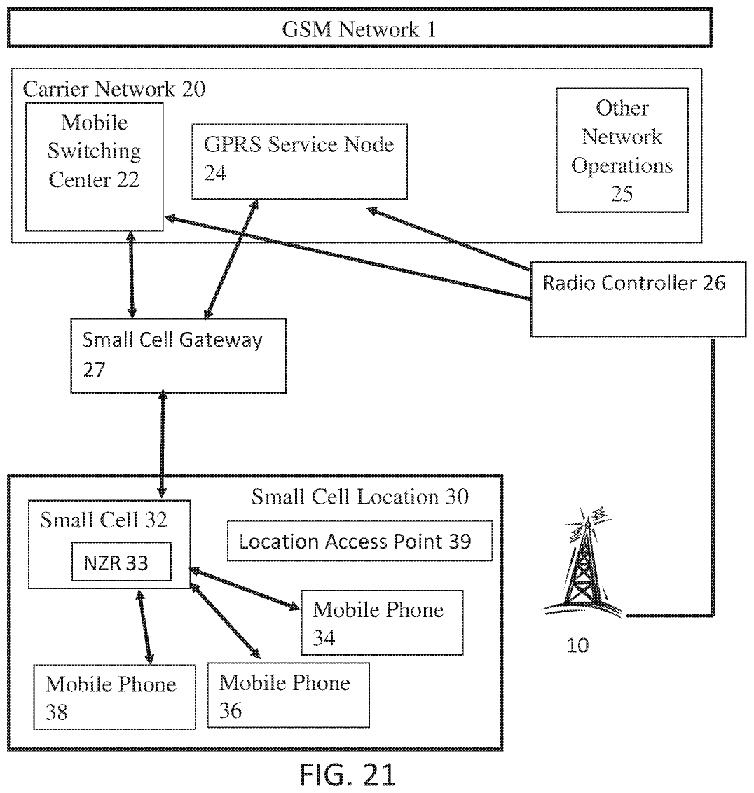

Small cell 32 is configured to permit mobile terminal to establish a communication link with tower 10 through small cell 32 under restricted conditions as disclosed herein. In one illustrative example, small cell 32 limits the digital data throughput to the mobile terminal to digital data associated with small cell location 30. In one illustrative example, data throughput to mobile terminal A is limited by small cell 32 to digital data from the website of the store occupying the premises (e.g., www.store1.com) or from a sponsored or co-sponsored site of store 1. The website of the store (e.g., www.store1.com) or from a sponsored or co-sponsored site of store 1 may be stored according to a memory map as disclosed herein in NZR 23 of network as depicted in FIGS. 20, 21, for example. Alternatively, the memory map may be stored in NZR 33 of small cell 32. In other embodiments a memory map may be stored in either or both NZR of network and small cell, or portions of the memory may be located in the NZR of the network with remaining portions located in the NZR of the small cell.

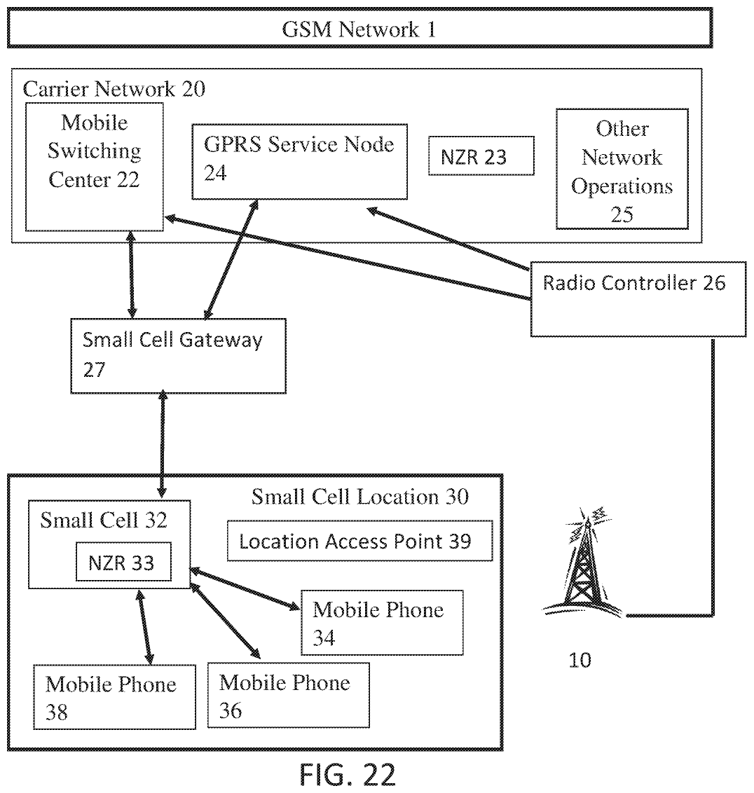

FIG. 21 is an alternative small cell network of this disclosure. It may include all of elements described in connection with FIG. 19 and further includes a No Zone Register (NZR) 33 located in the small cell. FIG. 22 is an alternative small cell network of this disclosure. It may include all of elements described in connection with FIG. 19 and further includes a No Zone Register (NZR) 23 located in the carrier network 20 and a No Zone Register (NZR) 33 in the small cell. The embodiments of FIG. 20, FIGS. 21 and 22 operate with the restrictions imposed on the communication link between the mobile terminal and the network. These restrictions are stored in an NZR located in the small cell or both smart cell and network.

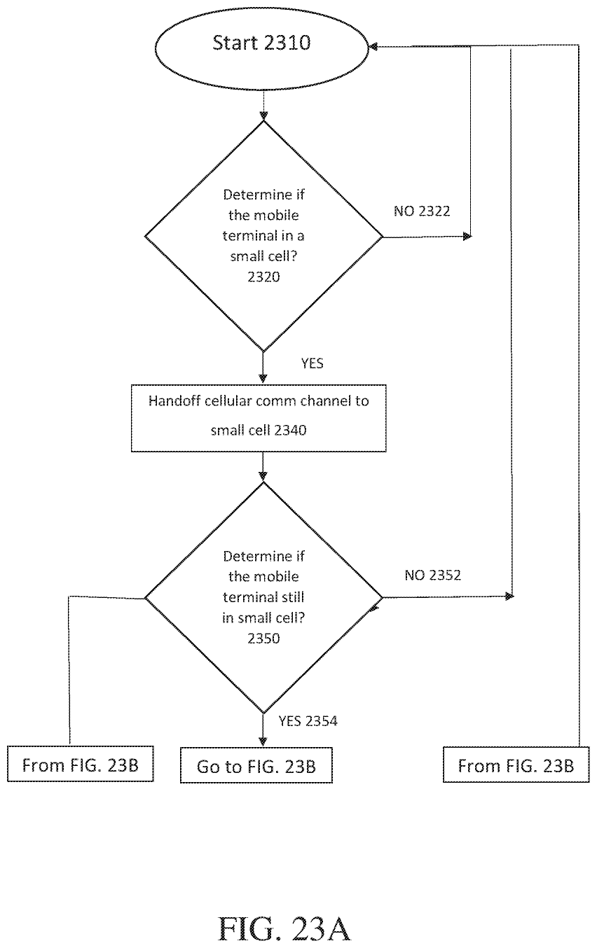

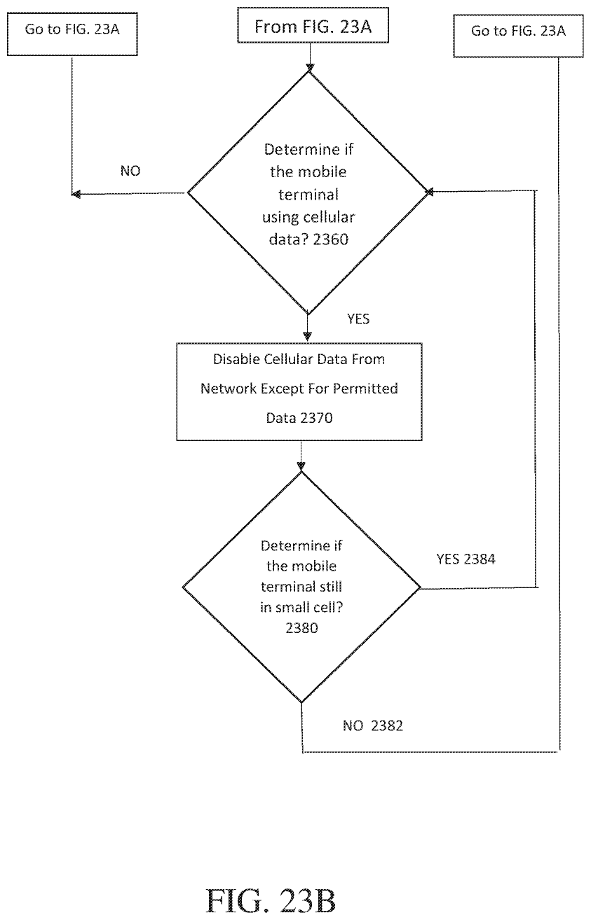

FIG. 23 discloses an embodiment of a method for dead zone in small cell application. The method begins at Start 2310. At step 2320, the NETWORK determines whether mobile terminal is in a small cell. If NO 2322, the method is returned by the NETWORK to Start 2320. If YES, the method is advanced by the NETWORK to step 2340. At step 2340, the NETWORK hands-off the cellular communication channel to small cell. At step 2350, the SMALL CELL determines if the mobile terminal is still in the small cell. If NO 2352, the NETWORK takes over the communication channel and returns the method to Start 2320. If YES 2354, control remains with small cell and the method advances to step 2360.

At step 2360, the SMALL CELL determines if the mobile terminal is using cellular data. If NO, the method is returned by the SMALL CELL to step 2350 where the small cell determines if the mobile terminal is still in the small cell. If YES, the method advances to step 2370 where the cellular data from the network is disabled by the small cell or by the network at the direction of the small cell except for cellular data permitted to be accessed by the mobile terminal at the small cell location. The method advances to step 2380 where the SMALL CELL determines if the mobile terminal is still in the small cell. If NO 2382, the NETWORK takes over the communication channel and returns the method to Start 2320. If YES 2354, control remains with small cell and the method advances to step 2360 where the small cell determines if the mobile terminal is using cellular data.

While the forgoing embodiment of the method involves disabling cellular data from network except for permitted cellular data (e.g., throttling), in other embodiments, the method may disable voice communication or another one or more functions of the mobile terminal by for example control signals by the small cell or by the network at the direction of the small cell. For example, an art gallery may want to prevent the function of a mobile terminal of taking a photo, audio, video, making a voice call, texting, emailing, or internet browsing within the art gallery. The method may control any function of the mobile terminal that an establishment at the small cell location may find desirable to improve the experience of a visitor as well as advancing the mission of the establishment such as avoiding flash image capture in an art gallery which may degrade the characteristic of paintings, avoiding calls in a restaurant designed for quiet dining, avoiding browsing of competitor online stores in a brick and mortar store to help drive sales, controlled WiFi and cellular access at airports to avoid interference with signaled control of airplanes as well as interference with communication systems, and so on.

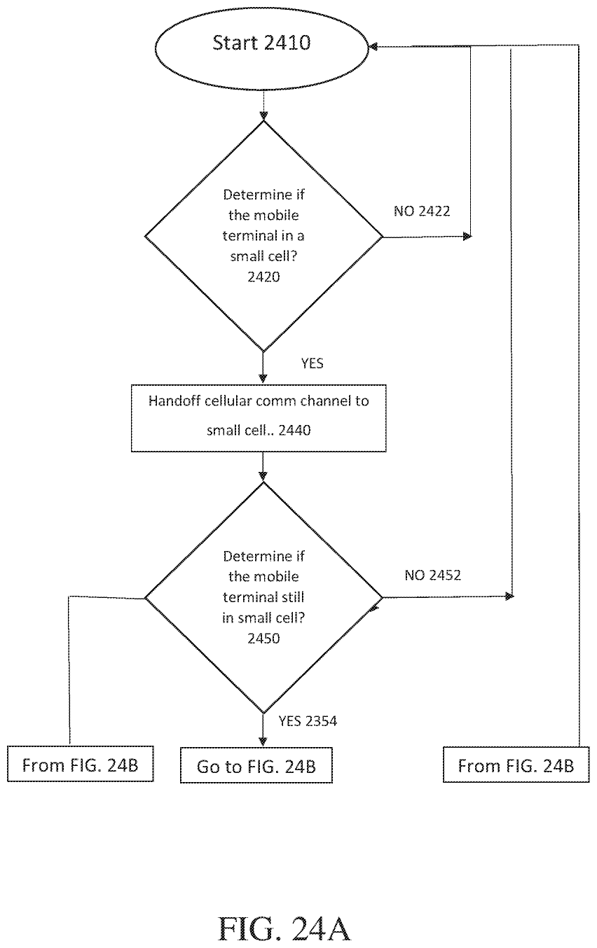

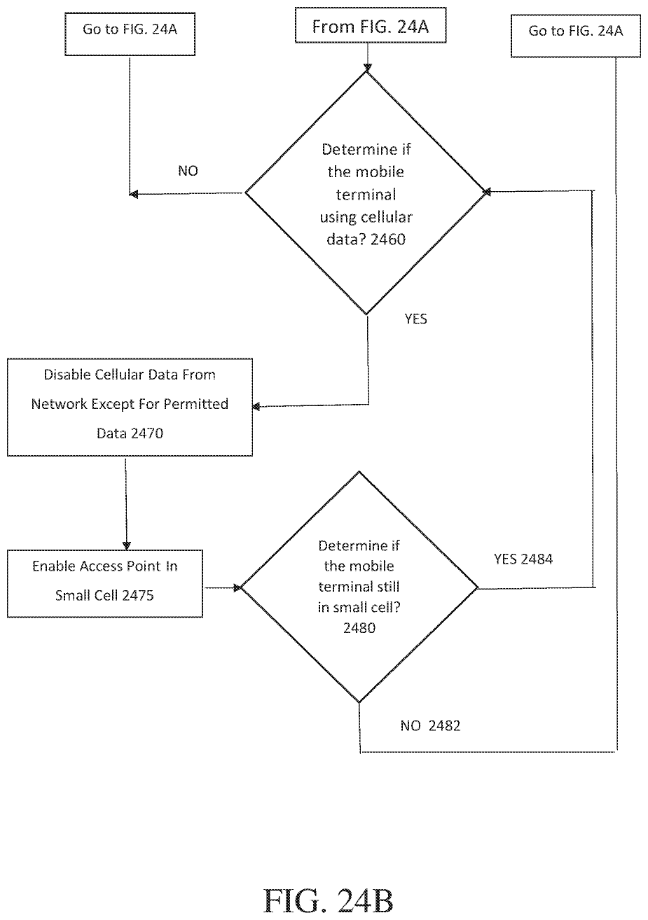

FIG. 24 discloses an embodiment of a method for dead zone in small cell application. The method begins at Start 2410. At step 2420, the NETWORK determines whether mobile terminal is in a small cell. If NO 2422, the method is returned by the NETWORK to Start 2420. If YES, the method is advanced by the NETWORK to step 2440. At step 2440, the NETWORK hands-off the cellular communication channel to small cell. At step 2450, the SMALL CELL determines if the mobile terminal is still in the small cell. If NO 2452, the NETWORK takes over the communication channel and returns the method to Start 2420. If YES 2454, control remains with small cell and the method advances to step 2460.

At step 2460, the SMALL CELL determines if the mobile terminal is using cellular data. If NO, the method is returned by the SMALL CELL to step 2450 where the small cell determines if the mobile terminal is still in the small cell. If YES, the method advances to step 2470 where the cellular data from the network is disabled by the small cell or by the network at the direction of the small cell except for cellular data permitted to be accessed by the mobile terminal at the small cell location. The method advances to step 2475 where the access point of the small cell location is enabled by the small cell or by the network at the direction of the small cell for subscriber access by the mobile terminal at the small cell location according to the permissions applied at the location.

The method advances to step 2480 where the SMALL CELL determines if the mobile terminal is still in the small cell. If NO 2482, the NETWORK takes over the communication channel and returns the method to Start 2420. If YES 2454, control remains with small cell and the method advances to step 2460 where the small cell determines if the mobile terminal is using cellular data.

While the forgoing embodiment of the method involves disabling cellular data from network except for permitted cellular data (e.g., throttling), in other embodiments, the method may disable voice communication or another one or more functions of the mobile terminal by for example control signals by the small cell or by the network at the direction of the small cell. For example, an art gallery may want to prevent the function of a mobile terminal of taking a photo, audio, video, making a voice call, texting, emailing, or internet browsing within the art gallery. The method may control any function of the mobile terminal that an establishment at the small cell location may find desirable to improve the experience of a visitor as well as advancing the mission of the establishment such as avoiding flash image capture in an art gallery which may degrade the characteristic of paintings, avoiding calls in a restaurant designed for quiet dining, avoiding browsing of competitor online stores in a brick and mortar store to help drive sales, controlled WiFi and cellular access at airports to avoid interference with signaled control of airplanes as well as interference with communication systems, and so on.

While the access point of the small cell location is enabled in this location, it may be disabled. Alternatively, the AP may be restricted. For example, for a store 1, the AP may be enabled to www.store1.com, store1 sponsored sites, and/or store1/carrier co-sponsored sites. For a restaurant, the AP may be enabled to restaurant app for menu and ordering. For a common location in a mall, for example, the AP sites may be throttled. For example, a common area in a mall may limit channel access over the internet to websites that do not compete with any of the stores at the mall in order to prevent patrons of the stores from accessing competitive stores for pricing and product comparisons while in the middle of a sales experience at a brick and mortar store.

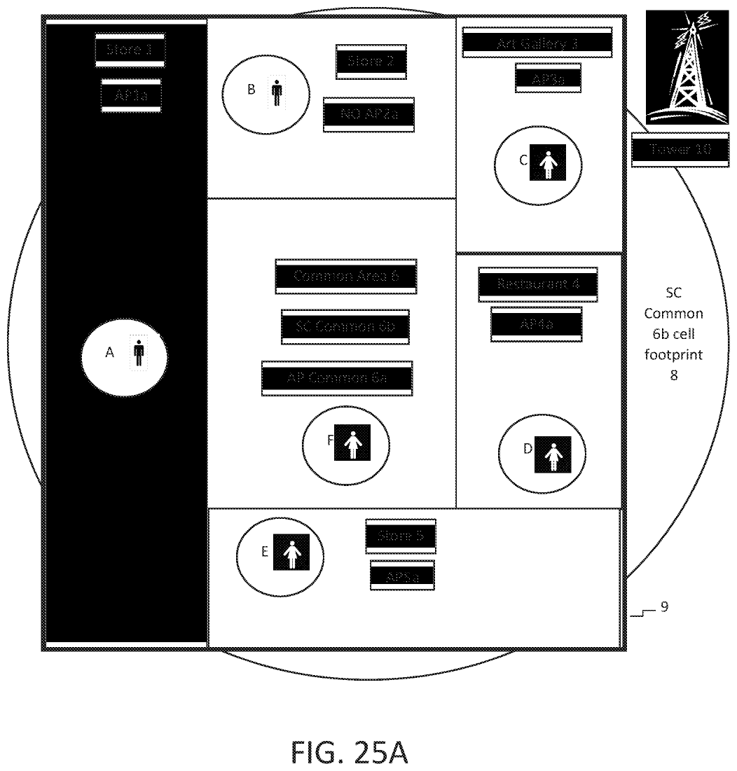

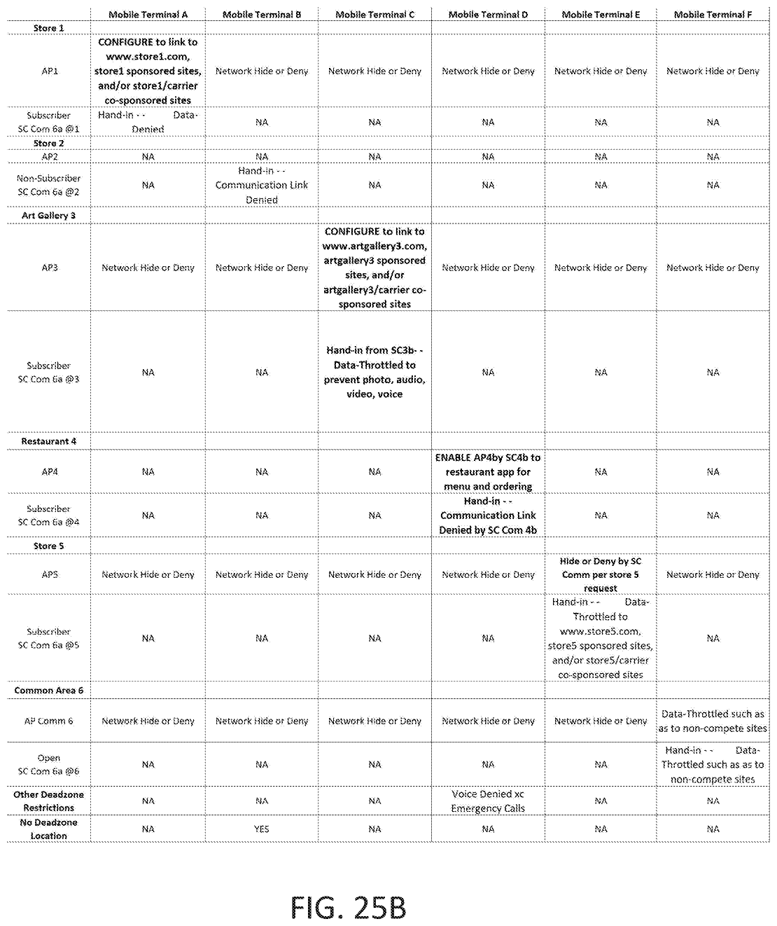

FIG. 25 depicts illustrative dead zone application to small cell.

FIG. 25A shows a mall 9 with store1, store 2, art gallery 3, restaurant 4, store 5, and a common area 6.

Store 1 includes an access point (“AP”) denoted AP 1a. Store 2 includes no access point (i.e., No AP 2a. Art gallery 3 includes an access point AP 3a. Restaurant 4 includes an access point AP 4a. Store 5 includes access point. Common area 6 includes an access point AP 6a and a small cell SC Com 6b which forms a cellular footprint SC Com 6 cell 6.

A person with mobile terminal A is visiting store 1, a person with mobile terminal B is visiting store 2, a person with mobile terminal C is visiting art gallery 3, a person with mobile terminal D is visiting restaurant 4, a person with mobile terminal E is visiting store 5, and a person with mobile terminal F is in common area 6.

As depicted in the NZR memory map shown in FIG. 25B applicable to mall 9 shown in FIG. 25A, as mobile terminals A, B, C, D, E, F enter mall 9 from the outside, the network hands off the signal from tower 10 to SC common 6b. For example, if mobile terminal A is entering store 1 from outside the mall, the hand-off may be from tower 10. If the mobile terminal A is entering store A from common area 6, there is no hand-off since common area 6 and store 1 both use SC common 6b to control the communication link between the mobile terminal A and the network. After the handoff to SC Com 6b, SC Com 6b controls the communication link between mobile terminals A-F and the network, and all control signals that may be imposed on the mobile terminals A-F by the network for the purpose of controlling functions of the mobile terminals that may be controlled by the network. Should the signal of tower 10 try to effect a handover of the communication link with mobile terminals A-F from SC Com 6b because the signal of tower 10 may become stronger than the signal of SC Com 6b or for some other reason, SC Com 6b will deny hand-over of the communication signal to tower 10 except as disclosed herein.

In this illustrative embodiment, SC Com 6b configures mobile terminals A-F to establish a communication link with tower 10 through SC Com 6b under restricted conditions as disclosed herein.

In one illustrative example, SC Com 6b limits the digital data throughput to the mobile terminal A to digital data associated with store 1. In one illustrative example, data throughput to mobile terminal A is limited by SC Com 6b to digital data from the website of the store (e.g., www.store1.com) or from a sponsored or co-sponsored site of store 1. The website of the store (e.g., www.store1.com) or from a sponsored or co-sponsored site of store 1 may be stored according to a memory map as depicted in FIG. 25B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

This NZ or dead zone condition applies when mobile terminal A enters store 1. On entry of store 1, the communication link between the mobile terminal A and the network is handed off to SC Com 6b. Once the handoff is complete, the network knows that mobile terminal A is connected to the network through SC Corn 6b. The network also knows that when mobile terminal A is connected at location store 1 to the network through SC Corn 6b, the restrictions set forth in the memory map associated with SC Corn 6b @1 apply. As explained, the map may be in an NZR register in the network, on the SC Corn 6b, or both.

The network then applies the restrictions found in the memory map to the communication link between the mobile terminal A and the network. In this example, those restrictions would cause SC Corn 6b to configure mobile terminal A to LINK to AP1 which would be tuned to the channel of the internet that broadcasts data on store 1. For example, the channel may be www.store1.com, store1 sponsored sites, and/or store1/carrier co-sponsored sites. SC Corn 6b would also tune the cellular data on the communication link to the channel of the internet that broadcasts data on store 1. For example, the channel may be www.store1.com, store1 sponsored sites, and/or store1/carrier co-sponsored sites. With these restrictions applied to mobile terminal A, the internet browsing possible by the mobile terminal A is limited to data on the channel. In this way, the internet browsing capability of mobile terminal A has been throttled to cellular data to content from www.store1.com, store1 sponsored sites, and/or store1/carrier co-sponsored sites.

SC Corn 6b also configures mobile terminal A so as to hide all but the AP1 of store 1.

The operation of mobile terminals B-F at store 2, art gallery 3, restaurant 4, store 5, and common area 6 are similar to the operation of mobile terminal A at store 1 with sc comm 6b controlling the communication link between these mobile terminals and the network except imposing the restrictions noted in the memory map depicted in FIG. X that for each location is different. Alternatively, all the restrictions may be the same or substantially similar.

For example, and as depicted on the memory map of FIG. 25B, mobile terminal B will have no internet access from an AP at store 2 since there is no AP at store 2. However, mobile terminal B may have access to AP1 of store 1, AP3 of art gallery 3, and AP 4 of restaurant 4 if access to those APs is unrestricted and the signal strength is sufficient. Each of these APs may allow access to drive traffic to the respective outlets. For example, AP4 of restaurant 4 may be configured to allow mobile terminal B to access AP4 only on the channel of the internet that broadcasts data on store 1 such as www.restaurant4.com, restaurant 4 sponsored sites, and/or restaurant 4/carrier co-sponsored sites. AP1 and AP3 may likewise be configured to allow mobile terminal B to tune to one or more limited channels of content associated with store 1 or art gallery 3, as the case may be.

As another example, the internet browsing possible by the mobile terminal C is limited to data from AP3 on the art gallery predetermined channel. Mobile terminal C would not be able to access cellular data or place a voice call. In addition, photo, audio, video functionality of mobile terminal C would be disabled so as to prevent photos, audio, and/or video functionality while in the art gallery.

With restrictions applied to mobile terminal D, the internet browsing possible by the mobile terminal D is limited to data through the app for menu and ordering. Mobile terminal D would not be able to access AP or cellular data or place a voice call.

The operation of mobile terminals E and F would be similar to the operation of mobile terminal A in store 1 except that sc comm 6b is controlling the communication link between the mobile terminal E and F and the network by imposing the restrictions noted in the memory map depicted in FIG. 25B. For example, with mobile terminal E, AP5 access would be denied cellular data would be throttled to www.store5.com, store5 sponsored sites, and/or store5/carrier co-sponsored sites. For mobile terminal F, both AP6 data and cellular data over SC Com 6 would be throttled such as to non-compete sites

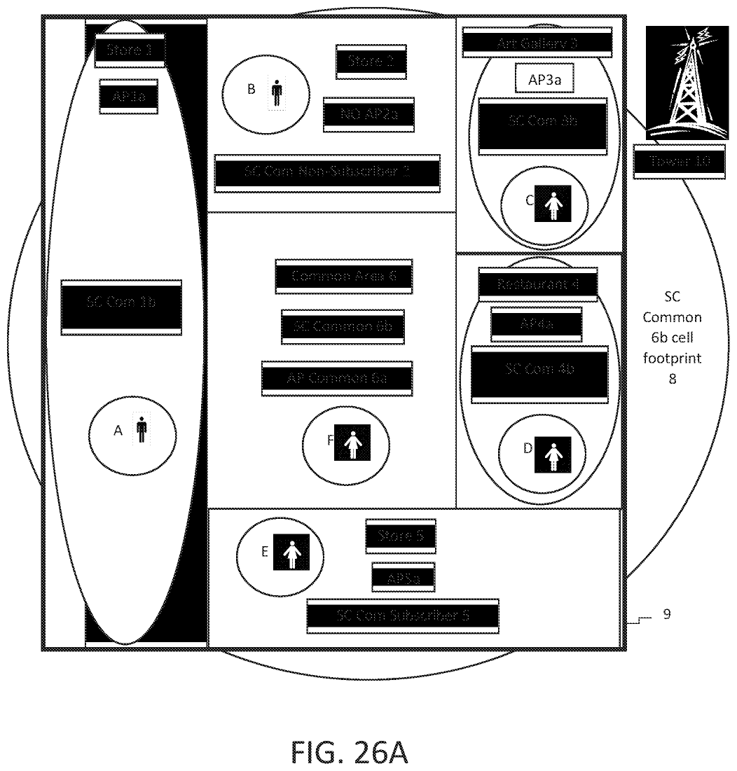

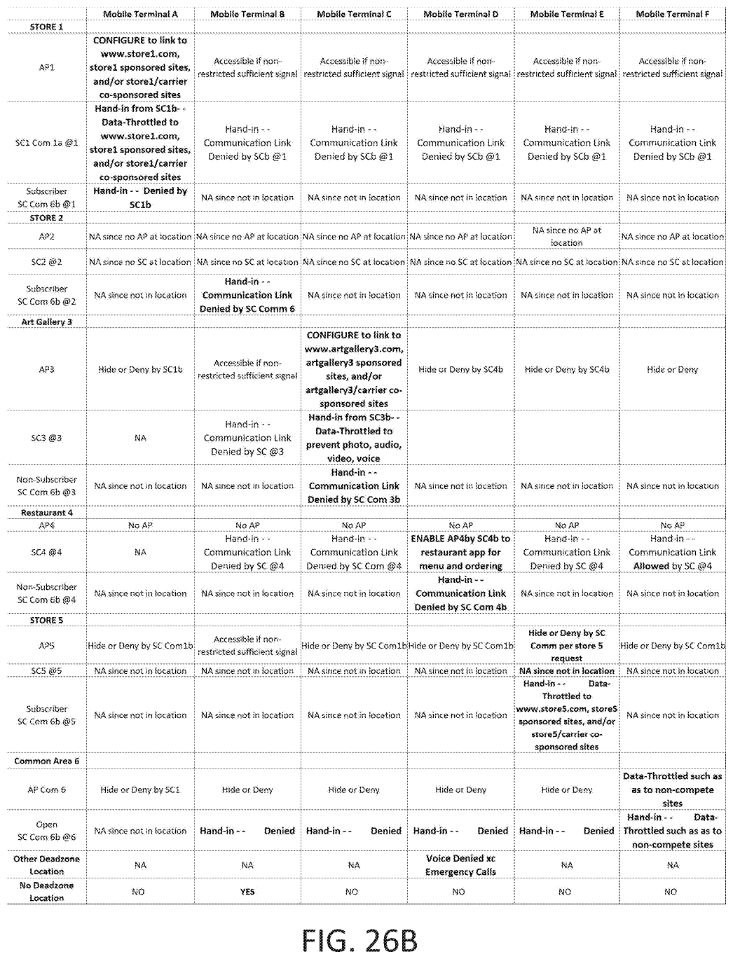

FIG. 26A shows a mall 9 with store1, store 2, art gallery 3, restaurant 4, store 5, and a common area 6.

Store 1 includes an access point (“AP”) denoted AP 1a, a small cell (“SC Com”) denoted SC Com 1b which forms a cellular footprint (“SC Common Cell”) denoted SC Com 1 cell 1.

Store 2 includes no access point (i.e., No AP 2a, has no small cell, and does not subscribe to SC com 6a (i.e., SC Common 6 cell 6).

Art gallery 3 includes an access point AP 3a, a small cell SC Com 3b which forms a cellular footprint SC Com 3 cell 3.

Restaurant 4 includes an access point AP 4a, a small cell SC Com 4b which forms a cellular footprint SC Com 4 cell 4.

Store 5 includes access point (i.e., AP 5a), has no small cell, but subscribes to SC com 6a (i.e., SC Common 6 cell 6).

Common area 6 includes an access point AP 6a, a small cell SC Com 6b which forms a cellular footprint SC Com 6 cell 6.

A person with mobile terminal A is visiting store 1, a person with mobile terminal B is visiting store 2, a person with mobile terminal C is visiting art gallery 3, a person with mobile terminal D is visiting restaurant 4, a person with mobile terminal E is visiting store 5, and a person with mobile terminal F is in common area 6.

As depicted in the NZR memory map shown in FIG. 26B applicable to mall 9 shown in FIG. 26A, as mobile terminal A enters store 1, the network hands off the signal from either tower 10 or SC common 6b, as the case may be, to SC Com 1b. For example, if mobile terminal A is entering store 1 from outside the mall, the hand-off may be from tower 10. If the mobile terminal A is entering store A from common area 6, the hand-off may be from SC common 6b. In either case, after the handoff to SC Com 1b, SC Com 1b controls the communication link between mobile terminal A and the network, and all control signals that may be imposed on the mobile terminal A by the network for the purpose of controlling functions of the mobile terminal A that may be controlled by the network. Should the signal of SC Com 6b at common area 6 try to effect a handover of the communication link with mobile terminal A from SC Com 1b because the signal of SC Com 6b may become stronger than the signal of SC1 Com 1b or for some other reason, SC Com 1 will deny hand-over of the communication signal to SC Com 6b. Similarly, should the signal of tower 10 try to effect a handover of the communication link with mobile terminal A from SC Com 1b because the signal of tower 10 may become stronger than the signal of SC Com 1b or for some other reason, SC Com 1b will deny hand-over of the communication signal to tower 10 except as disclosed herein.

In this illustrative embodiment, store 1 configures its SC Com 1b to permit mobile terminal A to establish a communication link with tower 10 through SC Com 1b under restricted conditions as disclosed herein. In one illustrative example, SC Com 1b limits the digital data throughput to the mobile terminal A to digital data associated with store 1. In one illustrative example, data throughput to mobile terminal A is limited by SC Com 1b to digital data from the website of the store (e.g., www.store1.com) or from a sponsored or co-sponsored site of store 1. The website of the store (e.g., www.store1.com) or from a sponsored or co-sponsored site of store 1 may be stored according to a memory map as depicted in FIG. 26B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

This NZ or dead zone condition applies when mobile terminal A enters store 1. On entry of store 1, the communication link between the mobile terminal A and the network is handed off to SC Com 1b. Once the handoff is complete, the network knows that mobile terminal A is connected to the network through SC Com 1b. The network also knows that when mobile terminal A is connected to the network through SC Com 1b, the restrictions set forth in the memory map associated with SC Com 1b apply. As explained, the map may be in an NZR register in the network, on the SC Com 1b, or both.

The network then applies the restrictions found in the memory map to the communication link between the mobile terminal A and the network. In this example, those restrictions would cause SC Com 1b to configure mobile terminal A to LINK to AP1 which would be tuned to the channel of the internet that broadcasts data on store 1. For example, the channel may be www.store1.com, store1 sponsored sites, and/or store1/carrier co-sponsored sites. SC Com 1b would also tune the cellular data on the communication link to the channel of the internet that broadcasts data on store 1. For example, the channel may be www.store1.com, store1 sponsored sites, and/or store1/carrier co-sponsored sites. With these restrictions applied to mobile terminal A, the internet browsing possible by the mobile terminal A is limited to data on the channel. In this way, the internet browsing capability of mobile terminal A has been throttled to cellular data to content from www.store1.com, store1 sponsored sites, and/or store1/carrier co-sponsored sites.

Mobile terminal A would not be able to establish a communication link with small cells located elsewhere since SC Com 1b prevents it. SC Com 1b also configures mobile terminal A so as to hide all but the AP1 of store 1.

Store 2 has neither an AP nor small cell. Nor does store 2 subscribe to the SC Common. In effect, store 2 is a no dead zone. There is no restriction imposed on the communication link between mobile terminal B and the network by store 2. When mobile terminal B enters store 2, there is nothing done by store 2 to force a handoff of the communication link between mobile terminal B and the network. If mobile terminal B enters from the street, the communication link between mobile terminal B and the network will be through tower 10. That communication link may remain uninterrupted while mobile terminal B is in store 2. If mobile terminal B enters from common area 6, the communication the communication link between mobile terminal B and the network will be through SC common 6. Once in the store, the communication link to the network through SC common 6 will be interrupted since store 2 is not a subscriber to receive access to the signal from SC common 6. Mobile terminal B will then search for and find the signal from tower 10 and connect to the network through tower 10. The communication link between mobile terminal B and the network through tower 10 may be uninterrupted while the mobile terminal B is in store 2.

As depicted on the memory map of FIG. 26B, mobile terminal B will have no internet access from an AP at store 2 since there is no AP at store 2. However, mobile terminal B may have access to AP1 of store 1, AP3 of art gallery 3, and AP 4 of restaurant 4 if access to those APs is unrestricted and the signal strength is sufficient. Each of these APs may allow access to drive traffic to the respective outlets. For example, AP4 of restaurant 4 may be configured to allow mobile terminal B to access AP4 only on the channel of the internet that broadcasts data on store 1 such as www.restaurant4.com, restaurant 4 sponsored sites, and/or restaurant 4/carrier co-sponsored sites. AP1 and AP3 may likewise be configured to allow mobile terminal B to tune to one or more limited channels of content associated with store 1 or art gallery 3, as the case may be.

Art Gallery 3 has AP3 and SC Com 3. As mobile terminal C enters art gallery 3, the network hands off the signal from either tower 10 or SC common 6b, as the case may be, to SC Com 3b. For example, if mobile terminal C is entering art gallery 3 from outside the mall, the hand-off may be from tower 10. If the mobile terminal C is entering art gallery 3 from common area 6, the hand-off may be from SC common 6a. In either case, after the handoff to SC Com 3b, SC Com 3b controls the communication link between mobile terminal C and the network, and all control signals that may be imposed on the mobile terminal C by the network for the purpose of controlling functions of the mobile terminal C that may be controlled by the network. Should the signal of SC Com 6b at common area 6 try to effect a handover of the communication link with mobile terminal C from SC Com 3b because the signal of SC Com 6b may become stronger than the signal of SC Com 3b or for some other reason, SC Com 3b will deny hand-over of the communication signal to SC Com 6b. Similarly, should the signal of tower 10 try to effect a handover of the communication link with mobile terminal C from SC Com 3b because the signal of tower 10 may become stronger than the signal of SC Com 3b or for some other reason, SC Com 3b will deny hand-over of the communication signal to tower 10 except as disclosed herein.

In this illustrative embodiment, art gallery 3 configures its SC Com 3b to permit mobile terminal B to establish a communication link with tower 10 through SC Com 3b under restricted conditions as disclosed herein. In one illustrative example, SC Com 3b limits the digital data throughput to the mobile terminal C to digital data associated with art gallery 3. In one illustrative example, data throughput to mobile terminal B is limited by SC Com 3b to digital data from the website of the art gallery (e.g., www.artgallery3.com) or from a sponsored or co-sponsored site of store 1. The website of the store (e.g., www.artgallery3.com) or from a sponsored or co-sponsored site of art gallery 3 may be stored according to a memory map as depicted in FIG. 26B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

This NZ or dead zone condition applies when mobile terminal C enters art gallery 3. On entry of art gallery 3, the communication link between the mobile terminal C and the network is handed off to SC Com 3b. Once the handoff is complete, the network knows that mobile terminal C is connected to the network through SC Com 3b. The network also knows that when mobile terminal C is connected to the network through SC Com 3b, the restrictions set forth in the memory map associated with SC Com 3b apply. As explained, the map may be in an NZR register in the network, on the SC Com 3b, or both.

The network then applies the restrictions found in the memory map to the communication link between the mobile terminal C and the network. In this example, those restrictions would cause SC Com 3b to configure mobile terminal C to LINK to AP3 which would be tuned to the channel of the internet that broadcasts data on art gallery 3. For example, the channel may be www.artgallery3.com, artgallery3 sponsored sites, and/or artgallery3/carrier co-sponsored sites. SC Com 3b would also throttle cellular data and apply control signals from SC Com 3b, the network, or both to prevent photo, audio, video, voice.

With these restrictions applied to mobile terminal C, the internet browsing possible by the mobile terminal C is limited to data from AP3 on the art gallery predetermined channel. Mobile terminal C would not be able to access cellular data or place a voice call. In addition, photo, audio, video functionality of mobile terminal C would be disabled so as to prevent photos, audio, and/or video functionality while in the art gallery.

Mobile terminal A would not be able to establish a communication link with small cells located elsewhere since SC Com 1b prevents it. SC Com 1b also configures mobile terminal A so as to hide all but the AP1a of store 1.

Restaurant 4 has AP4a and SC Com 4b. As mobile terminal D enters restaurant 4, the network hands off the signal from either tower 10 or SC common 6b, as the case may be, to SC Com 3b. For example, if mobile terminal D is entering restaurant 4 from outside the mall, the hand-off may be from tower 10. If the mobile terminal D is entering restaurant 4 from common area 6, the hand-off may be from SC common 6b. In either case, after the handoff to SC Com 4b, SC Com 4b controls the communication link between mobile terminal D and the network, and all control signals that may be imposed on the mobile terminal D by the network for the purpose of controlling functions of the mobile terminal D that may be controlled by the network. Should the signal of SC Com 6b at common area 6 try to effect a handover of the communication link with mobile terminal C from SC Com 4b because the signal of SC Com 6b may become stronger than the signal of SC Com 4b or for some other reason, SC Com 4B will deny hand-over of the communication signal to SC Com 6b. Similarly, should the signal of tower 10 try to effect a handover of the communication link with mobile terminal C from SC Com 4b because the signal of tower 10 may become stronger than the signal of SC Com 4b or for some other reason, SC Com 4b will deny hand-over of the communication signal to tower 10 except as disclosed herein.

In this illustrative embodiment, restaurant 4 configures its SC Com 4b to permit mobile terminal B to establish a communication link with tower 10 through SC Com 4b under restricted conditions as disclosed herein. In one illustrative example, SC Com 4b limits the digital data throughput to the mobile terminal D to digital data associated with restaurant 4. In one illustrative example, data throughput to mobile terminal D is limited by SC Com 4b to digital data from an app for menu and ordering. The website to which the app for menu and ordering connects may be stored according to a memory map as depicted in FIG. 26B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

This NZ or dead zone condition applies when mobile terminal D enters restaurant 4. On entry of restaurant 4, the communication link between the mobile terminal D and the network is handed off to SC Com 4b. Once the handoff is complete, the network knows that mobile terminal D is connected to the network through SC Com 4b. The network also knows that when mobile terminal D is connected to the network through SC Com 4b, the restrictions set forth in the memory map associated with SC Com 4b apply. As explained, the map may be in an NZR register in the network, on the SC Com 4b, or both.

The network then applies the restrictions found in the memory map to the communication link between the mobile terminal D and the network. In this example, those restrictions would cause SC Com 4b to configure mobile terminal D to LINK by app to a website for menu and ordering.

With these restrictions applied to mobile terminal D, the internet browsing possible by the mobile terminal D is limited to data through the app for menu and ordering. Mobile terminal D would not be able to access AP or cellular data or place a voice call.

Mobile terminal D would not be able to establish a communication link with small cells located elsewhere since SC Com 4b prevents it. SC Com 4b also configures mobile terminal D so as to hide all APs.

Store 5 has AP5 but no SC Com. Instead, store 5 subscribes to sc comm 6b to establish the communication link between mobile terminal E and the tower. The operation of mobile terminal E would be similar to the operation of mobile terminal 1 in store 1 except that sc comm 6b is controlling the communication link between the mobile terminal E and the network and imposing the restrictions noted in the memory map depicted in FIG. 26B.

Common area 6 has both AP Comm 6a and SC Common 6b. The operation of mobile terminal F would be similar to the operation of mobile terminal A in store 1 except that sc comm 6b is controlling the communication link between the mobile terminal F and the network and imposing the restrictions noted in the memory map depicted in FIG. 26B.

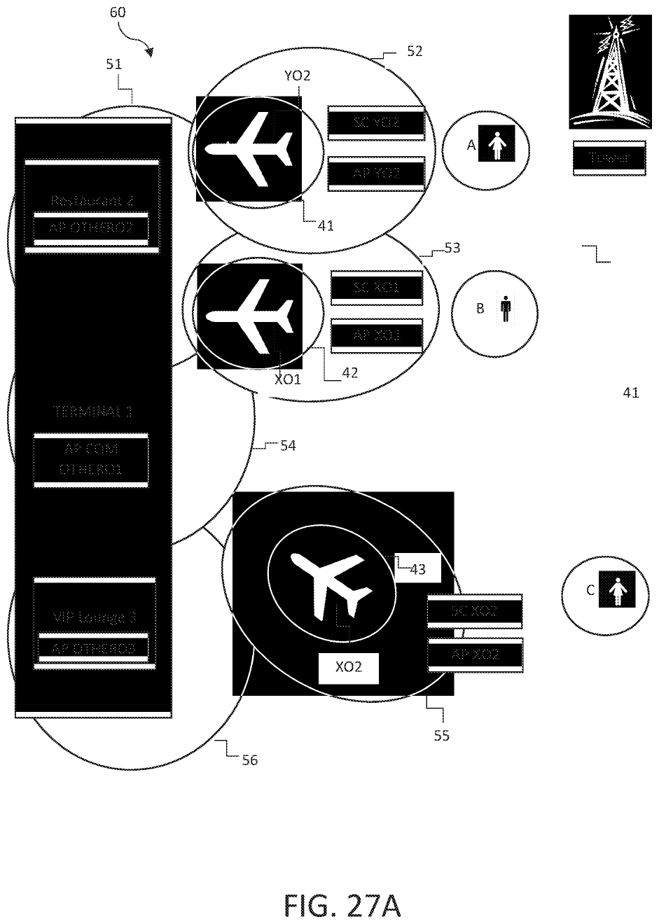

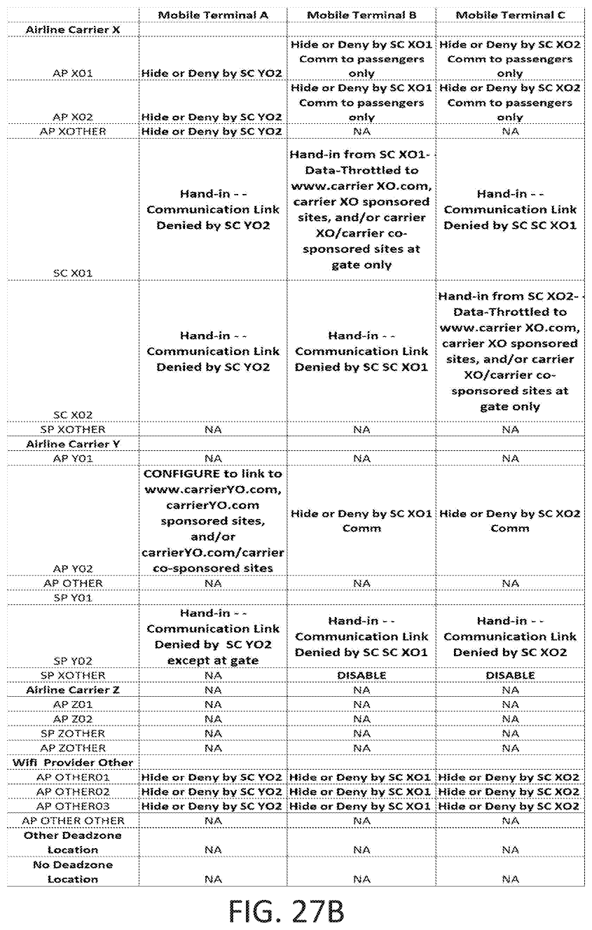

FIG. 27A shows airport 60 with terminal 1 including restaurant 2, and VIP lounge 3.

Terminal 1 includes an access point (“AP”) denoted AP COMMON OTHERO1, accessible to passengers in terminal 1. AP COMMON OTHERO1 services radio cell 54, that is the radio coverage or radio footprint provided by the AP COMMON OTHERO1.

Restaurant 2 includes access point AP OTHERO2, accessible by passengers on-site the restaurant 2. AP OTHERO2 services radio cell 51, that is the radio coverage or footprint provided by the AP OTHERO1.

VIP lounge 3 includes access point AP OTHERO3, accessible by passengers on-site the VIP lounge 3. AP OTHERO3 services radio cell 56, that is the radio coverage or footprint provided by the AP OTHERO3.

Also at airport 60 are three airplanes XO1, YO1, YO2. Airplane XO1 is operated by carrier XO and airplanes YO1, YO2 by carrier YO.

Airplane YO2 includes an access point AP YO2, which forms a radio footprint 41, and a small cell SC YO2 which forms a radio footprint 52.

Airplane XO1 includes an access point AP XO1, which forms a radio footprint 42, and a small cell SC XO1 which forms a radio footprint 53.

Airplane XO2 includes an access point AP XO2, which forms a radio footprint 43, and a small cell SC XO2 which forms a radio footprint 54.

A person with mobile terminal A is inside airplane YO2, a person with mobile terminal B is inside airplane XO1, and a person with mobile terminal C is inside airplane XO2.

As depicted in FIG. 27B, as mobile terminal A enters YO2, the network hands off the signal from tower 10 to SC YO2. After the handoff to SC YO2, SC YO2 controls the communication link between mobile terminal A and the network, and all control signals that may be imposed on the mobile terminal A by the network for the purpose of controlling functions of the mobile terminal A that may be controlled by the network. Should the signal of the signal of tower 10 try to effect a handover of the communication link with mobile terminal A from SC YO2because the signal of tower 10 may become stronger than the signal of SC YO2 or for some other reason, SC YO2 will deny hand-over of the communication signal to tower 10 except as disclosed herein.

In this illustrative embodiment, carrier Y configures its SC YO2 to permit mobile terminal A to establish a communication link with tower 10 through SC YO2 under restricted conditions as disclosed herein. In one illustrative example, SC YO2 limits the digital data throughput to the mobile terminal A to digital data except at gate. The condition of no digital data except at gate may be stored according to a memory map as depicted in FIG. 27B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

This NZ or dead zone condition applies when mobile terminal A enters airplane YO2. On entry of airplane YO2, the communication link between the mobile terminal A and the network is handed off to SC YO2. Once the handoff is complete, the network knows that mobile terminal A is connected to the network through SC YO2. The network also knows that when mobile terminal A is connected to the network through SC YO2, the restrictions set forth in the memory map associated with SC YO2apply. As explained, the map may be in an NZR register in the network, on the SC1 Com 1b, or both.

The network then applies the restrictions found in the memory map to the communication link between the mobile terminal A and the network. In this example, those restrictions would cause SC YO2 to configure mobile terminal A to LINK to AP YO2 which would be tuned to the channel of the internet that broadcasts data on airplane carrier YO. For example, the channel may be www.carrierYO.com, carrierYO.com sponsored sites, and/or carrierYO.com/carrier co-sponsored sites. SC YO2 would also deny any cellular communication except at gate. With these restrictions applied to mobile terminal A, the internet browsing possible by the mobile terminal A is limited to data on the channel of the airplane carrier YO or cellular data but only at the gate. In this way, the internet browsing capability of mobile terminal A has been throttled to cellular data at the gate or data from www.carrierYO.com, carrierYO.com sponsored sites, and/or carrierYO.com/carrier co-sponsored sites.

Mobile terminal A would not be able to establish a communication link with small cells located elsewhere since SC YO2prevents it. SC YO2also configures mobile terminal A so as to hide all but the AP YO2of airplane YO2. FIG. 27B shows the various illustrative restrictions with other AP and small cells. On the memory map of FIG. 27B, these restrictions may be the “other” restrictions noted on the map.

The operation of mobile terminals B and C in airplanes XO1 and XO2 are similar since they are both operated by the same carrier XO. Alternatively, the same carrier may have different restrictions apply to different airplanes. Further, different restrictions may apply at different airports or at different gates at the same airport, and so on. In this embodiment, SC XO1 and SC XO2 are controlling the communication link between the mobile terminals B and C respectively and the network and imposing the restrictions noted in the memory map depicted in FIG. 27B. SC XO1 and SC XO2 configure mobile terminals B and C to hide or deny AP XO1 and AP XO2 to passengers only. This allows the crew to access the internet over the AP. In addition, both SC XO1 and SC XO2 throttle data to www.carrier XO.com, carrier XO sponsored sites, and/or carrier XO/carrier co-sponsored sites at the gate only.

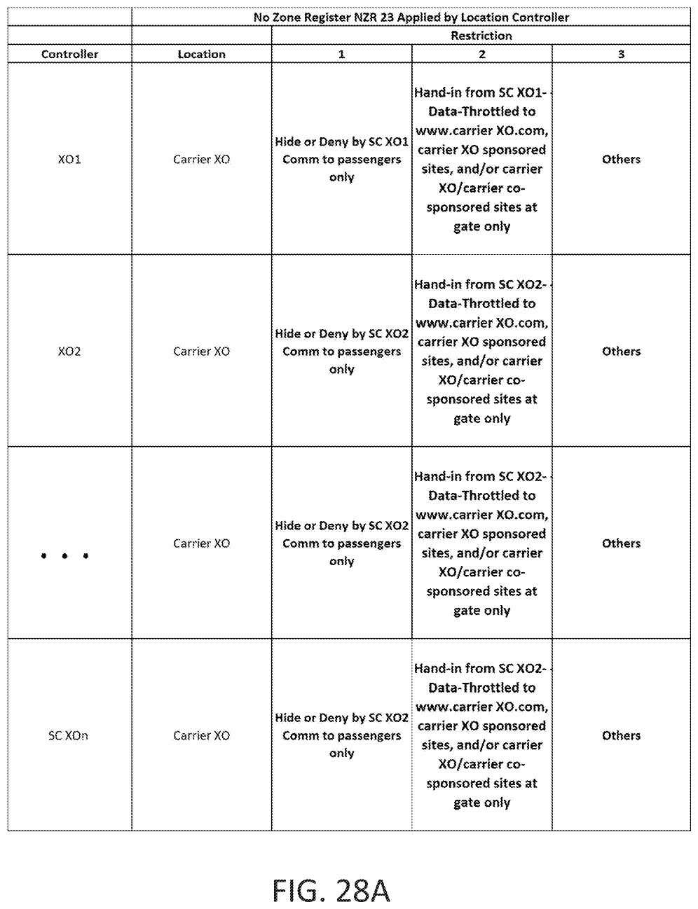

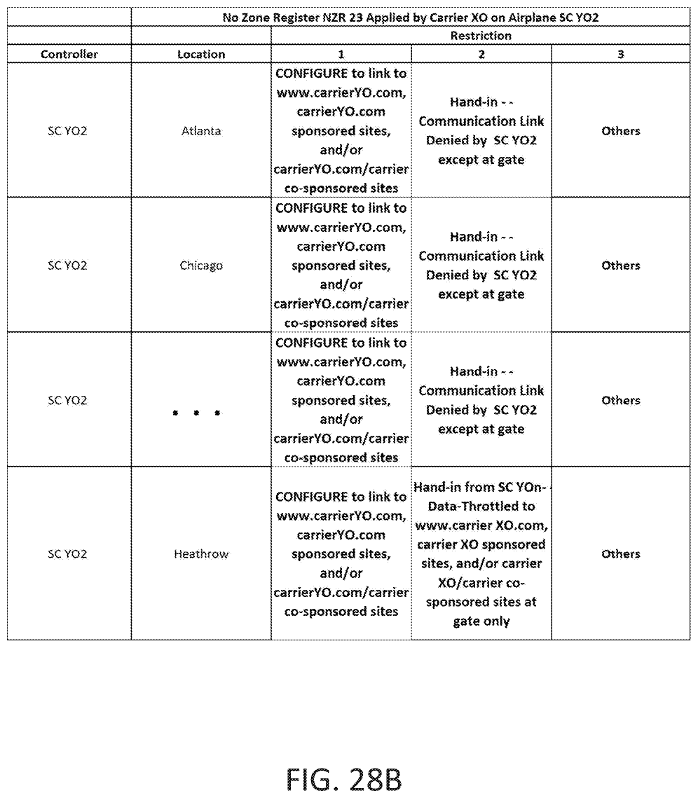

FIG. 28A and FIG. 28B depict alternative illustrative embodiment memory maps for use with airplane carriers as depicted in FIG. 27B in NZR 23 of network as depicted in FIG. 20 for example. Alternatively, the memory map may be stored in NZR 33 of small cell 32 as depicted in FIG. 21. In another embodiment, the memory map may be stored in NZR 23 of network and NZR 33 of small cell 32 as depicted in FIG. 22. In other embodiments portions of the memory map may be located in the NZR of the network with remaining portions located in the NZR of the small cell.

FIG. 28A illustrates restrictions imposed by Carrier XO on communications with the network and AP by small cells. In this embodiment, Carrier XO imposes like restrictions on all of its airplanes at any airport.

FIG. 28B illustrates restrictions imposed by Carrier YO on airplane YO2 communications with the network and AP by small cell SC YO2. In this embodiment, Carrier YO imposes different restrictions on its airplane YO at different airports. For example, in U.S. airports, communication link is denied by SC YO2 except at gate. At Heathrow, the SC YO data is throttled to www.carrier XO.com, carrier XO sponsored sites, and/or carrier XO/carrier co-sponsored sites at gate only.

In another aspect, a system configured for detecting firearm threats on a premises includes a surveillance camera on a premises and a utility. The surveillance camera is configured to generate surveillance data. The utility is configured to provide a cloud service for detecting firearm threats on a premises. The system includes a processor; memory in electronic communication with the processor; and instructions stored in the memory. The instructions are executable by the processor to: detect the presence of a firearm on the premises; and upon detecting a firearm, sending a notification that a firearm has been detected on the premises.

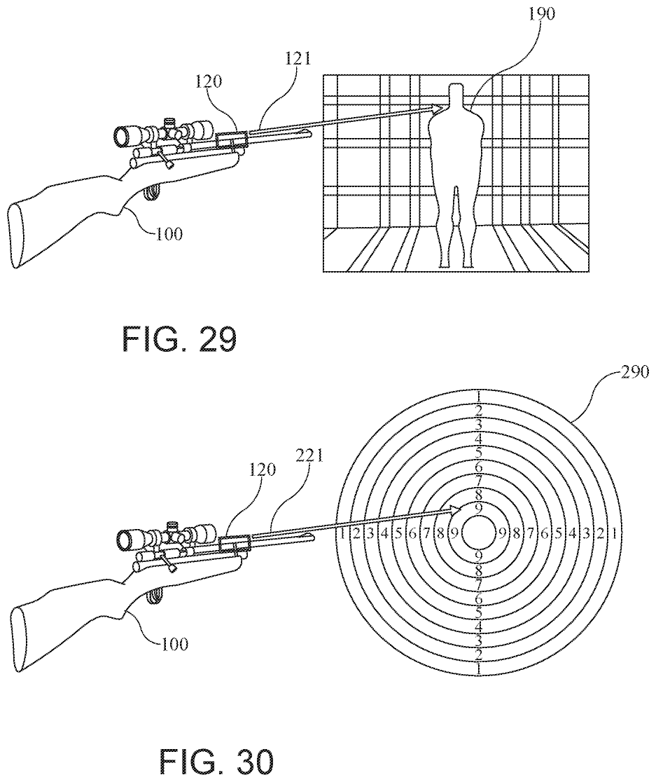

FIG. 29 depicts a firearm 100 with an electronic control system 120 of this disclosure. The firearm is aimed 121 at an object 190 in a shape of a human in this example. The electronic control system 120 processes the image information on the object 190 and in turn issues appropriate control signals to firearm subsystems to control the arm/disarm functionality of the firearm as explained below.

FIG. 30 depicts a firearm 100 with an electronic control system 120 of this disclosure. The firearm is aimed 221 in this case at an object 290 in a shape that is other than the shape of a human in this example. In this case the shape is in the shape of a target of the kind used at a target range. The electronic control system 120 processes the image information on the object 190 and in turn issues appropriate control signals to firearm subsystems to control the arm/disarm functionality of the firearm as explained below.

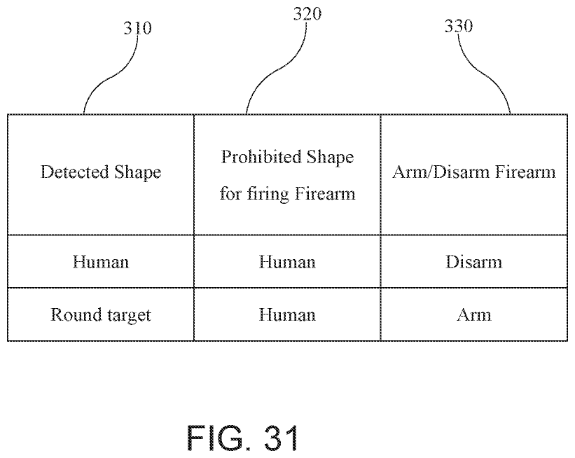

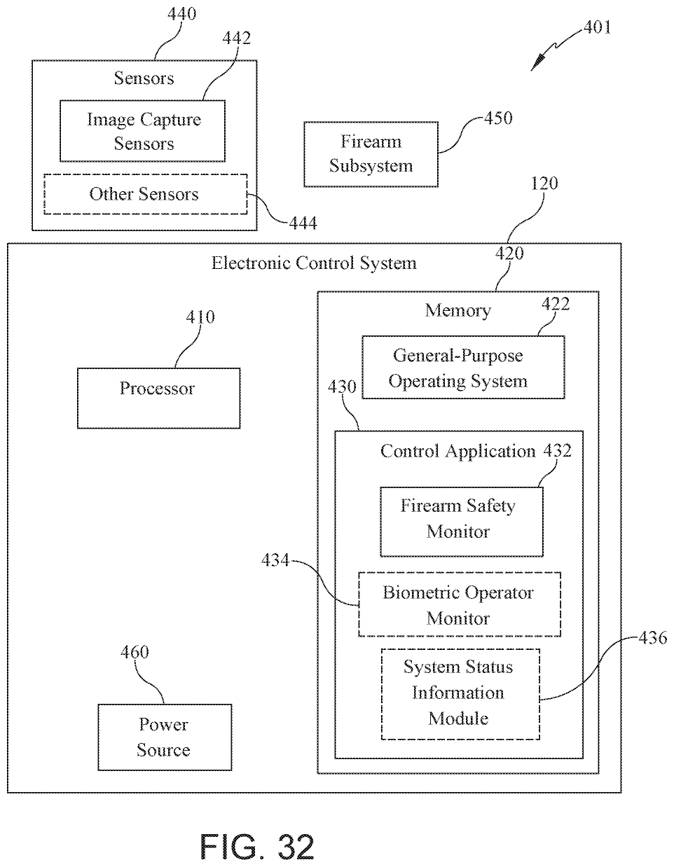

FIG. 31 shows a memory map illustratively residing in memory 430 shown in FIG. 32 and illustratively used by a fire safety monitor 432. The memory map depicts the detected shape of the target at which a firearm is aimed and the response of the electronic control system 120 of this disclosure in response thereto. If the detected shape 310 at which the firearm is pointing at is a shape that is prohibited from firing at 320, such as a shape indicative of a human, the electronic control system 120 will cause the firearm to be disarmed 330 meaning that the firearm will be in a disarm state in which it may not be fired. If the firearm is pointing at a permitted shape for firing at 320, such as a round target that may be indicative of a target of the kind used at a target range, the electronic control system 120 will cause the firearm to be armed 330 meaning that the firearm will be in an armed state in which it may be fired.

FIG. 32 shows the electronic control system 120 depicted in FIGS. 1 and 2 comprising a processor 410 and a memory 420.

Processor 410 may be hardware and software configured to process instructions. The processor may be implemented in any number of ways. Such ways include, by way of example and not of limitation, digital and/or analog processors such as microprocessors and digital-signal processors (DSPs); controllers such as microcontrollers; software running in a machine; programmable circuits such as Field Programmable Gate Arrays (FPGAs), Field-Programmable Analog Arrays (FPAAs), Programmable Logic Devices (PLDs), Application Specific Integrated Circuits (ASICs), any combination of one or more of these, and so on.

Memory 420 may be any physical device capable of storing information temporarily or permanently. Memory may be implemented in any number of ways. Such ways include, by way of example and not of limitation, nonvolatile memories (NVM), read-only memories (ROM), random access memories (RAM), any combination of these, etc. Memory 420 may include programs containing instructions for execution by processor 420. The programs provide instructions for execution by the processor 420, and can also include instructions regarding protocols and decision making analytics, etc. that can be used by sensors 440 as explained below. In addition, memory 420 can store rules, configurations, data, etc.

At least some of the software and data structures stored in the memory implement a general-purpose operating system 422 that functionally organizes the electronic control system 422. The general-purpose operating system 422 may be a type of operating system, that is capable of executing a variety of types of software applications, including applications related to firearm control.

A further portion of the software and data structures stores a control application 430 that is utilized to control motion, and potentially other functions, of the firearm as disclosed herein. The control application 430 includes a firearm safety module 432, a biometric operator monitor 434, and a system status information module 436.

The firearm safety module 432 may be hardware and software configured to monitor and control the firearm. In this regard, the electronic control system of the firearm is coupled to a lower level system as explained below. Illustratively, the lower level system may be an assemblage of parts that configure the firearm into an armed or disarmed state of operation. Alternatively, the lower level system may be one or more parts employed in the discharge of a firearm. In one illustrative embodiment, the electronic control system of the firearm is electrically coupled to one or more sensors 440 onboard the firearm as explained below. Image data on a target, firearm system status data, and/or other data may be detected by sensors or collected, under the direction of and processed by the electronic control system. The electronic control system is also electrically coupled to, and provides control signals to firearm subsystems 450 (e.g., firearm subsystems, such as firearm latch controllers, transmission controllers, latch actuators, etc.) that implement motion and/or other function control. The firearm subsystem is adapted to the lower level system. Illustratively, the firearm subsystem may be configured to obstruct the operation of the lower level system as explained below. In operation, image, system status, or other data is collected through the electronic control system of the firearm, and the electronic control system of the firearm in turn issues appropriate control signals (such as the arm or disarm firearm instructions disclosed in FIGS. 3 and 13) to firearm subsystems to control the arm/disarm functionality of the firearm by allowing or disallowing operation of the lower level system. The foregoing described functions of data collection and control signal application to control the arm/disarm functionality of the firearm are illustrative of the functions that the firearm safety module 432 may be configured to do.

The biometric operator module 434 may be hardware and software configured to calculate one or more biometric data or metrics, determine therefrom identity indicia on the operator currently using the firearm, and based on the identity indicia, permit or disable arm/disarm functionality of the firearm as described below. Biometric data or metrics may include one or more of data samples, models, fingerprints, similarity scores and verification or identification data.

Biometric data or metrics may be used to authenticate a user of the firearm for purposes such as identification and access control. Biometric operator monitor may employ a biometric identification technique such as face recognition, fingerprint identification, hand geometry biometrics, retina scan, iris scan, signature, voice analysis, and so to authenticate a user and access control. For example, if the biometrics of an operator do not match the biometrics of an authorized firearm operator encoded in the electronic control system (e.g., the operator is not the registered user of the firearm), the biometric operator module may not arm the firearm.

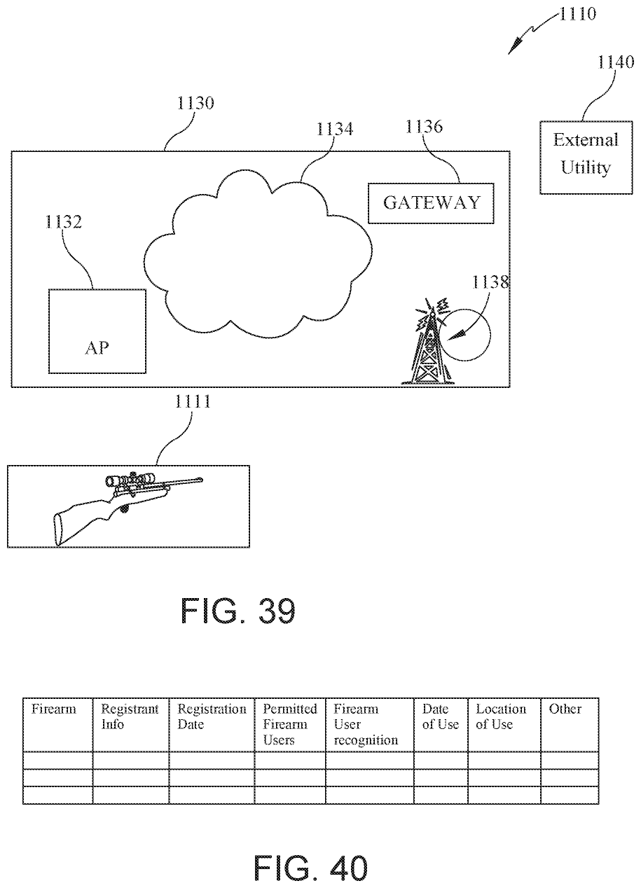

Alternatively, if the operator is not the registered user of the firearm, the biometric operator module may perform one or more other sequences, such as a sequence to determine, notwithstanding the operator not being the registered user of the firearm, whether the operator is someone otherwise authorized to use the firearm. For example, in the illustrative embodiment of FIG. 39, a cloud service may be provided comprising a registry of biometric or other data on law enforcement officers. The biometric operator module may provide to the cloud service the biometric or other data on the person seeking to use the firearm. The cloud service may then perform a set of instructions to determine whether the provided biometric data of the intended user matches the biometric data of a law enforcement officer. If there is a match, the cloud service may communicate to the biometric operator monitor to provide control instructions to arm the firearm for use by the intended user.

The system status information module 436 may be hardware and software configured to provide system status information that may include data on why a firearm remains disarmed notwithstanding the desire of the operator to use the firearm, information on the condition of the firearm, instructions on what an operator may do in order to disarm the firearm, and so on. For example, the status data may indicate that the biometric recognition failed; try again. Or the status data may indicate that the target shape is prohibited; try another target. The status data may also indicate that the power source is low; recharge or change battery. Other information may also be provided.

To provide feedback to an operator on the system status information, the electronic control system may also include a speaker, to issue voice prompts, etc. The electronic control system may also include visual gauges like a gauge to indicate the amount of power left and a gauge that changes in a condition such as changing a color, such as green, when a firearm is armed according to this disclosure, and another color, such as red, when the firearm is disarmed.

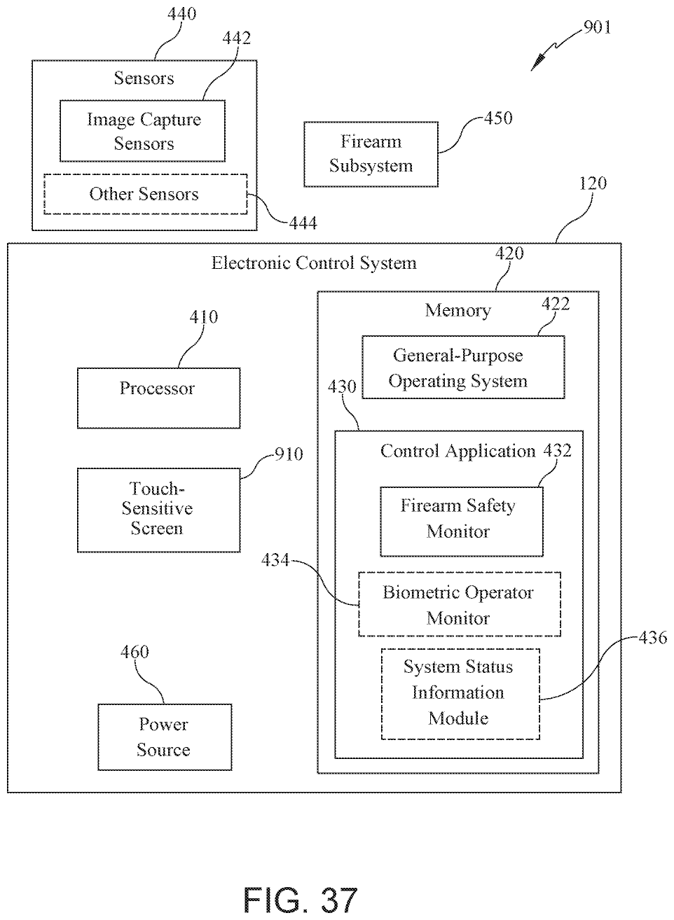

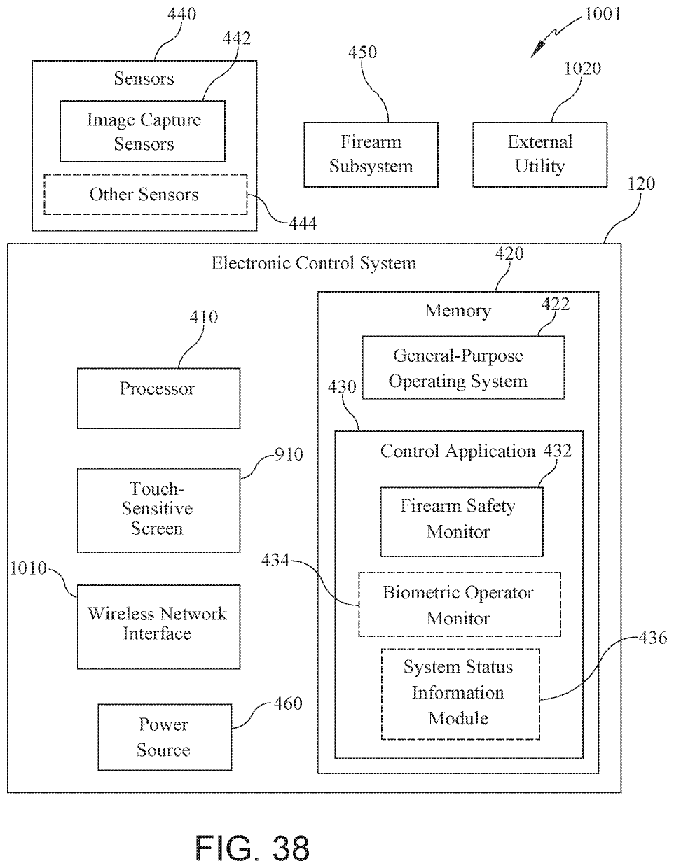

The electronic control system may also include an arm/disarm control interface illustratively including a touch-sensitive screen to allow a firearm operator to interface with the electronic control system as explained in FIG. 37. The electronic control system may also include an arm/disarm control interface through which a remote operator or service may monitor and control the firearm as disclosed in in FIG. 38.

The electronic control system may be provided with a microphone for the electronic control system to receive voice commands, such as by an operator, like “try again” or “reboot”, and so on.

In embodiments in which a touch-sensitive screen is provided to the electronic control system as described in FIG. 37, the system status information for the firearm may be displayed on a user interface (UI) on a touch-sensitive screen 910 (FIG. 37), and the touch-sensitive screen may receive control input indicating desired motion and other function control, when firearm operator control is permitted. The desired motion may be scrolling, navigating, and zooming image data and system status data rendered on the touch-sensitive screen. As depicted in FIG. 38, this control input may be passed to a network through wireless network interface 1010 for transmission back to an external utility 1020 (FIG. 38) over a wireless network, when permitted.

FIG. 32 shows additional to the electronic control system 120 an illustrative system of this disclosure further comprising sensors 440 and firearm subsystem 450.

Sensors 440 comprise an image capture sensor, another sensor, or a combination of both. The image capture sensor may be hardware and software configured to capture an image. Image capture sensors 442 typically include one or more light sensors. A light source may also be included to emit light to be reflected off an object. The light sensors capture and translate the reflected light into electrical signals. The image captured may be a photo image. For example, the light sensors may be a high-pixel resolution CCD (charge coupled device) chip and it and associated hardware may be used for generating digital images. The software for processing the captured images may reside in the memory 430 or a section of memory associated with the firearm safety monitor 432 if the captured images are for use by the firearm safety monitor. Alternatively, the image capture sensors 442 may be provided with a processor and a memory for storing and executing this image processing software.

Other sensors may include heat, location accelerometer, a gyroscope, a magnetometer, a proximity sensor, a gravity sensor, a linear accelerometer, and so on. Additional sensors may include light sensor, camera sensors, microphone sensors, touch sensors, pressure sensor, temperature sensor, humidity sensor, and so on.

Firearm subsystem 450 are functionalities provided to a firearm by this disclosure, such as firearm latch controllers, transmission controllers, latch actuators, etc., which implement motion or other function control.

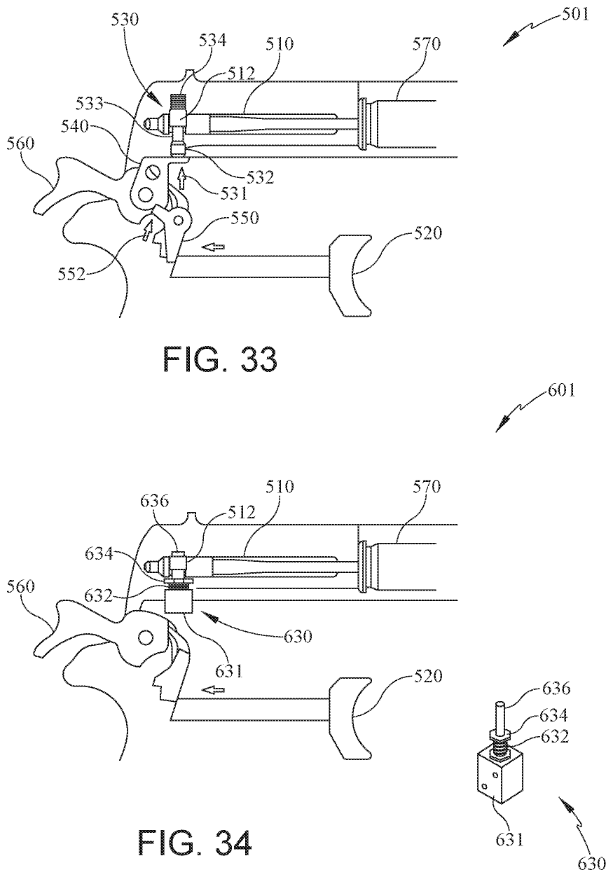

FIG. 33 shows an illustrative embodiment of one prior art lower level system 501 in a firearm known as the firelock pin block mechanism (FPB). The FPB is a well-known safety feature on, for example a Colt 1911 series 80 handgun, which blocks the firing pin. The purpose of the FPB is to prevent firelock pin 510 from moving forward unless trigger 520 is depressed. This “mechanism is designed to prevent “accidental discharges” caused by dropping the pistol or catastrophic mechanical failures. As is well known in the prior art, on depressing trigger 520, a trigger bar lever 550 is caused to rotate clockwise 552 as depicted in FIG. 33, causing a firelock pin plunger lever 540, with which the trigger bar lever 550 is in mechanical engagement, to rotate counterclockwise. This causes an upward force 531 on a firelock pin plunger 532 of a firelock pin block safety 530, causing upward movement of the firelock pin block safety 530 within an opening 512 of the firelock pin 510. When a narrow portion 533 of the firelock pin block safety is within opening 512 of the firelock pin 530, the firelock pin is no longer restricted from forward movement. On further depressing of the trigger 520, a hammer 560 is released to contact the firing pin, causing the firelock pin to accelerate forward under the force of the hammer contact against a bullet 570 causing the bullet and hence the firearm to fire.

FIG. 34 shows an illustrative embodiment of one lower level system with firearm subsystem 601 according to this disclosure. As shown, when this disclosure enables the firearm to be armed, then on depressing of the trigger 520, the hammer 560 is released from a restricted position and allowed to strike the firelock pin 510. The firelock pin is caused to accelerate forward under the force of the hammer contact against the bullet 570 causing the bullet and hence the firearm to fire.

Disablement of the firearm is by the firearm subsystem which illustratively comprises a latch actuator 630. Illustratively latch actuator 630 comprises a DC solenoid electromagnet which is normally open. This means that without electrical energization of a magnetic coil disposed within the latch actuator, a plunger 636 remains in an expanded position within opening 512 of the firing pin 510; blocking the forward movement of the firing pin 510. Hence, any contact of the hammer against the firing pin will not cause the firearm to discharge since the firing pin is restricted from forward movement by plunger 636 of the latch actuator. On energization of a magnetic coil inside housing 631, the plunger 636 is retracted inside the housing 631 of the latch actuator 630 allowing the firing pin 510 to move forward under the influence of force imparted by the hammer 560 and against the bullet 570 causing the bullet and hence the firearm to fire.

Referring back to FIG. 32, the electronic control system further comprises a power source. Illustratively, the power source is a battery that provides power sufficient to operate the electronic control system and firearm subsystems according to this disclosure. The battery may be a replaceable battery in which event a removable panel may be provided to a compartment housing the battery to permit access to and replacement of a battery. Alternatively, the battery may be a chargeable battery in which event a charging port may be provided to a compartment housing the battery to permit charging of the battery.

In operation, image, system status, or other data is collected through the electronic control system of the firearm as previously disclosed, and the electronic control system of the firearm in turn issues appropriate control signals to firearm subsystem, or firearm subsystems if more than one firearm system is employed, to control the arm/disarm functionality of the firearm. Hence, when, for example, the firearm is pointing at a target that in accordance with the memory map of FIG. 31 is an impermissible target for firing upon (e.g., a human), the electronic control system 120 may not energize the magnetic coil and hence the firing pin and hence firearm are restricted from firing. If the firearm is pointing at a permissible target, however, the electronic control system may energize the magnetic coil and allow the firing of the firearm.

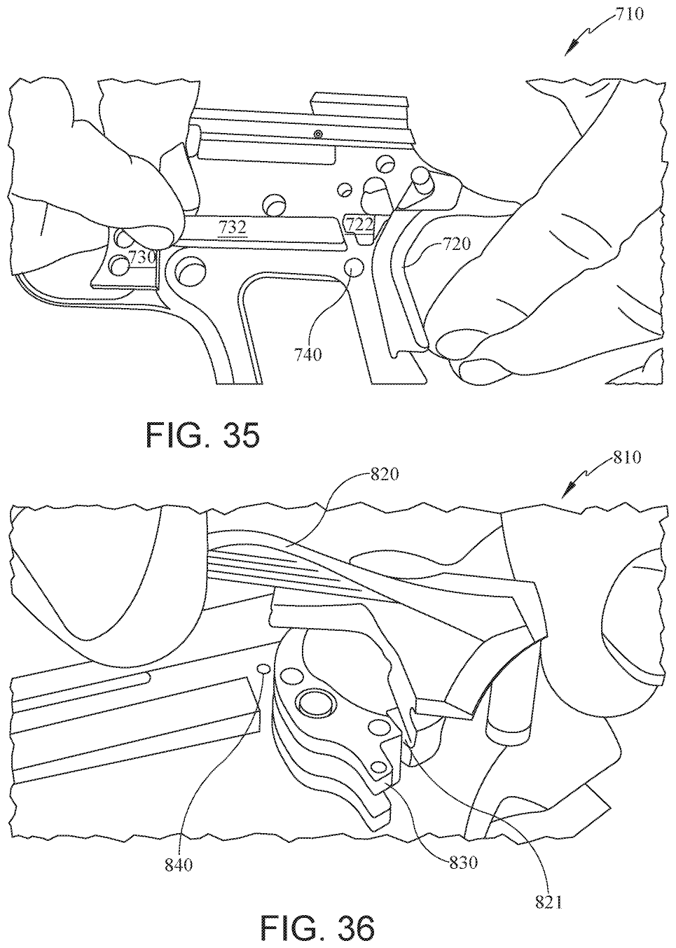

FIG. 35 shows an illustrative embodiment of one lower level system with firearm subsystem 710 according to this disclosure adapted to a grip safety feature (GS) 720 of a firearm. The GS 720 blocks rearward movement of a trigger 730. As shown, a tab 722 blocks the rearward movement of the trigger 730. Disablement of the firearm is by a firearm subsystem which illustratively comprises a latch actuator 740 in this embodiment. Latch actuator may be similar to the latch actuator 630 but appropriately sized and configured for use in this application. While in this embodiment a latch actuator 740 is used other electrically activated mechanisms for blocking the movement of a part of a firearm required to discharge a bullet may be used for the firearm subsystem. Where a latch actuator similar to the latch actuator 630 is used, without electrical energization of a magnetic coil disposed within the latch actuator, a plunger 636 remains in an expanded position; blocking the rearward movement of the trigger. Hence, the hammer is restricted from contacting the firing pin to cause the firearm to discharge since the trigger is restricted from movement by plunger 636 of the latch actuator. On energization of the magnetic coil, the plunger 636 is retracted inside the housing of the latch actuator allowing the trigger to free the hammer to strike the firing pin to strike a bullet and discharge the firearm.

FIG. 36 shows an illustrative embodiment of one lower level system with firearm subsystem 810 according to this disclosure adapted to a thumb safety (TS) feature 820 of a firearm. A tab 821 on TS feature 820 blocks a sear 830 from releasing the hammer. When the TS feature 820 is moved to the firing position, the sear 830 is free to move out of a position where a notch is restricting the hammer. Disablement of the firearm is by the firearm subsystem which illustratively comprises a latch actuator 840. Latch actuator may be similar to the latch actuator 630 but appropriately sized and configured for use in this application. While in this embodiment a latch actuator 840 is used, other electrically activated mechanisms for blocking the movement of a part of a firearm required to discharge a bullet may be used. Where a latch actuator similar to the latch actuator 630 is used, without electrical energization of a magnetic coil disposed within the latch actuator, a plunger 636 remains in an expanded position; blocking the sear 830 from moving its hammer notch out of the way of the hammer. Hence, the hammer is restricted from contacting the firing pin to cause the firearm to discharge since the trigger is restricted from movement by plunger 636 of the latch actuator. On energization of the magnetic coil, the plunger 636 is retracted inside the housing of the latch actuator allowing the sear to move out of the hammer notch to free the hammer to strike the firing pin to strike a bullet and discharge the firearm.

While the firearm subsystem may be according to this disclosure described above, other actuator latch controllers, transmission controllers, latch actuators, or mechanisms that restrict movement of a part of a firearm required to discharge a round may be used with this disclosure. More specifically, any electrically activated mechanism that blocks the movement of a part of a firearm required to discharge a bullet may be used with this disclosure as explained herein.

FIG. 37 shows the electronic control system 120 depicted in FIG. 32 further comprising a touch-sensitive screen 910. The elements in FIG. 32 shown in FIG. 37 bear the same number in FIG. 37 as they do in FIG. 32, with the explanation of those elements in FIG. 32 applicable to those elements in FIG. 37.

The touch-sensitive screen is a computer display screen that is also an input device. In this disclosure, a touch-screen is adapted for use with the electronic control system of this disclosure. Illustratively, the touch-screen may be integrated with the electronic control system to allow an operator of the firearm to provide input commands to the electronic control system and to scroll, navigate, and zoom image, system status, and other data rendered on the touch-sensitive screen. Alternatively, any arm/disarm control interface may be used in place of the touch-screen.

The screens are sensitive to pressure; a user interacts with the computer by touching pictures or words on the screen. The touch-sensitive screen 910 is configured to visually display information and to received input, including touches and gestures entered by an operator. Alternatively, the touch-sensitive screen 910 may be provided by wireless mobile devices. Illustrative examples of wireless mobile devices include tablet computers, smartphones, and certain portable media players that execute general-purpose operating systems and may be configured to wirelessly communicate with the electronic control system of this disclosure. The wireless communication of the wireless mobile device with the electronic control system may be over a wireless network interface 1010 described below in connection with FIG. 38. Alternatively, the wireless mobile devices or other arm/disarm control interface, such as a monitor, may be hardwire tethered to the electronic control system of this disclosure through communication ports provided in each.

As described above, with such a touch-sensitive screen provided to the electronic control system, the image, system status, or other data may be displayed on a user interface (UI) on a touch-sensitive screen 910 (FIG. 37), and may receive control input indicating desired motion and/or other function control via the UI, when firearm operator control is permitted.

The desired motion may be scrolling, navigating, and zooming image, system, and other data rendered on the touch-sensitive screen. This control input may be passed to the network through wireless network interface 1010 for transmission back to an external utility 1020 (FIG. 38) over a wireless network 180, when permitted.

Control may be permitted an operator to access data, such as image, system status, other data, update data, and/or confirm data, and so on. For example, a hunter may have permission to access system status data in order to understand why a firearm won't arm. A firearm bureau may have permission to update status data over a network as disclosed in FIG. 38. In the illustrative example, the firearm bureau may be permissible operators of the firearm. A law enforcement officer may have permission to arm a firearm that is not his own. Permission may be illustratively granted using the cloud service registry on biometric data previously explained.

Permission may be given a user of the firearm in other situations after the electronic control system of this disclosure has identified a condition that would normally keep the firearm in a disarmed mode of operation. For example, if a law enforcement officer is in hot pursuit of armed robbers, the target of the firearm would be a human which may be a precondition not allowing the firearm to be fired in an illustrative embodiment. However, the law enforcement officer may, for example, using permissions, over-ride the disarm of the firearm to allow the firearm to be fired upon the armed robbers. Permissions may be encoded in the electronic control system or stored in a cloud service including a registry of persons with permission to operate a firearm.

The initial disarm provided a firearm by this disclosure illustrates how the disarm mode of operation of this disclosure may provide a law enforcement officer (or others with permission to over-ride a disarm condition of a firearm) with a first alert that a precondition for a disarm has been satisfied and so the firearm is disarmed. This first alert data may be used by operators with permission to disarm in deciding whether or not to over-ride the disarm. Where, for example, the target is a human involving armed robbers, the law enforcement officer may over-ride the disarm of the firearm notwithstanding the first alert data in order to be able to use the firearm to apprehend the armed robbers.

However, if the officer is aiming at a target not realizing it to be a human or is doing so and pulling the trigger in the heat of the moment, the first alert data may allow the law enforcement officer to reflect on whether the human is a target by mistake or in the heat of the moment. The may allow the law enforcement officer to think twice before over-riding the safety disarm feature of this disclosure and firing the firearm. Indeed, this feature may have prevented the recent knee jerk firing by a law enforcement officer in Minneapolis on an innocent Australian woman in the heat of the moment by forcing the officer to think twice before pulling the trigger of his firearm.

In another example of this disclosure, military soldiers may have permission for over-ride when in battle against enemies. On the other hand, the biometric operator monitor, for example, of this disclosure may keep the firearm from falling into and being used by enemy hands since the biometric monitor may keep the firearm disarmed should that happen.

In the embodiment of FIG. 37, the firearm is provided with an arm/disarm control interface illustratively including a touch-sensitive screen through which a firearm operator may monitor and control the firearm. The electronic control system is coupled to a lower level system. The lower level system may be a one or more parts of the firearm employed in the discharge of a firearm. Alternatively, the lower level system may be an assemblage of parts that configure the firearm into an armed or disarmed state of operation. The electronic control system of the firearm may be electrically coupled to various sensors onboard the firearm. Image data on a target, firearm system status data, and/or other data may be detected by sensors or collected, under the direction of the electronic control system, and processed by the electronic control system. The electronic control system is electrically coupled to, and provides control signals to a firearm subsystem (e.g., firearm subsystems, such as firearm latch controllers, transmission controllers, latch actuators, etc.) that implement motion and/or other function control. The firearm subsystem is adapted to the lower level system, the firearm subsystem configured to obstruct the operation of the lower level system. The electronic control system is configured to provide a control signal to the firearm subsystem in response to a detected condition to allow operation of the lower level system to operate the firearm by allowing or disallowing operation of the lower level system. In addition, the image, status, and/or other data may be propagated to the arm/disarm control interface through which an operator may monitor and control the firearm.

FIG. 38 shows the electronic control system 120 depicted in FIG. 37 further comprising a wireless network interface 1010. The elements in FIG. 37 shown in FIG. 38 bear the same number in FIG. 38 as they do in FIG. 37, with the explanation of those elements in FIG. 37 applicable to those elements in FIG. 38.

Illustratively, the wireless network interface 1010 comprises transceiver circuitry and software for sending and receiving packets over a wireless network (e.g., an IEEE 802.11 WLAN). Alternatively, the transceiver may be hardware and software configured to transmit data to and from the electronic control system and a network or an external device including Wi-Fi, blue tooth CDMA, and so on, that enables a wireless communication link for between the electronic control system and an external device.

In an alternative embodiment, the wireless network interface 1010 may be combined with or replaced by a hardwire connect for electrically connecting the electronic control system to the network by wire, such as one or more ports and associated circuitry and software that allow wired communication between the electronic control system and an external device (e.g., an Ethernet connector, an RS232 connector, a USB or other wire connector.)

A hardwire connect may be used, for example, to tether a smart phone to the electronic control system to enable the functionality of the smart phone to assist, augment, enhance, or complement functionality that is provided by the electronic control system. In one example, the tether permits the wireless network interface of the smart phone to be used by the electronic control system to communicate with external devices or a network. For example, a smart phone received and held in a pocket of a garment worn by the operator may be tethered to the electronic control system so as to allow the smart phone to communicate with the electronic control system to perform the functionalities of this disclosure. For example, the touch-screen of the display may provide the touch sensitive screen 910 of the electronic control system. In another example, the wireless network interface of the smart phone provides the wireless communication link with a network.

In another embodiment, the hardwire connect may be in the form factor of a docking station for receiving and holding the smart phone firmly to the firearm and electrically connecting the smart phone to the electronic control system. The docking station may be provided with an electrical connector for mating with the charge port of a smart phone to provide an electrical connection between the two. The docking station may provide a simplified way of plugging in the smart phone to the electronic control system of this disclosure. The wireless network interface 1010, hardwire connect, or both may enable any computing device to be electrically connected to the electronic control system of this disclosure. By computing device is meant servers, intermediary servers, personal computers, cellular phones, smart phones, wireless computers, wireless lap-top computers, mobile devices such as tablet computers, pad computers, personal digital assistant, wireless sensors or networks of sensors, such as mesh network sensors, and so on may be in electrical communication with to provide functionality to the electronic control system.

In another illustrative embodiment, a wireless mobile device such as a smartphone or other computing device may provide the electronic control system of this disclosure. For example, a smartphone may replace the electronic control system in, for example, FIGS. 4, 9, and 10. In this embodiment, the smartphone may provide the processor, memory, and wireless network interface functionalities of the electronic control system according to this disclosure. The battery of the smartphone may provide power for the firearm subsystem or enhance a power system provided the firearm for operating the firearm subsystem.

In another embodiment, the firearm may be provided with a docking station for receiving and holding and electrically connecting a smart phone or other mobile computing device that is functioning as electronic control system firmly to the firearm. The docking station may be as previously described except that the electrical connection provided by the docking station may serve to connect the smart phone to the firearm subsystem so as to allow control signals from the smart phone to operate the firearm subsystem. The electrical connection may also connect the smart phone to sensors on the firearm, in embodiments in which sensors are on the firearm. Alternatively, the sensors on the smart phone may provide the functionality of the sensors according to the disclosure. For example, a camera on the smart phone may capture the image of a target according to this disclosure. The control application on the smartphone in this embodiment may be configured to provide the control signals arming and disarming a firearm according to the teachings of this disclosure. In other embodiments, sensors on the firearm and in the smart phone may be combined in performing the function of the sensors according to the disclosure.

In an alternative embodiment, the electronic control system on a firearm a computing device connected thereto according to this disclosure may distribute the electronic control system functionality across both electronic control system on firearm and computing devices.

In another embodiment, a plurality of firearms may be tethered or wirelessly connected to an off boarded computing device. The computing device may serve the plurality of firearms in one or more ways, such as by validating the operator, arming the firearms in the case of military troops preparing for battle, and so forth. A plurality of firearms in a hunting area may be wirelessly connected to a remote computing device for purposes of monitoring and controlling the firearm in the hunting area, such as by disarming a firearm when an operator is aiming at a target in the shape of human while hunting.

In the embodiment in FIG. 38, the touch-sensitive screen may also enable an operator of the firearm to pass data to the network through wireless network interface 1010 for transmission back to an external utility 1020 (FIG. 38) over a wireless network 180, when permitted. The touch-sensitive screen may also render on the display of the touch-sensitive screen data received over the wireless network 180 from a cloud service or other external utilities over the network. For instance, data streamed into the electronic control system for rendering on the touch-sensitive screen (or for broadcast audibly) may include data on why a firearm remains disarmed, data requiring the operator to perform certain steps before arming of the firearm, data resulting from a biometric check done by a cloud server as previously described, and so on.

The external utility may provide a control signal to wireless network interface 1010 for use by electronic control system in controlling the firearm as disclosed herein.

Even after a firearm is armed according to the teachings of this disclosure, the touch-sensitive screen may allow streaming of data to assist, inform, coach, and so on the operator in connection with the use of the firearm. For example, the data feed could be of weather; a message from a family member or friend, a message from hunters that they are in the area or a message on sighting of prey; coaching from a network service on proper use of the firearm, or on adjustments to the use of the firearm based on general or historical data, and so on. For instance, the electronic control system of the firearm may observe the target, the trajectory of a fired bullet, detect movement of the operator in connection with the pulling of the trigger, and so on, and provide coaching to the operator to correct same. On detecting body movement, the electronic control system may make visual (e.g., on the touch-screen display) or audio recommendations to the operator on corrections such as “don't jerk,” “hold steady”, “aim higher”, and so on. Other audio and video features may be provided by the electronic control system of this disclosure. For example, coaching may be provided to an operator of the firearm by a person or service over a network via loudspeaker provided with the electronic control system of this disclosure. A microphone on the electronic control system may allow for interactive communication exchange between an operator and an entity over the network—be it a family member, a friend, a fellow operator of a firearm, a firearm coaching provider, interactive cloud services, and so on.

In one illustrative embodiment, the firearm is provided with an arm/disarm control interface through which a remote operator can monitor and control the firearm. The electronic control system is coupled to a lower level system. The lower level system may be a one or more parts of the firearm employed in the discharge of a firearm. Alternatively, the lower level system may be an assemblage of parts that configure the firearm into an armed or disarmed state of operation. The electronic control system of the firearm may be electrically coupled to various sensors onboard the firearm. Image data on a target, firearm system status data, and/or other data may be detected by sensors or collected, under the direction of the electronic control system, and processed by the electronic control system. The electronic control system is electrically coupled to, and provides control signals to a firearm subsystem (e.g., firearm subsystems, such as firearm latch controllers, transmission controllers, latch actuators, etc.) that implement motion and/or other function control. The firearm subsystem is adapted to the lower level system, the firearm subsystem configured to obstruct the operation of the lower level system. The electronic control system is configured to provide a control signal to the firearm subsystem in response to a detected condition to allow operation of the lower level system to operate the firearm by allowing or disallowing operation of the lower level system.

FIG. 39 shows an illustrative embodiment system 1110 implementation of FIG. 38 of this disclosure comprising a firearm control system 1111 (e.g., the electronic control system 120 and sensors 440 of FIG. 38), a network 1130, and an external utility 1140.

Firearm control system 1111 has been previously described.

Network illustratively may include access point 1132, base station 1138, a cloud 1134, and a gateway 1136. Network may include an access point or base station or both. Networking may also occur on a peer-to-peer basis where possible.

Access point 1132 is a station that transmits and receives data (sometimes referred to as a transceiver). An access point connects users to other users within the network and also can serve as the point of interconnection between the WLAN and a fixed wire network. A base station is a fixed point of communication for customer cellular phones ones on a carrier network. A cloud is a network of computers through which data passes between two end points. A gateway 1136 is a network node that connects two networks using different protocols together.

External utility 1140 comprises one or more programmed computers that may be connected to the electronic control system 120 wirelessly or by wired connection in order to allow for the exchange of data and control signals between the electronic control system and the external utility through wireless network interface 1010 and/or hardware connection as previously explained. The external utility of this disclosure may be a cloud server. A server may be any computer configured to serve the requests of client programs running on the same or other computers on a network. The computer of the external utility may be a host computer configured to serve the requests of one or more client programs residing in the safety disarm module. Alternatively, the computer of the external utility may serve a client residing on the external utility or on some other computer to which the external utility may be connected. Depending on the computing service that the server is configured to offer, the server may include one or more of a file server for storing and making files accessible for reading and writing to the client, a print server that manages one or more printers, a network server that manages network traffic, a mail server that manages mail on a network, a database server that allows clients to interact with a database, a firearm server for managing firearm records, and so on. The server may also be in communication with one or more other servers that may include one or more of the foregoing or other servers. Each of the foregoing and servers may provide a service to the firearm operator. For instance, the print server may enable a firearm operator to print an image of a target or print information on why the firearm was not armed, or information on the use of the firearm such as day and time of use, time of firing, number of firings, location, and so on. Sensors associated with the firearm may track movement of the firearm for printing by the print server for investigative, historical, archival, or other purposes.

The computer of the external utility may be any computer (e.g., end user device or server) including servers, intermediary servers, personal computers, cellular phones, smart phones, wireless computers, wireless lap-top computers, mobile devices such as tablet computers, pad computers, personal digital assistant, and wireless sensors or networks of sensors, such as mesh network sensors. These examples are not intended to be limiting, and the present disclosure is not limited to these examples of computing device. In one illustrative embodiment, the computing device may be a user equipment such as a cellular phone, a smart phone, or other device, such as a tablet or a personal digital assistant containing a multi applications processor configured to execute a mobile application. In other embodiments, any computing device configured to execute an application to provide a data service according to this disclosure may be used as the computing device of this disclosure.

The external utility 1140 in FIG. 39 may be configured to serve the firearm control system 1111 in controlling the operation of the firearm and in supporting the operator of the firearm. In one example, the illustrative memory map for operation of the firearm shown in FIG. 31 which may reside in the electronic control system, may alternatively reside on an external utility, such as a cloud server. The cloud server may allow for shape, pattern, data recognition, and so on at a level more complicated and sophisticated than possible on the electronic control system to take place in order to make the arming of the firearm control system of this disclosure based on target shape, etc., more robust and effective. Control application 430 of this disclosure, for example as illustrated in FIGS. 4, 9, and 10 may comprise software configured to create a communication link between the electronic control system and the cloud server so as to allow the electronic control system and the service to communicate. The control application may be downloadable software, embedded software, and so on. In another example, the cloud server may allow for complex biometric metrics to be generated for use by the biometric operator monitor 434 of the electronic control system of this disclosure, for example as illustrated in FIGS. 4, 9, and 10. This may make the arming of the firearm according to this disclosure based on the biometric identity of the operator more robust and effective.

In another example, the cloud server may allow for system status data to be generated for use by the system status information module 436. This may make the feeding of system status data to the firearm control system of this disclosure more robust and effective.

In another embodiment, as shown in FIG. 40, an illustrative memory map for operation of the firearm shown in FIGS. 10 and 11 may reside on a cloud server. Data on the firearm, firearm registrant, registration data, permitted firearm operators, firearm operator recognition, date of use, location of use, firearm restrictions, and so on may be managed by way of a service on a cloud server and used to arm or disarm a firearm, stream data, provide guidance or coaching to an operator, and so on.

In another example, a person near or remotely located from an operator of the firearm may, if permitted, send control signals to the electronic control system of the disclosure over the network or peer-to-peer (where such communication is provided) to disarm the firearm with his smart phone or other computing device in certain situations according to the teachings of this disclosure. For instance, where a firearm is being fired on people outside or inside a room or building, as happened in San Bernardino and Orlando, a person in the room or building or outside or elsewhere may, if authorized to do so, send a control to the electronic control system of the discharging firearm to disable the firearm according to the teachings of this disclosure. For example, a person in a room in which people are being fired upon may send a signal to a cloud service that manages firearm use to prompt the cloud server to send a disarm signal to the discharging firearm to disarm same. Alternatively, the person may call 911 to do the same. Alternatively, a server that is configured to monitor a firearm may detect a target of a firearm in the shape of a human and may send a control signal through the network to the firearm to turn off the firearm. This example may occur where, for example, the firearm control system is configured to disarm on certain conditions other than the shape of the target at which the firearm is aimed. For example, the firearm control system may not configured to disarm based on target shape when a firearm is aiming at a human. Or where lighting or some other condition may prevent accurate shape recognition functionality at the firearm safety monitor level but not at the cloud server level where more sophisticated software may allow same. Or where an operator managed to tamper with the shape functionality at the firearm level so that it is not working at the firearm safety monitor level in which case the shape recognition service on the cloud may provide a redundant shape recognition system. The cloud service may also locate one or more firearms in the location where the firearm is being discharged and either disarm those firearms to prevent them from getting into the hands of the perpetrator of the firearm discharge or provide instructions to the caller, persons inside or outside the building, or others to help the person locate and use the firearm to take down the perpetrator.

In another example, surveillance cameras on premises or surveyed areas may monitor the presence of events like a firearm, a firearm operator, other persons, and so on and provide surveillance data to a cloud service. The video feed may be continually streamed to the cloud service or triggered on detection of an event. The triggering event may be an on-site administrator of the surveillance cameras, an authorized on-site personnel, and so on. An on-site recorder may be provided to process surveillance data from the surveillance cameras and on detection of an event, the recorder may be internally triggered to send the video feed to the cloud service. Alternatively, the feed may be an audio video feed (e.g., include an audio component), an audio feed, and so on. The cloud service may process the data and investigate, take action such as sending a control signal to disarm the firearm, and so on in order prevent discharge of the firearm in the surveyed space.

In one embodiment, homes and establishments may subscribe to a service that provides this or other kind of firearm safety service for their premises or surveyed areas. An establishment or home may allow surveillance feed captured by surveillance cameras to be communicated to the firearm safety service either continually or when a firearm on the premises is detected. For example, the surveillance feed may be stored on an on-site recorder. An employ of the establishment may trigger the streaming of the video feed to the cloud service on detection of a firearm on the premises or any irregular behavior of a person on the premises. Alternatively, the cloud service may track firearm movement and be configured to trigger surveillance cameras on a premises to provide video feed when the firearm moves onto the premises of the subscriber. The surveillance feed may allow for remote video identifying and monitoring individuals with firearms and their behavior. The service may be in communication with an employ of the establishment, such as by phone call, text messaging and so on, in the event of any suspicious behavior for purposes of securing additional data for use in further investigating the situation and taking preemptive measures if needed. If a firearm is used in a way that fits within a pattern of suspicious activity, the cloud service may disarm the use of the firearm according to the teachings of this disclosure if needed.

In another embodiment, the image capture sensors 442 previously described, such as in connection with FIGS. 4, 10, and 11, may be configured to capture images when the trigger of a firearm is activated. Alternatively, the image capture sensors may be configured to capture images when some other image capture trigger on or off the firearm is activated. For example, the electronic control system may be configured to detect movement of the trigger of a firearm and activate the image capture sensors 442 to capture a snap shot or a video stream of the discharge of a firearm at a target.

Alternatively, the electronic control system may capture a snap shot or a video stream responsive to activation of an image capture trigger electrically connected to the electronic control system. In this example, a snap shot or video image may be taken even when the firearm trigger is not activated since activation in this cases occurs upon activation of the image capture trigger. Illustratively, the image capture trigger may reside on the firearm and be activated by the operator. Alternatively, the image capture trigger may reside on a smart phone or other computing device providing electronic control functionality to the firearm.

In another example, the image capture trigger may reside on a smart phone or other computing device and operate independently of and even without the electronic control system, firearm subsystem, and other arm/disarm features of this disclosure. For example, a firearm may be provided with a mechanical docking station to mechanically connect and hold a smart phone or other mobile computing device to the firearm. An image capture trigger on the smart phone may be activated by an operator to capture snap shot or video images. Because of the mechanical association of the smart phone with the firearm as disclosed herein (e.g. mechanical connection between the two which causes the two devices to maintain an alignment between the two), snap shot or video images taken by the camera may be of images that are within or about the target of the firearm. For example, the camera in the smart phone may capture images in view of a firing scope or generally in the direction of aim of a firearm. In another example, the smart phone may be positioned to have the optical axis of the camera perpendicular to the line of sight of the firearm in order to allow capture of images taken along one, or if two cameras pointing in opposite directions are used, both sides of the firearm.

In another embodiment, the touch-sensitive screen of an electronic control system may render images captured by a camera of a smart phone attached to the firearm according to this disclosure. In an embodiment, where the camera of the smart phone is capturing images to the side, back and so on of the operator, those images may be rendered on the touch-sensitive screen of the electronic control system to allow the operator to observe events occurring about him as he may be advancing or aiming at a target. For example, while aiming at a target, a hunter may observe on his touch-sensitive screen an approaching lion captured to the side, back and so on. With this data, the hunter may take pre-emptive action. A law enforcement officer or military soldier may be firing on a target and observe an approaching or the enemy on the touch-sensitive screen. This allows the operator to see events to the side and “in the rear view mirror” so to speak in order to prevent harm to himself from an advancing person or thing.

In another embodiment, the image capture trigger may be activated remotely by a cloud service or person over the network of this disclosure.

Where a smart phone or other computing device for example is providing electronic control system functionality, the camera of the smart phone may capture the snap shot or video stream of a target or things to the side or back of the operator as previously indicated. The snap shot or video stream may be recorded on the memory 420 of the electronic control system. The snap shot or video stream may be downloaded at a later point in time to a computing device wirelessly or using a tether according to the teachings of this disclosure.

The foregoing embodiments illustrate that functionalities of the electronic control system according to this disclosure (e.g., image capture functionality) may be used to arm/disarm a firearm. But they may also be used for other functions. Some of these other functionalities may be employed without configuring the electronic control system to perform an arm/disarm functionality. Hence, this disclosure provides functionality to a firearm that can arm/disarm a firearm, capture image data, and to do other things. One functionality that may be employed even if the electronic control system is not configured to arm/disarm is the image capture functionality as previously explained. Other non-limiting functionalities that may be employed even if the electronic control system is not configured to arm/disarm is firearm movement (e.g., GPS, location tracking, and so on), firearm discharge (e.g., the electronic control system may detect firearm discharge and record same with time stamp, or other information), and so on.

A snap shot or video stream may be wirelessly or by wire transmitted in real time, in batch time, in intervals or later to a cloud service, an external computer, a computing device, and so on for storage. The received data may be stored in an account set up by the firearm owner or other person or entity authorized to use the firearm or access data from the firearm. The authorized person or entity may be a firearm service provider or a firearm bureau such as a government office tasked with firearm use, safety, and so on. It may be a store that sold the firearm. The owner may subscribe to a service that allows historic, archival, administrative, investigative, and/or so services to allow retrieval of the snap shot or video stream according to the subscription. The other person or entity authorized to access the snap shot or video may access the snap shot or video stream for regulatory, investigatory as well as historic, archival, administrative and/or so on services. The services provided by this disclosure may have helped authorities in Minneapolis understand why an unarmed Australian woman was shot by an officer who did not have his camera turned on in violation of enforcement protocol since this disclosure enables an operator of a firearm to capture snapshots and video to memorialize a firearm discharge, a hunt, target practice, and so on. It also allows for more robust monitoring and control of a firearm by facilitating investigatory, regulatory, historic, archival, administrative and so on services in connection with a firearm after discharge. It also allows for same before discharge, by for example, tracking of a firearm, change of operator registration, and so on.

Before and/or after arming of a firearm, the touch-sensitive screen of this disclosure may allow streaming of data to assist, inform, coach, and so on the operator in connection with the use of the firearm. For example, the data feed could be of weather; a message from a family member or friend, a message from hunters that they are in the area or a message on sighting of prey; coaching from a network service on proper use of the firearm, or on adjustments to the use of the firearm based on general or historical data. For instance, the firearm may observe misalignment of the trajectory of the bullet with respect to the gun sight and provide coaching to the operator to correct same. The firearm may detect the response of the body of the operator after discharge and make recommendations to the operator on corrections such as adjusted body posture, less body movement when pulling the trigger, and so on.

The principles of dead zone may also be used to control the safety disarm module to arm or disarm a firearm. These principles are taught in the dead zone disclosures this application claims priority to and the benefit of identified above, the contents of which have been hereby incorporated by reference. For example the electronic control system of a firearm may be disarmed if the firearm is in a predetermined zone in which use of a firearm is not permitted. In this example a register of firearm dead zone locations may be located either in the cloud, including on a wireless smart phone connected to the electronic control system via wireless connection, or on the electronic control system itself or both. If the firearm is in one of the firearm dead zones, the firearm is disarmed according to this disclosure so that the firearm may not be used while in the dead zone. For example, if the cloud service detects that the firearm is in a church, a restaurant, or other place where a firearm should not be used, the cloud service may disarm the firearm. On leaving the dead zone, the firearm may be armed by the electronic control system according to the teachings of this disclosure.

The electronic control system of this disclosure may also be programmed and updated over-the-air with software updates, electronic control system configurations and settings, firearm subsystem configurations and settings, predetermined zones in which the firearm is to be disable, and so on.

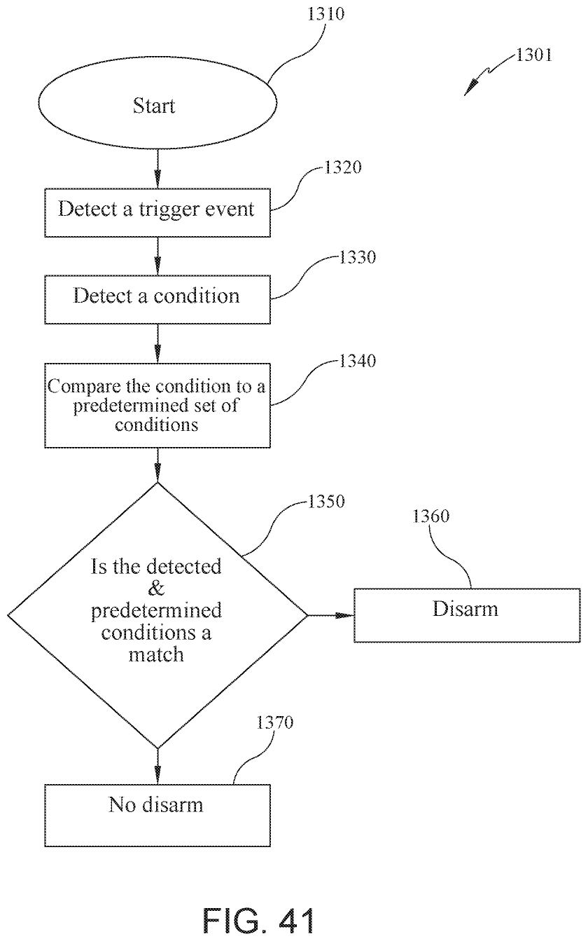

FIG. 41 shows an illustrative method of this disclosure. The method advances from start 1310 to detecting a trigger event. If a trigger event is detected, the method detects a condition 1330. For example, the condition may be the shape of the target, the identity of an operator, and so on. In step 1340, the method compares the detected condition to a predetermined set of conditions. For example, the detected shape would be compared to a predetermined set of shapes. At step 1350, the method determines whether the comparison yields a match. If comparison yields a match, the firearm is disarmed 1360. If the comparison yields no match, the firearm is armed for firing.

There is thus disclosed a firearm provided with an electronic control system which monitors and controls the firearm. The electronic control system of the firearm is coupled via connection to lower level systems. The lower level system may be one or more parts of the firearm employed in the discharge of a firearm. Alternatively, the lower level system may be an assemblage of parts that configure the firearm into an armed or disarmed state of operation. The electronic control system of the firearm may be electrically coupled to various sensors onboard the firearm. Image data on a target, firearm system status data, and/or other data may be detected by sensors or collected, under the direction of the electronic control system, and processed by the electronic control system. The electronic control system is electrically coupled to, and provides control signals to a firearm subsystem (e.g., firearm subsystems, such as firearm latch controllers, transmission controllers, latch actuators, etc.) that implement motion and/or other function control. The firearm subsystem is adapted to the lower level system, the firearm subsystem configured to obstruct the operation of the lower level system. In operation, image, system status, or other data may be processed by the electronic control system of the firearm, and the electronic control system of the firearm in response may issue appropriate control signals to firearm subsystems to control the arm/disarm functionality of the firearm by allowing or disallowing operation of the lower level system.

The firearm may be provided with an arm/disarm control interface illustratively including a touch-sensitive screen through which a firearm operator may monitor and control the firearm. The firearm may be provided with an arm/disarm control interface through which a remote operator or service may monitor and control the firearm.

The electronic control system of this disclosure may minimize any attempt by an operator to tamper with the firearm in an attempt to bypass the electronic control system. This is because the electronic control system of this disclosure configures the firearm in a disarmed state. Unless the firearm is properly energized according to this disclosure and the conditions that allow the firearm to be armed as taught by this disclosure are satisfied, the firearm will remain disarmed. The complexities of a work-around serve as a disincentive to further tampering. Greater integration of the firearm subsystem into the firearm may further disincentivize tampering since it may make it more difficult to remove the obstacle that prevents the operation of the firearm (e.g., the plunger blocking the firing pin in the solenoid electromagnet example). Even more measures may be taken to prevent disassembly of the firearm subsystem or other components of this disclosure to get around the disarming of the firearm.

In an illustrative method according to this disclosure, a trigger event is detected and a condition is detected. The condition is compared to a predetermined condition. The firearm is disarmed if the condition matches the predetermined condition. The predetermined condition may be a shape (e.g., in the shape of a human), a location (e.g., in a dead zone), the identity of the operator, whether or not the firearm has been tampered with (e.g., electronic control system or sensors have been tampered with), and so on.

An illustrative computer readable medium according to this disclosure contains program instructions for causing a computer to perform the method of detecting a trigger event; detecting a condition; comparing the condition to a predetermined condition; disarming the firearm if the condition matches the predetermined condition. The predetermined condition may be a shape (e.g., in the shape of a human), a location (e.g., in a dead zone), the identity of the operator, whether or not the firearm has been tampered with (e.g., electronic control system or sensors have been tampered with), and so on.

In one aspect, there is thus disclosed a system configured for detecting firearm threats on a premises includes a surveillance camera on a premises and a utility. The surveillance camera is configured to generate surveillance data. The utility is configured to provide a cloud service for detecting firearm threats on a premises. The system includes a processor; memory in electronic communication with the processor; and instructions stored in the memory. The instructions are executable by the processor to: detect the presence of a firearm on the premises; and upon detecting a firearm, sending a notification that a firearm has been detected on the premises.

The system may further include a recorder. The recorder may be configured to monitor a firearm and to generate the surveillance data.

The utility may be an external utility.

The processor, the memory, and the instructions stored in the memory may reside in the recorder.

The notification may be generated by the recorder. The notification may alert the cloud service to the detection of the presence of a firearm on the premises.

The notification may trigger transmittal of a video feed of the surveillance data to the cloud service.

The processor, the memory, and the instructions stored in the memory may reside in the utility.

The processor, the memory, and the instructions stored in the memory may be a processor, a memory, and instructions residing in both the recorder and the external utility.

The surveillance data may allow for remote video identifying and monitoring individuals with firearms and their behavior on the premises.

The notification may be generated by the cloud service.

The notification generated by the cloud service may be communicated to the premises.

The notification may alert the premises regarding the detection of the presence of a firearm on the premises.

The cloud service may be provided to the premises by way of a subscription service.

The recorder may continually stream video feed to the cloud service.

The recorder may stream video feed on detection of a firearm on the premises.

On detection of a firearm the cloud service may respond to the detection of the firearm.

The response of the cloud service may be to investigate further.

The response of the cloud service may be to take an action.

The action taken by the cloud service may be to send a control signal to the premises. The response may provide instructions to the premises regarding addressing the detection of the firearm on the premises.

While the invention has been described in connection with specific embodiments, it is evident that numerous alternatives, modifications, and variations will be apparent to those skilled in the art within the spirit and scope of the invention described above.

What is claimed is:

1. A system configured for detecting firearm threats on a premises, comprising:
a surveillance camera on the premises, the surveillance camera configured to generate surveillance data;
a utility configured to provide a cloud service for detecting firearm threats on the premises;
the system including
a processor;
memory in electronic communication with the processor; and
instructions stored in the memory, the instructions being executable by the processor to:
detect the presence of a firearm on the premises;
upon detecting a firearm, sending a notification that a firearm has been detected on the premises.

2. The system of claim 1 further comprising a recorder, the recorder configured to monitor a firearm and to generate the surveillance data;

3. The system of claim 1 wherein the utility is an external utility.

4. The system of claim 2 wherein the processor, the memory, and the instructions stored in the memory reside in the recorder.

5. The system of claim 2 wherein the notification is generated by the recorder, the notification alerting the cloud service to the detection of the presence of a firearm on the premises.

6. The system of claim 5 wherein the notification triggers transmittal of a video feed of the surveillance data to the cloud service.

7. The system of claim 3 wherein the processor, the memory, and the instructions stored in the memory reside in the utility.

8. The system of claim 3 wherein the processor, the memory, and the instructions stored in the memory reside in the external utility.

9. The system of claim 1 wherein the surveillance data allows for remote video identifying and monitoring individuals with firearms and their behavior on the premises.

10. The system of claim 1 wherein the notification is generated by the cloud service.

11. The system of claim 10 wherein the notification generated by the cloud service is communicated to the premises.

12. The system of claim 10 wherein the notification alerting the premises regarding the detection of the presence of a firearm on the premises.

13. The system of claim 1 wherein the cloud service is provided to the premises by way of a subscription service.

14. The system of claim 2 wherein the recorder continually streams video feed to the cloud service.

15. The system of claim 2 wherein the recorder streams video feed on detection of a firearm on the premises.

16. The system of claim 7 wherein on detection of a firearm the cloud service responds to the detection of the firearm.

17. The system of claim 16 wherein the response of the cloud service is to investigate further.

18. The system of claim 16 wherein the response of the cloud service is to take an action.

19. The system of claim 18 wherein the action taken by the cloud service is to send a control signal to the premises.

20. The system of claim 16 wherein the response provides instructions to the premises regarding addressing the detection of the firearm on the premises.
